(19) United States
(12) Patent Application Publication
(10) Pub. No.: US 2014/0091756 A1
(43) Pub. Date: Apr. 3, 2014

(54) WIRELESS POWER TRANSFER

(71) Applicant: WiTricity Corporation, Watertown, MA (US)

(72) Inventors: Robert B. Ofstein, Wrentham, MA (US); Volkan Efe, Watertown, MA (US); Andre B. Kurs, Chestnut Hill, MA (US); Alexander P. McCauley, Cambridge, MA (US); Arunanshu M. Roy, Cambridge, MA (US); Empar Rollano, Cambridge, MA (US); Abdel Sam Rhoufiry, Logan, UT (US); Benjamin K. Sampson, Logan, UT (US); Morris P. Kesler, Bedford, MA (US); Matthew J. MacDonald, Boxford, MA (US); Eric R. Giler, Boston, MA (US); Katherine L. Hall, Arlington, MA (US); Simone Agha, Somerville, MA (US)

(21) Appl. No.: 14/044,437

(22) Filed: Oct. 2, 2013

Related U.S. Application Data
(60) Provisional application No. 61/708,991, filed on Oct. 2, 2012.
(60) Provisional application No. 61/835,061, filed on Jun. 14, 2013.
(60) Provisional application No. 61/844,789, filed on Jul. 10, 2013.

(51) Int. Cl. H02J 7/00

(52) U.S. Cl. CPC H02J 7/0044
USPC 320/108

(57) ABSTRACT

Methods and systems for wireless transmission of power to a battery-operated device include a power receiving apparatus featuring at least one receiving resonator and a housing dimensioned to engage with a battery compartment of a battery-operated device, and a power transmitting apparatus including: a first pair of spaced source resonators, where each source resonator in the first pair features a loop of conducting material surrounding a common first axis; a second pair of spaced source resonators, where each source resonator in the second pair features a loop of conducting material surrounding a common second axis different from the first axis; and a controller coupled to the first and second pairs of source resonators and configured to provide non-radiative wireless power transfer from the power transmitting apparatus to the power receiving apparatus by alternately activating the first and second pairs of source resonators.

### CROSS REFERENCE TO RELATED APPLICATIONS

This application claims the benefit of the following applications each of which is hereby incorporated by reference in its entirety: U.S. Provisional Application No. 61/844,789, filed on Jul. 10, 2013; U.S. Provisional Application No. 61/835,061, filed on Jun. 14, 2013; and U.S. Provisional Application No. 61/708,991, filed on Oct. 2, 2012.

### TECHNICAL FIELD

This disclosure relates to wireless power transfer techniques.

### BACKGROUND

Energy can be transferred from a power source to receiving device using a variety of known techniques such as radiative (far-field) techniques. For example, radiative techniques using low-directionality antennas can transfer a small portion of the supplied radiated power, namely, that portion in the direction of, and overlapping with, the receiving device used for pick up. In this example, most of the energy is radiated away in all the other directions than the direction of the receiving device, and typically the transferred energy is insufficient to power or charge the receiving device. In another example of radiative techniques, directional antennas are used to confine and preferentially direct the radiated energy towards the receiving device. In this case, an uninterruptible line-of-sight and potentially complicated tracking and steering mechanisms are used.

Another approach is to use non-radiative (near-field) techniques. For example, techniques known as traditional induction schemes do not (intentionally) radiate power, but uses an oscillating current passing through a primary coil, to generate an oscillating magnetic near-field that induces currents in a near-by receiving or secondary coil. Traditional induction schemes can transfer modest to large amounts of power over very short distances. In these schemes, the offset tolerance offset tolerances between the power source and the receiving device are very small. Electric transformers and proximity chargers are examples using the traditional induction schemes.

### SUMMARY

This disclosure relates to wireless transfer of power from a source to a receiver. Energy or power may be transferred wirelessly using a variety of known radiative, or far-field, and non-radiative, or near-field, techniques as detailed, for example, in commonly owned U.S. patent application Ser. No. 12/613,686 published on May 6, 2010 as US 2010/010909445 and entitled “Wireless Energy Transfer Systems,” U.S. patent application Ser. No. 12/860,375 published on Dec. 9, 2010 as 2010/0308939 and entitled “Integrated Resonator-Shield Structures,” U.S. patent application Ser. No. 13/222,915 published on Mar. 15, 2012 as 2012/0062345 and entitled “Low Resistance Electrical Conductor,” U.S. patent application Ser. No. 13/283,811 published on Oct. 4, 2012 as US 2012/0248981 and entitled “Multi-Resonator Wireless Energy Transfer for Lighting,” U.S. patent application Ser. No. 13/534,966 entitled “Wireless Energy Transfer for Rechargeable Batteries,” the contents of which are incorporated by reference.

In a first aspect, the disclosure features systems for wireless transmission of power to a battery-operated device, the systems including a power receiving apparatus featuring at least one receiving resonator and a housing dimensioned to engage with a battery compartment of a battery-operated device, and a power transmitting apparatus featuring: a first pair of source resonators spaced from one another, where each source resonator in the first pair includes a loop of conducting material surrounding a common first axis; a second pair of source resonators spaced from one another, where each source resonator in the second pair features a loop of conducting material surrounding a common second axis different from the first axis; and a controller coupled to the first and second pairs of source resonators and configured to provide non-radiative wireless power transfer from the power transmitting apparatus to the power receiving apparatus by alternately activating the first pair of source resonators to transfer power from the first pair of source resonators to the at least one receiving resonator, and activating the second pair of source resonators to transfer power from the second pair of source resonators to the at least one receiving resonator.

Embodiments of the systems can include any one or more of the following features.

Each one of the first pair of source resonators and each one of the second pair of source resonators can include multiple loops of the conducting material defining a coil. The first and second axes can be orthogonal (e.g., substantially orthogonal).

The power transmitting apparatus can include a housing, and the first pair of source resonators can be positioned on opposite sides of the housing. The second pair of source resonators can be positioned on opposite sides of the housing at locations that are different from locations of the first pair of source resonators. The first pair of source resonators can be positioned within walls of the housing. The second pair of source resonators can be positioned within walls of the housing.

The power transmitting apparatus can include at least one additional source resonator coupled to the controller, where the at least one additional source resonator features a loop of conducting material surrounding a common third axis different from the first and second axes. The controller can be configured to activate the at least one additional source resonator to transfer power from the at least one additional source resonator to the at least one receiving resonator.

The power transmitting apparatus can include a housing, and the first and second pairs of source resonators and the at least one additional source resonator can be positioned on different sides of the housing. The housing can enclose the power transmitting apparatus. The housing can include an aperture dimensioned to allow the power receiving apparatus to be introduced into the housing. The housing can have a form factor that corresponds to one of a bowl and a box. The housing can include one or more movable elements so that a form factor of the housing is configurable. The housing can be transformable between a first form factor and a second form factor. The first form factor can include a planar shape.

Each resonator in the first pair of source resonators can include a core, and the coil of each resonator in the first pair of source resonators can be concentric with its core. Each resonator in the second pair of source resonators can include a core, and the coil of each resonator in the second pair of source resonators can be concentric with its core. The cores of each one of the first pair of source resonators can be formed from a magnetic material. The magnetic material can include a ferrite material.

Each one of the first pair of source resonators can be an electromagnetic resonator having a resonant frequency f=ω/2π, an intrinsic loss rate Γ, and a Q-factor Q=ω/(2Γ), and the Q-factor for at least one of the first pair of resonators can be greater than 100. Each one of the second pair of source resonators can have an electromagnetic resonator having a resonant frequency f=ω/2π, an intrinsic loss rate Γ, and a Q-factor Q=ω/(2Γ), and the Q-factor for at least one of the second pair of resonators can be greater than 100. Each one of the first and second pairs of source resonators can have a capacitance and an inductance that define the resonant frequency f. The Q-factor for at least one of the first pair of source resonators can be greater than 300.

The conducting material can include at least one of a conducting wire, a conducting Litz wire, and a conducting ribbon.

The controller can be configured to activate the first and second pairs of source resonators by applying an oscillating voltage to each pair of source resonators, where the oscillating voltage applied to the first pair of resonators differs in phase from the oscillating voltage applied to the second pair of resonators. The oscillating voltage applied to the first pair of source resonators can differ in phase from the oscillating voltage applied to the second pair of source resonators by 30° or more (e.g., 40° or more, 50° or more, 60° or more, 70° or more, 80° or more). The oscillating voltage applied to the first pair of source resonators can differ in phase from the oscillating voltage applied to the second pair of source resonators by 90° (e.g., approximately 90°).

The controller can be configured to: activate the first and second pairs of source resonators by applying an oscillating voltage to each pair of source resonators, where the oscillating voltage applied to the first pair of source resonators differs in phase from the oscillating voltage applied to the second pair of source resonators; and activate the at least one additional source resonator by applying a voltage to the at least one additional source resonator. The voltage applied to the at least one additional source resonator can be a static voltage. The voltage applied to the at least one additional source resonator can be an oscillating voltage. The oscillating voltage applied to the at least one additional source resonator can differ in phase from each of the oscillating voltages applied to the first and second pairs of source resonators. The oscillating voltages applied to each of the first and second pairs of source resonators and the at least one additional source resonator can differ in phase from one another by 20° or more (e.g., 30° or more, 40° or more, 50° or more, 60° or more, 70° or more, 80° or more).

The controller can be configured to receive a feedback signal from the power receiving apparatus, and the feedback signal can include information about a charge capacity of the power receiving apparatus. The feedback signal can include at least one of a radiofrequency signal, an optical signal, and a change in inductance of the at least one receiving resonator of the power receiving apparatus. The controller can be configured to adjust a frequency of at least one of the oscillating voltages applied to the first and second pairs of source resonators based on the feedback signal. The controller can be configured to adjust the phase of at least one of the oscillating voltages applied to the first and second pairs of source resonators based on the feedback signal.

The at least one receiving resonator can include a hollow core formed from a magnetic material and a loop of conducting material surrounding at least a portion of the magnetic material. The magnetic material can include a ferrite material.

The at least one receiving resonator can include multiple loops of the conducting material defining a coil. The conducting material of the at least one receiving resonator can include at least one of a conducting wire, a conducting Litz wire, and a conducting ribbon. Control electronics can be positioned within the hollow core.

The at least one receiving resonator can include a coil supported by a flexible substrate, and the substrate can be wrapped around the hollow core.

The power receiving apparatus can be configured so that when the power receiving apparatus is engaged with the battery compartment of the battery-operated device, the power receiving apparatus inductively transfers power directly to the device. The power receiving apparatus can include one or more power storage cells, and the power receiving apparatus can be configured to transfer power received from the power transmitting apparatus to the one or more power storage cells.

Embodiments of the systems can also include any of the other features disclosed herein, including features disclosed in connection with other systems, in any combination, as appropriate.

In another aspect, the disclosure features systems for wireless transmission of power to a battery-operated device, the systems including a power receiving apparatus featuring at least one receiving resonator and a housing dimensioned to engage with a battery compartment of a battery-operated device, and a power transmitting apparatus that includes: a first pair of source resonators spaced from one another, where each source resonator in the first pair features a loop of conducting material surrounding a common first axis; a second pair of source resonators spaced from one another, where each source resonator in the second pair features a loop of conducting material surrounding a common second axis perpendicular to the first axis; at least one additional source resonator featuring a loop of conducting material surrounding a common third axis perpendicular to the first and second axes; and a controller coupled to the first and second pairs of source resonators and to the at least one additional resonator and configured to provide non-radiative wireless power transfer from the power transmitting apparatus to the power receiving apparatus by alternately activating in sequence: (i) the first pair of source resonators and the second pair of source resonators; (ii) the first pair of source resonators and the at least one additional source resonator; and (iii) the second pair of source resonators and the at least one additional source resonator.

Embodiments of the systems can include any one or more of the following features.

Each one of the first pair of source resonators, each one of the second pair of source resonators, and each one of the at least one additional source resonator can include multiple loops of the conducting material defining a coil.

The power transmitting apparatus can include a housing, where the first pair of source resonators can be positioned on different sides of the housing, and where the second pair of source resonators can be positioned on different sides of the housing. The first and second pairs of source resonators and the at least one additional source resonator can be positioned within walls of the housing. The housing can enclose the power transmitting apparatus and can include an aperture dimensioned to allow the power receiving apparatus to be introduced into the housing. The housing can have a form factor that corresponds to one of a bowl and a box. The housing can include one or more movable elements so that a form factor of the housing is configurable. The housing can be transformable between a first form factor and a second form factor. The first form factor can include a planar shape.

Each one of the first pair of source resonators, the second pair of source resonators, and the at least one additional source resonator can be an electromagnetic resonator having a resonant frequency f=ω/2π, an intrinsic loss rate Γ, and a Q-factor Q=ω/(2Γ), where the Q-factor for at least one of the first pair of source resonators and for at least one of the second pair of source resonators can be greater than 100. Each one of the first pair of source resonators, the second pair of source resonators, and the at least one additional source resonator can have a capacitance and an inductance that define the resonant frequency f.

The controller can be configured to activate the first pair of source resonators and the second pair of source resonators for a time period t₁, the first pair of source resonators and the at least one additional source resonator for a time period t₂, and the second pair of source resonators and the at least one additional source resonator for a time period t₃. The controller can be configured to activate the first and second pairs of source resonators and the at least one additional source resonator such that t₁, t₂, and t₃ are the same.

The controller can be configured to receive a feedback signal from the power receiving apparatus, and the feedback signal can include information about a charge capacity of the power receiving apparatus. The feedback signal can include at least one of a radiofrequency signal, an optical signal, and a change in inductance of the at least one receiving resonator of the power receiving apparatus. The controller can be configured to adjust at least one of t₁, t₂, and t₃ based on the feedback signal.

The at least one additional source resonator can include one source resonator. The at least one additional source resonator can include a pair of source resonators spaced from one another.

Embodiments of the systems can also include any of the other features disclosed herein, including features disclosed in connection with other systems, in any combination as appropriate.

In a further aspect, the disclosure features devices for wireless transmission of power to a power receiving apparatus featuring at least one receiving resonator, the devices including a first pair of source resonators spaced from one another, where each source resonator in the first pair features a loop of conducting material surrounding a common first axis; a second pair of source resonators spaced from one another, where each source resonator in the second pair features a loop of conducting material surrounding a common second axis different from the first axis; and a controller coupled to the first and second pairs of source resonators and configured to provide non-radiative wireless power transfer from the device to the power receiving apparatus by alternately: activating the first pair of source resonators to transfer power from the first pair of source resonators to the power receiving apparatus; and activating the second pair of source resonators to transfer power from the second pair of source resonators to the power receiving apparatus.

Embodiments of the devices can include one or more of the following features.

Each one of the first pair of source resonators and each one of the second pair of source resonators can include multiple loops of the conducting material defining a coil.

The controller can be configured to activate the first and second pairs of source resonators by applying an oscillating voltage to each pair of source resonators, where the oscillating voltage applied to the first pair of source resonators differs in phase from the oscillating voltage applied to the second pair of source resonators.

The devices can include at least one additional source resonator featuring a loop of conducting material surrounding a common third axis different from the first and second axes, where the controller is coupled to the at least one additional source resonator and configured to activate the at least one additional source resonator by applying a voltage to the at least one additional source resonator. The voltage applied to the at least one additional source resonator can be a static voltage. The voltage applied to the at least one additional source resonator can be an oscillating voltage that differs in phase from the oscillating voltages applied to each of the first and second pairs of source resonators.

The devices can include at least one additional source resonator featuring a loop of conducting material surrounding a common third axis different from the first and second axes, where the controller is configured to activate the first pair of source resonators and the second pair of source resonators for a time period t₁, the first pair of source resonators and the at least one additional source resonator for a time period t₂, and the second pair of source resonators and the at least one additional source resonator for a time period t₃. The first, second, and third axes can be substantially mutually perpendicular. The controller can be configured to activate the first and second pairs of source resonators and the at least one additional source resonator such that t₁, t₂, and t₃ are the same.

Each one of the first and second pairs of source resonators can be an electromagnetic resonator having a resonant frequency f=ω/2π, an intrinsic loss rate Γ, and a Q-factor Q=ω/(2Γ), and the Q-factor for at least one of the first pair of resonators and for at least one of the second pair of resonators can be greater than 100.

Embodiments of the devices can also include any of the other features disclosed herein, including features disclosed in connection with any of the systems, in any combination as appropriate.

In another aspect, the disclosure features methods for wireless transmission of power to a power receiving apparatus, the methods including: applying an oscillating voltage to a first pair of source resonators spaced from one another, where each source resonator in the first pair features a loop of conducting material surrounding a common first axis, to transfer power from the first pair of source resonators to a receiving resonator in the power receiving apparatus; and applying an oscillating voltage to a second pair of source resonators spaced from one another, where each source resonator in the second pair features a loop of conducting material surrounding a common second axis different from the first axis, to transfer power from the second pair of source resonators to the receiving resonator, where the oscillating voltage applied to the first pair of source resonators differs in phase from the oscillating voltage applied to the second pair of source resonators.

Embodiments of the methods can include any one or more of the following features.

The difference in phase can be approximately 90°. The difference in phase can be 20° or more (e.g., 30° or more, 40° or more, 50° or more, 60° or more, 70° or more, 80° or more).

The methods can include applying a voltage to at least one additional source resonator featuring a loop of conducting material surrounding a common third axis different from the first and second axes to transfer power from the at least one additional source resonator to the receiving resonator. The first, second, and third axes can be substantially mutually perpendicular. The voltage applied to the at least one additional source resonator can be a static (e.g., constant) voltage. Over a period during which power is transmitted to the power receiving apparatus, the voltage applied to the at least one additional source resonator can vary by 10% or less (e.g., 5% or less, 2% or less, 1% or less, 0.5% or less, 0.1% or less) of its mean value during the period. The voltage applied to the at least one additional source resonator can be an oscillating voltage that differs in phase from the oscillating voltages applied to the first and second pairs of source resonators.

Embodiments of the methods can also include any of the other features or steps disclosed herein, including features disclosed in connection with other methods, in any combination as appropriate.

In a further aspect, the disclosure features methods for wireless transmission of power to a power receiving apparatus, the methods including: (a) during a first time period, applying a voltage to a first pair of source resonators spaced from one another, where each source resonator in the first pair features a loop of conducting material surrounding a common first axis, and applying a voltage to a second pair of source resonators spaced from one another, where each source resonator in the second pair features a loop of conducting material surrounding a common second axis perpendicular to the first axis; (b) during a second time period, applying a voltage to the first pair of source resonators and applying a voltage to at least one additional source resonator featuring a loop of conducting material surrounding a common third axis perpendicular to the first and second axes; (c) during a third time period, applying a voltage to the second pair of source resonators and applying a voltage to the at least one additional source resonator; and (d) repeating (a)-(c) to transmit power wirelessly from the first and second pairs of source resonators and the at least one additional source resonator to a receiving resonator in the power receiving apparatus.

Embodiments of the methods can include any one or more of the following features.

The first, second, and third time periods can be equal in duration. At least one of the first, second, and third time periods can be different in duration from other time periods. The first, second, and third axes can be mutually perpendicular.

The methods can include receiving a signal from the power receiving apparatus, where the signal includes information about a charge capacity of the power receiving apparatus, and adjusting at least one of the first, second, and third time periods based on the signal.

Embodiments of the methods can also include any other features disclosed herein, including features disclosed in connection with other methods, in any combination as appropriate.

The systems and methods disclosed in this disclosure provide numerous benefits and advantages (some of which may be achieved only in some of the various aspects and embodiments) including the following.

In some embodiments, the disclosed techniques can be used to manufacture a wirelessly chargeable battery with a dimension of a standard battery (e.g., AA, AAA battery) while incorporating one or more resonators and electronics. This may allow a user to easily replace a standard battery used to power a battery-operated device by the wirelessly chargeable battery without modifying a battery compartment of the battery-operated device. The wireless chargeable battery can be charged remotely without being physically connected to a power outlet. This approach may reduce a need to open the battery compartment to replace standard batteries, and thereby the user may conveniently use the battery-operated device with decreased cost and maintenance efforts.

In some embodiments, a wirelessly rechargeable battery can have elements including one or more resonators and control electronics. These elements can be designed and arranged to have a large battery cell for a given volume of the wireless chargeable battery. For example, the one or more resonators can be made from thin flexible conductors and the control electronics can include poly switches or DC circuits to reduce its footprint. Maximizing a volume of the battery cell leads to a larger capacity energy storage of the battery, and thereby the battery can provide power to a battery-operated device for a longer duration.

In some embodiments, a wirelessly chargeable battery can have a shielding element to improve an efficiency of power transfer from a source resonator to the wirelessly rechargeable battery. For example, the shielding element includes a magnetic material, which is arranged between a receiver resonator and a battery cell of the wirelessly rechargeable battery. Use of such a shielding element can prevent energy losses induced by lossy materials in the battery cell. This can lead to faster power charging of the wirelessly chargeable battery.

In certain embodiments, a wirelessly chargeable battery can have elements which are arranged to provide a robust and ruggedized structure of the battery. For example, a power receiving sub-structure can be connected to a battery cell in a way to reduce force applied along a coaxial direction of the battery cell. A spring element can be placed within the battery to absorb the force. The ruggedized structure can improve the mechanical reliability of the battery, which may include additional elements compared to a standard battery.

In some embodiments, a power transmitting apparatus can include one or more resonators to wirelessly transmit power to a power receiving apparatus. The one or more resonators can be activated in various configurations to effectively transmit power to the power receiving apparatus. For example, the one or more resonators can be operated to generate a time-varying magnetic field changing directions in a three-dimensional space (3D), which may effectively provide power to one or more receiving resonators oriented randomly in the 3D space.

Unless otherwise defined, all technical and scientific terms used herein have the same meaning as commonly understood by one of ordinary skill in the art to which this disclosure belongs. In case of conflict with publications, patent applications, patents, and other references mentioned or incorporated herein by reference, the present disclosure, including definitions, will control. Any of the features described above may be used, alone or in combination, without departing from the scope of this disclosure. Other features, objects, and advantages of the systems and methods disclosed herein will be apparent from the following detailed description and figures.

### BRIEF DESCRIPTION OF THE DRAWINGS

FIG. 1 is a schematic diagram of a resonator.

FIGS. 2a-c are schematic diagrams showing examples of resonators.

FIGS. 3a and 3b are schematic diagrams showing examples of resonators.

FIGS. 4a-c are schematic diagrams showing an example of a resonator with its characteristics size, thickness and width indicated.

FIG. 5 is a schematic diagram of a resonator in presence of a load.

FIG. 6 is a schematic diagram of a resonator in presence of a perturbation.

FIG. 7 is a schematic diagram showing an example arrangement of wireless power transfer.

FIG. 8 is a plot of efficiency, η, vs. strong coupling factor, U==κ\sqrt{ΓₛΓ_{d}}=k=\sqrt{QₛQ_{d}}.

FIG. 9 is a schematic diagram showing an example arrangement of wireless power transfer.

FIGS. 10a-d are schematic diagrams showing example arrangements of wireless power transfer.

FIGS. 11a-c are schematic diagrams showing an example of a wirelessly chargeable battery.

FIG. 11d is a schematic diagram showing another example of a wirelessly chargeable battery.

FIGS. 11e-h are schematics diagrams showing examples of wirelessly chargeable batteries.

FIG. 11i is a photo of standard size batteries.

FIGS. 12a-e are schematic diagrams showing examples of wirelessly chargeable batteries.

FIGS. 13a-b are schematic diagrams showing examples of wirelessly chargeable batteries.

FIG. 13c is a table showing a list of examples of magnetic materials.

FIGS. 14a-e are schematic diagrams showing examples of wirelessly chargeable batteries.

FIGS. 15a-b are schematic diagrams showing examples of wirelessly chargeable batteries.

FIGS. 16a-b are tables listing exemplary sizes and specifications of battery cells.

FIG. 17a is a schematic diagram showing an example of a power transmitting apparatus.

FIG. 17b is a schematic diagram showing an example of a power transmitting apparatus.

FIG. 18a is a schematic diagram showing an example of a power transmitting apparatus.

FIG. 18b is a schematic diagram showing an example coil.

FIG. 18c is a schematic diagram showing example operations of the power transmitting apparatus shown in FIG. 18a.

FIG. 18d is a schematic diagram showing an example of a power transmitting apparatus.

FIG. 19 is a schematic diagram showing another example of a power transmitting apparatus.

FIG. 20 is a schematic diagram showing another example of a power transmitting apparatus.

FIGS. 21a-b are schematic diagrams showing examples of multiple coils.

FIGS. 22a-b are schematic diagrams showing examples of a power transmitting apparatus.

FIGS. 23a-c are schematic diagrams showing examples of a power transmitting apparatus.

FIG. 24 is a schematic diagram showing an example of a power transmitting apparatus.

FIG. 25a-b are schematic diagrams showing a side view and a top view of an example of a power transmitting apparatus.

FIGS. 26a-b are schematic diagrams showing top views of examples of a power transmitting apparatus.

FIG. 27 is a schematic diagram showing an example arrangement of wireless power transfer.

FIG. 28 is a series of photos showing examples of wireless power transmission systems.

FIG. 29 is a schematic diagram showing an example of a power receiving apparatus.

FIG. 30a is a photo of another example of a wirelessly chargeable battery.

FIG. 30b is a photo of a battery housing.

FIG. 31 is a series of photos showing examples of toys with battery compartments.

FIG. 32 is a series of photos of examples of a power transmitting apparatus.

FIG. 33 is a flow chart depicting an example process for wireless power transfer.

FIG. 34 is a flow chart depicting another example process for wireless power transfer.

Like reference numbers and designations in the various drawings indicate like elements.

### DETAILED DESCRIPTION

The methods and systems described herein can be implemented in many ways. Some useful embodiments are described below. However, the scope of the present disclosure is not limited to the detailed embodiments described in this section.

A power transmitting apparatus can be configured to transmit power to a power receiving apparatus. For example, the power receiving apparatus can include one or more wirelessly chargeable batteries. One or more receiver resonators can be integrated into the one or more batteries, thereby allowing the battery to be wirelessly rechargeable. As such, a user may conveniently charge the one or more batteries without physical connecting wires to the batteries. The use may not need to often replace the batteries, thereby reducing maintenance needs of an electronic device.

The power transmitting apparatus can include one or more source resonators, which can be activated by a controller. The controller can activate the one or more source resonators in a way to generate time-varying magnetic fields in a 3D space in which the power receiving apparatus is positioned. In some cases, the one or more receiver resonators of the power receiving apparatus are positioned in a random orientation. The disclosed techniques can be used to activate the one or more source resonators to effectively transmit power to the randomly oriented receiver resonators. This may allow a user to randomly position the power receiving apparatus without worrying about the orientations of its receiver resonators. In some other case, the one or more source resonators can be active to transmit power to a selected orientation of the receiver resonators. In some embodiments, the power transmitting apparatus and the power receiving apparatus can communicate to optimize the power transfer depending on a condition of the power receiving apparatus. For example, when one or more batteries of the power receiving apparatus is charged above a threshold capacity, the power transmitting apparatus can reduce or stop the power transmission based on the communication.

Single Resonator

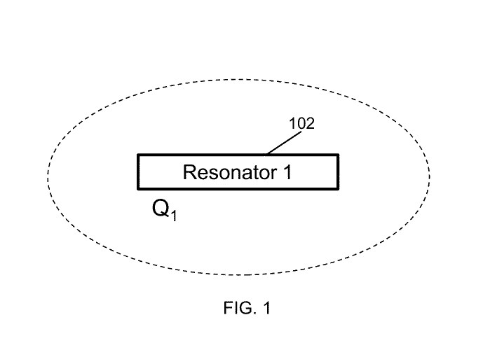

A resonator may be defined as a system that can store energy in at least two different forms (e.g., electric and magnetic fields), and where the stored energy is oscillating between the two forms. FIG. 1 is a schematic diagram of a resonator 102, which is capable of storing energy. Generally, the resonator 102 can have one or more resonances. A resonance of the resonator 102 has an oscillation mode with a resonant frequency f and a resonant field distribution. The resonant frequency f may refer to the frequency when the resonance can be excited most strongly with a given input stimulus. Angular resonant frequency ω is defined as ω=2πf, and the resonant wavelength λ is defined as λ=c/f (where c is the speed of light.) Resonant period T is defined as T=1/f=2π/ω.

In the absence of loss mechanisms, coupling mechanisms or external energy supplying or draining mechanisms, total stored energy W of the resonator 102 remains fixed. On the other hand, when the resonator 102 has intrinsic losses (e.g., radiation damping, absorption losses), the stored energy decays. Resonant fields of the resonator 102 can be represented according to Eq. (1), shown below:

$$\frac{d a ( t )}{d t} = - i ( ω - i Γ ) a ( t ) , \qquad ( 1 )$$

where a(t) is the resonant field amplitude, defined so that the energy contained within the resonator is given by |a(t)|². Γ is the intrinsic amplitude decay or loss rate (e.g. due to absorption and radiation losses) of the resonant fields. Γ or Q may be measured by a Standing-Wave Ratio (SWR) analyzer.

The resonator 102 can also be described to have a quality factor Q (also referred to as the “Q-factor”) for the given resonance. The Q characterizes the energy decay and is inversely proportional to the energy losses. The Q can be defined as Q=ω*W/P, where P is the time-averaged power lost at steady state. As such, when the resonator 102 has a high Q, the resonator 102 has relatively low intrinsic losses and can store energy for a relatively long time. Because the resonator 102 loses energy at its intrinsic energy decay or energy loss rate, 2Γ, its Q, also referred to as its intrinsic Q, is given by Q=ω/2Γ. The bandwidth of the resonator 102 is given by Δω=2Γ or Δf=Γ/π. For example, Δf may refer to the width of frequencies for which the energy is at least half of its peak value when excited by a stimulus. When Q=100, Δf=f/Q=0.01f. The Q can be related to the number of oscillation periods for the energy to decay by a factor of Euler's number e. The Q can be expressed as Eq. (2), shown below:

Q=ωL/(R_{abs}+R_{rad}) (2)

where R_{rad} is the radiative loss and R_{abs} is the absorption loss of the resonator 102.

As described above, Q is related to intrinsic loss mechanisms (e.g., radiation damping, absorption losses.) A subscript index can be used to indicate the resonator to which the Q refers. For example, FIG. 1 shows the (intrinsic) quality factor Q₁ of the resonator 102 (resonator 1 in this case) labeled according to this convention.

Examples of Resonators

A resonator 102 can be an electromagnetic resonator, which can include an inductive element, a distributed inductance, or a combination of inductances with inductance, L, and a capacitive element, a distributed capacitance, or a combination of capacitances, with capacitance, C. The electromagnetic resonator can be described to be a magnetic resonator or an electric resonator. For example, a magnetic resonator can have energy stored by the electric field to be primarily confined within its structure and the energy stored by the magnetic field to be primarily in the region surrounding its structure. In this case, the magnetic resonator can be used to transfer energy primarily by the resonant magnetic near-field. As another example, an electric resonator can have energy stored by the magnetic field to be primarily confined within its structure and that the energy stored by the electric field to be primarily in the region surrounding its structure. In this case, the electric resonator can be used to transfer energy primarily by the resonant electric near-field.

The total electric and magnetic energies stored by the resonator may be equal, but with different spatial field distributions. For example, the ratio of the average electric field energy to the average magnetic field energy specified at a distance (e.g., 1L, 2L, 3L, 5L, where L is the characteristic size described below) from the center of a resonator 102 can be 1 or larger (e.g., 2 or larger, 5 or larger, 10 or larger, 100 or larger.) As another example, the ratio of the average magnetic field energy to the average electric field energy specified at a distance (e.g., 1L, 2L, 3L, 5L) from the center of the resonator 102 can be 1 or larger (e.g., 2 or larger, 5 or larger, 10 or larger, 100 or larger.) In some embodiments, the electromagnetic resonator is capable of storing electromagnetic energy.

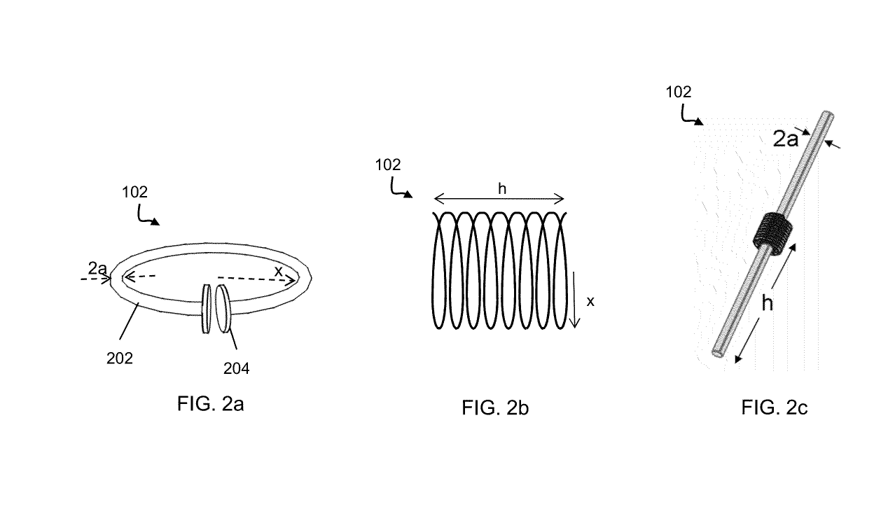

FIGS. 2a-c are schematic diagrams of examples of resonators. FIG. 2a is a schematic diagram of an example of a capacitively-loaded loop inductor, which may be a magnetic resonator. In FIG. 2a, x is the radius of the enclosed circular surface area and a is the radius of the conductor used to from loop 202. Loop 202 can provide an inductance and capacitor 204 can provide a capacitance to a resonator 102. In parts of this disclosure, the capacitively-loaded loop inductor may be illustrated as an example of resonator 102.

FIG. 2b is a schematic diagram of an example of multi-turn conductor, which may be a magnetic resonator. In FIG. 2b, h is the height of the multi-turn conductor. The capacitance may be distributed and be realized between adjacent windings of multiple turns of wire. FIG. 2c shows an example of an electric resonator, where a is the radius of the conducting rod and h is the half length of the rod.

As used herein, a “loop” is formed by a material that encloses a surface of any shape or dimension. A loop can be planar (e.g., two-dimensional) or non-planar, such as helical (e.g., three-dimensional). Typically, loops are formed of one or more conducting materials (e.g., conducting wire, Litz wire, conducting tubes, ribbon cable, conducting strips, conducting traces). Loops can be self-supported, or supported by a substrate (e.g., a rigid substrate or a flexible substrate such as a flexible circuit board, paper, or another deformable substrate material). As used herein, a “coil” is formed by one or more loops. Typically, the one or more loops are concentric and define a coil axis. For planar loops, the coil axis is typically perpendicular to the plane of the loops. For helical loops, the coil axis typically corresponds to the helical axis.

It will be understood, that resonator 102 may be other types of resonators other than those shown in FIGS. 2a-c.

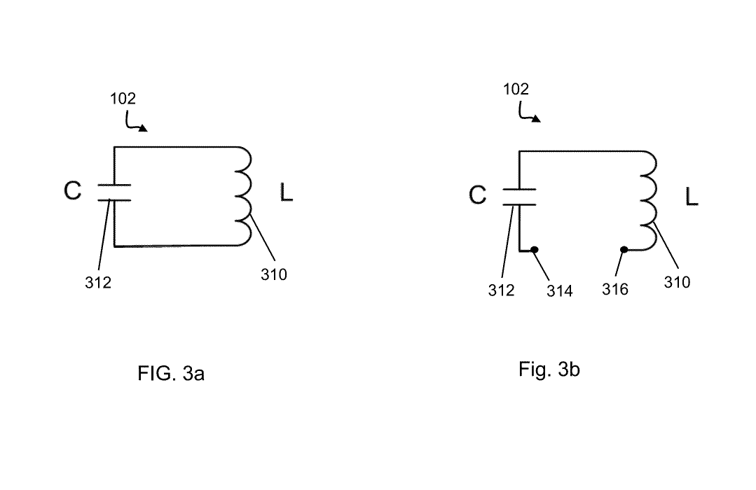

FIGS. 3a and 3b are schematic diagrams of examples of resonators, which can include one or more inductors and one or more capacitors. In these examples, inductor 310 indicates an inductive element and capacitor 312 indicates a capacitive element. It is understood that electromagnetic resonators (including the examples shown in FIGS. 2a-c) can be schematically described by the circuits shown in FIGS. 3a and 3b. Provided with initial energy, such as electric field energy stored in the capacitor 312, energy in the resonator 102 can oscillate as the capacitor 212 discharges and transfers energy into magnetic field energy stored in the inductor 310 which in turn transfers energy back into electric field energy stored in the capacitor 312 and so on.

FIG. 3a is a schematic diagram showing an example of a resonator 102, where an inductor 310 and a capacitor 312 form a closed circuit. Power can be transferred in or out of the resonator 102 by physically connecting a power source or a load device to the resonator 102. Alternatively, power may be transferred to or from the resonator 102 in a non-contact manner (e.g., inductive manner.) FIG. 3b is a schematic diagram showing another example of a resonator 102, where an inductor 310 and a capacitor 312 form an open circuit. In this example, power can be transferred to or from the resonator 102 by physically connecting a power source or load device to the two ends 314 and 316 and forming a closed loop. Alternatively, additional circuit elements may be added to close the circuit of the resonator 102, and then power may be transferred in a non-contact manner.

In some embodiments, a resonator 102 can include resistors, diodes, switches, amplifiers, diodes, transistors, transformers, conductors and connectors.

Resonant Frequency

In some embodiments, the angular resonant frequency ω of a resonator 102 can be expressed as Eq. (3), shown below:

$$ω = 2 π f = \sqrt{\frac{1}{LC}} . \qquad ( 3 )$$

where L represents the inductance and C represents the capacitance of the resonator 102. The resonant frequency can be changed by changing the inductance L and/or the capacitance C. In some embodiments, at least some portion of L and/or C of the resonator 102 may be tunable. The resonator frequency may be designed to operate at the so-called ISM (Industrial, Scientific and Medical) frequencies as specified by the FCC. The resonator frequency may be chosen to meet certain field limit specifications, specific absorption rate (SAR) limit specifications, electromagnetic compatibility (EMC) specifications, electromagnetic interference (EMI) specifications, component size, cost or performance specifications. In some embodiments, the resonant frequency can be in a range of 10 kHz to 100 MHz.

Characteristic Size of a Resonator

Power transfer between two resonators may occur for mid-range distances larger than the characteristic dimension L of the smallest of the resonators involved in the transfer, where the distances are measured from the center of one resonator structure to the center of the other resonator.

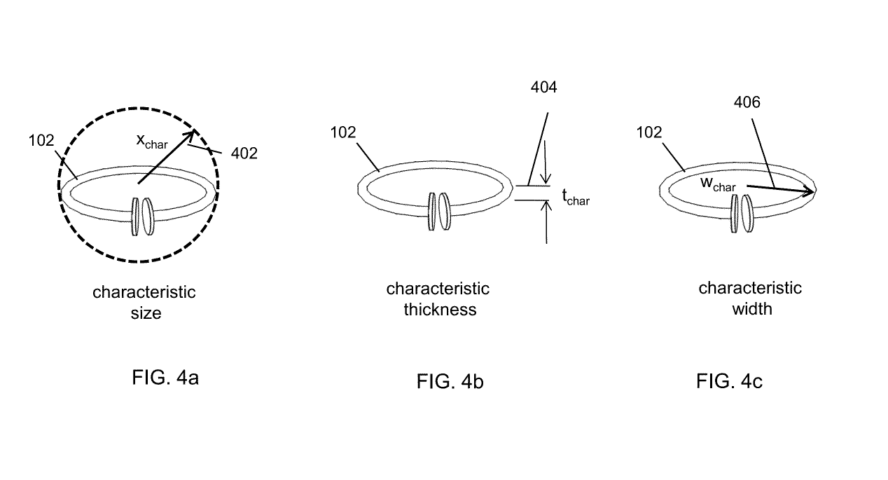

FIG. 4a is a schematic diagram showing an example of a resonator 102 with characteristic size, x_{char}, (or L), 402 defined to be the radius of the smallest sphere that can fit around the resonator 102. The center of the resonator structure 102 is the center of the sphere. FIG. 4b is a schematic diagram showing an example of a resonator 102 with characteristic thickness, t_{char}, 404 that is defined to be the smallest possible height of the highest point of the resonator 102, measured from a flat surface on which it is placed. FIG. 4c is a schematic diagram showing an example of a resonator 102 with characteristic width, w_{char}, 406 of a resonator 102 defined to be the radius of the smallest possible circle through which the resonator 102 may pass while traveling in a straight line. For example, the characteristic width 406 of a cylindrical resonator may be the radius of the cylinder.

Loaded Resonator

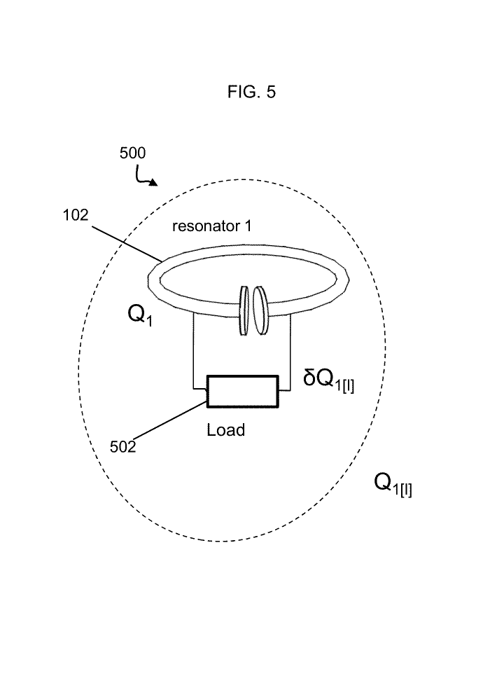

In some embodiments, extraneous objects and/or additional resonators in the vicinity of a resonator 102 may perturb or load the resonator 102, thereby perturbing or loading the Q of the resonator 102. FIG. 5 is a schematic diagram showing a resonator system 500 including a resonator 102 which is “loaded” by an object 502 (e.g., power source, load device.) The object 502 can couple to the resonator 102 through direct contact, as shown in FIG. 5, and/or in a non-contact manner. The amount of load on resonator 102 due to object 502 depends on a variety of factors such as the distance between the resonator 102 and the object 502, the presence of other extraneous objects and/or additional resonators in the vicinity of resonator 102, the material composition of the extraneous objects and/or additional resonators, the structure of the resonator 102, and the power in the resonator 102. Unintended external energy losses or coupling mechanisms to extraneous objects in the vicinity of the resonator 102 may be referred to as “perturbing” the Q of the resonator 102, and may be indicated by a subscript within rounded parentheses, ( ). Intended external energy losses associated with energy transfer via coupling to additional resonators and to generators and loads in a wireless energy transfer system may be referred to as “loading” the Q of the resonator, and may be indicated by a subscript within square brackets, [ ].

The Q of a resonator system 500 with a resonator 102 connected or coupled to a power generator, g, or load 502, l, may be called the “loaded quality factor” or the “loaded Q” and may be denoted by Q_{[g]} or Q_{[l]}, as illustrated in FIG. 5. In some embodiments, there may be more than one generator or load connected to a resonator 102. The subscripts “g” and “l” can be used to refer to the equivalent circuit loading imposed by the combinations of generators and loads. The subscript “l” may refer to either generators or loads connected to the resonators.

The “loading quality factor” or the “loading Q” may be used to describe herein the resulting Q of the resonator system 500 due to a power generator or load connected to the resonator, as δQ_{[l]}, where, 1/δQ_{[l]}≡1/Q_{[l]}−1/Q. The larger the loading Q, δQ_{[l]}, of a generator or load, the less the loaded Q, Q_{[l]}, deviates from the unloaded Q of the resonator 102.

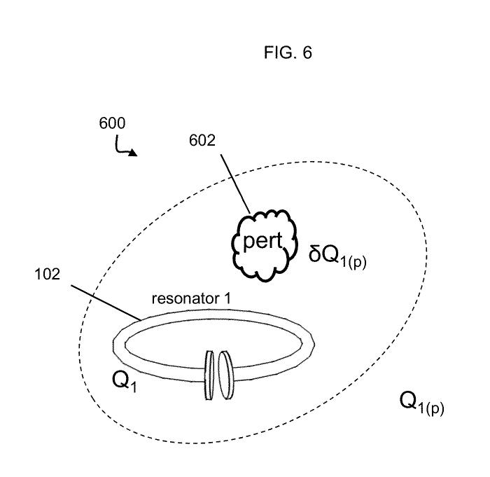

FIG. 6 is a schematic diagram showing a resonator system 600. The Q of the resonator system 600 in the presence of an extraneous object 602, p, that is not intended to be part of the energy transfer system may be called the “perturbed quality factor” or the “perturbed Q” and may be denoted by Q₍ₚ₎, as illustrated in FIG. 6. In general, there may be many extraneous objects, denoted as p1, p2, etc., or a set of extraneous objects {p}, that perturb the Q of the resonator 102. In this case, the perturbed Q may be denoted Q_{(p1+p2+ . . . )} or Q_{({p})}. For example, Q_{1(brick+wood)} may denote the perturbed quality factor of a first resonator 102 in a system for wireless energy transfer in the presence of a brick and a piece of wood, and Q_{2({office})} may denote the perturbed quality factor of a second resonator 201 in a system for wireless energy transfer in an office environment.

The “perturbing quality factor” or the “perturbing Q” refers to the resulting Q of the resonator system 500 due to an extraneous object, p, as δQ₍ₚ₎, where 1/δQ₍ₚ₎≡1/Q₍ₚ₎−1/Q. As stated before, the perturbing quality factor may be due to multiple extraneous objects, p1, p2, etc. or a set of extraneous objects, {p}. The larger the perturbing Q, δQ₍ₚ₎, of an object, the less the perturbed Q, Q₍ₚ₎, deviates from the unperturbed Q of the resonator.

The “quality factor insensitivity” or the “Q-insensitivity” of a resonator 102 in the presence of an extraneous object 502 is defined as Θ₍ₚ₎≡Q₍ₚ₎/Q. A subscript index, such as Θ₁₍ₚ₎, indicates the resonator to which the perturbed and unperturbed quality factors are referring, namely, Θ₁₍ₚ₎≡Q₁₍ₚ₎/Q₁.

Note that quality factor, Q, may also be characterized as “unperturbed”, when necessary to distinguish it from the perturbed quality factor, Q₍ₚ₎, and “unloaded”, when necessary to distinguish it from the loaded quality factor, Q_{[l]}. Similarly, the perturbed quality factor, Q₍ₚ₎, may also be characterized as “unloaded”, when necessary to distinguish them from the loaded perturbed quality factor, Q_{(p)[l]}.

In some embodiments, the intrinsic Q of a resonator 102 can be deduced by measuring the power that the resonator 102 receives from a power source as a function of frequency. For example, the observed full-width-half maximum (FWHM) of the measured spectra may be related to Q.

Power Transfer between Two Resonators

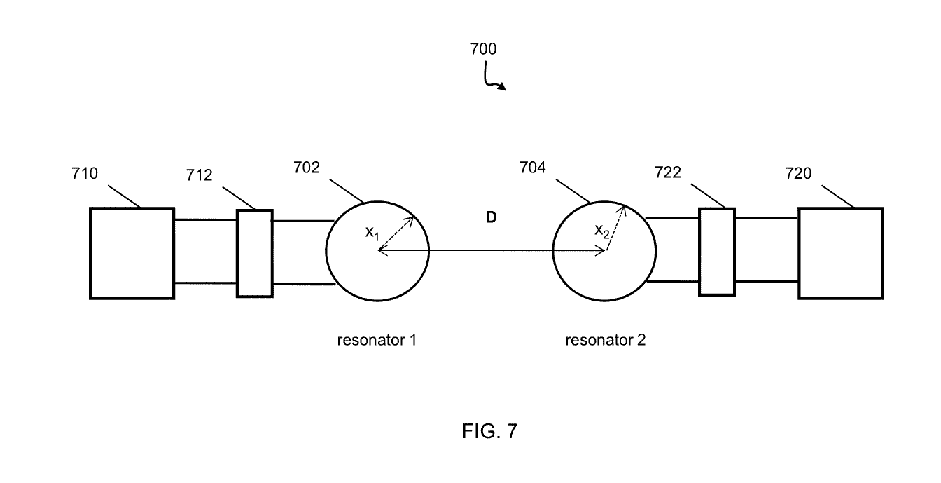

FIG. 7 is a schematic diagram showing an example arrangement of a power transfer scheme 700 between a source resonator 702 and a receiver resonator 704 with a separation D. A power source 710 is coupled to the source resonator 702 through an impedance matching circuit 712, which is used to tune the impedance matching condition between the power source 710 and the source resonator 702. Coupling between the power source 710 and the impedance matching circuit 712 can be achieved through physical contact or in a non-contact manner. Similarly, coupling between the impedance matching circuit 712 and the source resonator 702 can be achieved through physical contact or in a non-contact manner. In some embodiments, the power source 710 is directly coupled (e.g., physical contact or in a non-contact manner) to the source resonator 702 without the impedance matching circuit 710. In these embodiments, the energy coupling between the power source 710 and the source resonator 702 can be controlled by adjusting the arrangement (e.g., alignment, orientation, separation) between these two elements using an adjustment unit (not shown.) Similarly, the receiving resonator 704 can be coupled to a load device 720 (which consumes power) through an impedance matching circuit 722. Similar features can be applied as described for the relation between the impedance matching circuit 712, power source 710, and source resonator 102.

It is understood that that the source resonator 702 and the receiver resonator 704 each can be any type of resonator 102 described above. In some embodiments, a power source 702 can include a power generator, a solar panel, and/or a battery. A load device can include a load resistor, a mobile device, a lighting device, and/or a battery.

Energy transfer between the source resonator 702 and the receiver resonator 704 can be described using coupled mode theory (CMT.) In coupled mode theory, the resonator fields obey the following set of linear equations Eq. (4), shown below:

$$\frac{d {a}_{m} ( t )}{d t} = - i ( {ω}_{m} - i {Γ}_{m} ) {a}_{m} ( t ) + i {\sum }_{n \neq m} {κ}_{mn} {a}_{n} ( t ) \qquad ( 4 )$$

where the indices denote different resonators and κₘₙ are the coupling coefficients between the resonators. For a reciprocal system, the coupling coefficients may obey the relation κₘₙ=κₙₘ. Note that, for the purposes of the present disclosure, far-field radiation interference effects will be ignored and thus the coupling coefficients will be considered real. Furthermore, since in all subsequent calculations of system performance in this disclosure the coupling coefficients appear only with their square, κₘₙ², we use κₘₙ to denote the absolute value of the real coupling coefficients.

Note that the coupling coefficient, κₘₙ, from the CMT described above is related to the so-called coupling factor, kₘₙ, between resonators m and n by kₘₙ=2κₘₙ/\sqrt{ωₘωₙ}. The “strong-coupling factor”, Uₘₙ, is defined as the ratio of the coupling and loss rates between resonators m and n, by Uₘₙ=κₘₙ/\sqrt{ΓₘΓₙ}=kₘₙ\sqrt{QₘQₙ}.

The quality factor of a resonator m, in the presence of a similar frequency resonator n or additional resonators, may be loaded by that resonator n or additional resonators, in a fashion similar to the resonator being loaded by a connected power generating or consuming device. The fact that resonator m may be loaded by resonator n and vice versa is simply a different way to see that the resonators are coupled.

The loaded Q's of the resonators in these cases may be denoted as Q_{m[n]} and Q_{n[m]}. For multiple resonators or loading supplies or devices, the total loading of a resonator may be determined by modeling each load as a resistive loss, and adding the multiple loads in the appropriate parallel and/or series combination to determine the equivalent load of the ensemble.

In some embodiments, “loading quality factor” or the “loading Qₘ” of resonator m due to resonator n is defined as δQ_{m[n]}, where 1/δQ_{m[n]}−1/Qₘ. Note that resonator n is also loaded by resonator m and its “loading Qₙ” is given by 1/δQ_{n[m]}≡1/Q_{n[m]}−1/Qₙ.

When one or more of the resonators are connected to power generators or loads, the set of linear equations is modified as Eq. (5), shown below:

$$\frac{d {a}_{m} ( t )}{d t} = - i ( {ω}_{m} - i {Γ}_{m} ) {a}_{m} ( t ) + i {\sum }_{n \neq m} {κ}_{mn} {a}_{n} ( t ) - {κ}_{m} {a}_{m} ( t ) + \sqrt{2 {κ}_{m}} {s}_{+ m} ( t ) \\ {s}_{- m} ( t ) = \sqrt{2 {κ}_{m}} {a}_{m} ( t ) - {s}_{+ m} ( t ) , \qquad ( 5 )$$

where s₊ₘ(t) and s₋ₘ(t) are respectively the amplitudes of the fields coming from a generator into the resonator m and going out of the resonator m either back towards the generator or into a load, defined so that the power they carry is given by |s₊ₘ(t)|² and |s₋ₘ(t)|². The loading coefficients κₘ relate to the rate at which energy is exchanged between the resonator m and the generator or load connected to it.

Note that the loading coefficient, κₘ, from the CMT described above is related to the loading quality factor, δQ_{m[l]}, defined earlier, by δQ_{m[l]}=ωₘ/2κₘ.

The “strong-loading factor”, U_{m[l]}, is defined as the ratio of the loading and loss rates of resonator m, U_{m[l]}=κₘ/FΓₘ=Qₘ/δQ_{m[l]}.

Referring to FIG. 7, work may be extracted from the receiver resonator 704 by the load device 720. In the following, the subscript “s” is used to denote the source resonator 702, and the subscript “d” is used to denote the receiving resonator 704 (also referred to as “g” for the power source 710, and “l” for the load device 720). In this example, κ_{sd}=κ_{ds} because there are only two resonators, and in the following, indices on κ_{sd}, k_{sd}, and U_{sd} are dropped as κ, k, and U, respectively. In the following description of CMT, the power source 710 is considered to be directly coupled to the source resonator 702, and the receiver resonator 704 is considered to be directly connected to the load device 720, without impedance matching circuits 712 and 722.

The power source 710 may be constantly driving the source resonator 702 at a constant operating frequency, fₒ, corresponding to an angular operating frequency, ωₒ, where ωₒ=2πfₒ.

In this case, the efficiency, η=|s_{-d}|²/|s₊ₛ|², of the power transmission from the power source 710 to the load device 720 (via the source and receiver resonators) is maximized under the following conditions: the source resonant frequency, the device resonant frequency and the generator operating frequency are matched, namely ω=ω_{d}=ωₒ. Furthermore, the loading Q of the source resonator 702 due to the power source 710, δQ_{s[g]}, should be matched (equal) to the loaded Q of the source resonator 710 due to the receiver resonator 704 and the load, Q_{s[dl]}, and inversely the loading Q of the receiver resonator 704 due to the load, δQ_{d[l]}, should be matched (equal) to the loaded Q of the receiver resonator 704 due to the source resonator 702 and the power source 710, Q_{d[sg]}, namely δQ_{s[g]}=Q_{s[dl]} and δQ_{d[l]}=Q_{d[sg]}. These equations determine the optimal loading rates of the source resonator 702 by the power source 710 and of the receiver resonator 720 by the load as Eq. (6), shown below:

U_{d[l]}=κ_{d}/Γ_{d}=Q_{d}/δQ_{d[l]}=\sqrt{1+U²}=\sqrt{1+(κ/\sqrt{ΓₛΓ_{d}})²}=Qₛ/δQ_{s[g]}=κₛ/Γₛ=U_{s[g]}. (6)

Note that the above frequency matching and Q matching conditions are together known as “impedance matching” in electrical engineering.

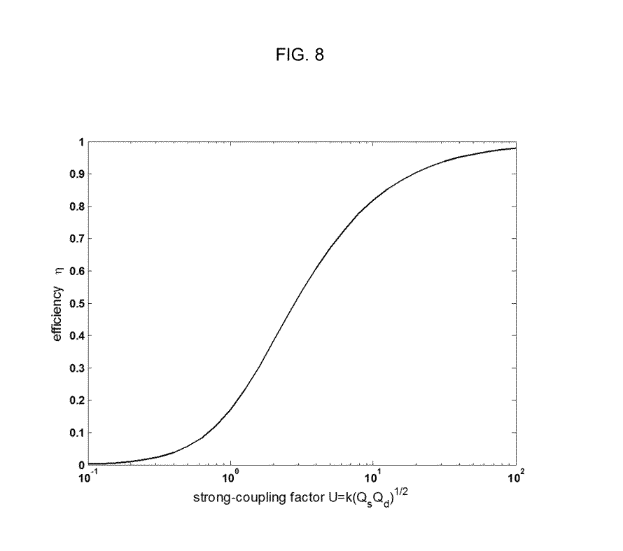

Under the above conditions, the maximized efficiency is a monotonically increasing function of only the strong-coupling factor, U=κ/\sqrt{ΓₛΓ_{d}}=k\sqrt{QₛQ_{d}}, between the source and receiver resonators and is given by, η=U²/(1+\sqrt{1+U²})², as shown in FIG. 8. The coupling efficiency, 17, is greater than 1% when U is greater than 0.2, is greater than 10% when U is greater than 0.7, is greater than 17% when U is greater than 1, is greater than 52% when U is greater than 3, is greater than 80% when U is greater than 9, is greater than 90% when U is greater than 19, and is greater than 95% when U is greater than 45. In some applications, the regime of operation where U>1 may be referred to as the “strong-coupling” regime.

Because a large u=κ/\sqrt{ΓₛΓ_{d}}=(2κ/\sqrt{ωₛω_{d}})\sqrt{QₛQ_{d}} is desired in certain circumstances, source resonator 702 and receiver resonator 704 may be used that are high-Q. The Q of each resonator 702 and 704 may be high. The geometric mean of the resonator Q's, \sqrt{QₛQ_{d}} may also or instead be high.

The coupling factor, k, is a number between 0≦k≦1, and it may be independent (or nearly independent) of the resonant frequencies of the source resonator 702 and receiver resonator 704, rather it may be determined mostly by their relative geometry and the physical decay-law of the field mediating their coupling. In contrast, the coupling coefficient, κ=k\sqrt{ωₛω_{d}}/2, may be a strong function of the resonant frequencies. The resonant frequencies of the resonators 702 and 704 may be chosen preferably to achieve a high Q rather than to achieve a low Γ, as these two goals may be achievable at two separate resonant frequency regimes.

In some embodiments, a high-Q resonator 102 may be defined as one with Q>100. Two coupled resonators may be referred to as a system of high-Q resonators when each resonator has a Q greater than 100, Qₛ>100 and Q_{d}>100. In other embodiments, two coupled resonators may be referred to as a system of high-Q resonators when the geometric mean of the resonator Q's is greater than 100, \sqrt{QₛQ_{d}}>100.

In certain embodiments, a high-Q resonator 102 can have Q>200 (e.g., Q>300, Q>500, Q>1000). Two coupled resonators can be high-Q resonators when each resonator has a Q is Qₛ>200 and Q_{d}>200 (e.g., Qₛ>300 and Q_{d}>300, Qₛ>500 and Q_{d}>500, Qₛ>1000 and Q_{d}>1000). In other embodiments, two coupled resonators can be high-Q resonators where the geometric mean of the resonator Q's is \sqrt{QₛQ_{d}}>200 (e.g., \sqrt{QₛQ_{d}}>300\sqrt{QₛQ_{d}}>400\sqrt{QₛQ_{d}}>500\sqrt{QₛQ_{d}}>1000.) Power transfer can occur efficiently over a wide range of distances, but the technique is distinguished by the ability to exchange useful energy for powering or recharging devices over mid-range distances and between resonators with different physical dimensions, components and orientations. Note that while k may be small in these circumstances, strong coupling and efficient energy transfer may be realized by using high-Q resonators to achieve a high U, U=k\sqrt{QₛQ_{d}} (where Qₛ and is the quality factor of one resonator and Qₛ is the quality factor of another resonator) in Q may be used to at least partially overcome decreases in k, to maintain useful energy transfer efficiencies.

While the near-field of a single resonator may be described as omni-directional, the efficiency of the power exchange between two resonators may depend on the relative position and orientation of the resonators. The efficiency of the power exchange may be maximized for particular relative orientations of the resonators. The sensitivity of the transfer efficiency to the relative position and orientation of two uncompensated resonators may be captured in the calculation of either k or κ. While coupling may be achieved between resonators that are offset and/or rotated relative to each other, the efficiency of the exchange may depend on the details of the positioning and on any feedback, tuning, and compensation techniques implemented during operation.

In some embodiments, even though certain frequency and Q matching conditions may optimize the system efficiency for power transfer, these conditions may not need to be exactly met in order to have efficient enough power transfer for a useful power exchange. Efficient power exchange may be realized so long as the relative offset of the resonant frequencies (|ωₛ−ω_{d}|/\sqrt{ωₛω_{d}}) is less than approximately the maximum among 1/Qₛ₍ₚ₎, 1/Q_{d(p)} and k_{sd(p)}. The Q matching condition may be less critical than the frequency matching condition for efficient power exchange. The degree by which the strong-loading factors, U_{m[l]}, of the resonators due to generators and/or loads may be away from their optimal values and still have efficient enough power exchange depends on the particular system, whether all or some of the generators and/or loads are Q-mismatched and so on.

Resonant frequencies of the resonators 702 and 704 may not be exactly matched, but may be matched within Γₛ or Γ_{d} of the resonators 702 and 704. The strong-loading factors of at least some of the resonators due to a power source (e.g., generators) and/or loads may not be exactly matched to their optimal value. The voltage levels, current levels, impedance values, material parameters may not be at the exact values described in the disclosure but will be within some acceptable tolerance of those values. The system optimization may include cost, size, weight, complexity, considerations, in addition to efficiency, Q, frequency, strong coupling factor, and the like, considerations. Some system performance parameters, specifications, and designs may be far from optimal in order to optimize other system performance parameters, specifications and designs.

In some embodiments, at least some of the parameters of power transfer system 700 may be varying in time, for example because components, such as a source resonator 702 or receiver resonator 704, may be mobile or aging or because the loads may be variable or because the perturbations or the environmental conditions are changing etc. In these cases, in order to achieve acceptable matching conditions, at least some of the system parameters (e.g., separation distances, resonant frequencies) may need to be dynamically adjustable or tunable.

Near-Field Coupling

Referring back to FIG. 7, power transfer between the source resonator 702 and the receiver resonator 704 can occur through near-fields. Either of the two resonators can be a sub-wavelength object. That is, the maximum physical dimension of either of the two resonators 702 and 704 may be less than 70% (e.g., less than 50%, less than 25%, less 10%, less than 2%) of the wavelength corresponding to the resonant frequency. In some embodiments, the two resonators 702 and 704 can be sub-wavelength magnetic resonators, and power can be transferred through magnetic near-fields surrounding the two resonators 702 and 704. These near-fields may also be described as stationary or non-propagating because they do not radiate away from the resonator. In other words, the power transfer between two resonators can occur through non-radiative fields.

The extent of the near-field in the area surrounding a resonator 102 is typically less than 100% (e.g., less than 75%, less than 50%, less than 25%) of the resonant wavelength, so the near-field may extend well beyond the resonator itself for a sub-wavelength resonator. The limiting surface, where the field behavior changes from near-field behavior to far-field behavior may be called the “radiation caustic”.

The strength of the near-field is reduced as a function of distance from the resonator 102. While the field strength of the near-fields decays away from the resonator 102, the fields may still interact with objects brought into the general vicinity of the resonator. The degree to which the fields interact depends on a variety of factors, some of which may be controlled and designed, and some of which may not. The wireless power transfer schemes described herein may be realized when the distance between coupled resonators is such that one resonator lies within the radiation caustic of the other.

Power Transfer using Repeater Resonators

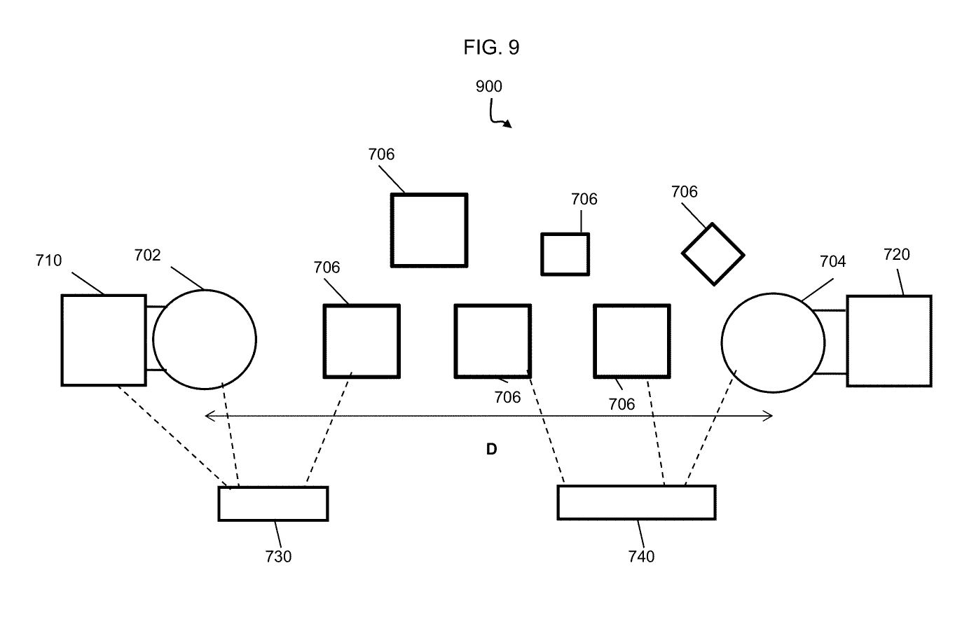

FIG. 9 is a schematic diagram showing an example arrangement of a wireless power transfer system 900. A power source 710 provides power to a source resonator 702, which wirelessly transfers power to one or more repeater resonators 706. A receiving resonator 704 receives power from one or more repeater resonators 706. The source resonator 702 can provide power by an oscillating field (e.g., electric, magnetic field), which induces electrical currents in the one or more repeater resonators 706. These induced electrical currents create their own oscillating field (e.g., electric, magnetic field), which further induces electric currents on other adjacent repeater resonators 706 and/or the receiver resonator 704. As a result, the repeater resonators 706 can extend the range of wireless power transfer from the source resonator 702 to the receiver resonator 704. In some embodiments, power is transferred through multiple repeater resonators 706 before being received by the receiving resonator 704.

One or more repeater resonators 706 can be used to change, distribute, concentrate, enhance, the oscillating field (e.g., electric, magnetic field) generated by a source resonator 702. The repeater resonators 706 can be used to guide the oscillating fields around lossy and/or metallic objects that might otherwise block the oscillating fields. For example, the repeater resonators 706 can be used to eliminate or reduce areas of low power transfer, or areas of low magnetic field around a source. The repeater resonators 706 can be used to improve the coupling efficiency between a source and a target receiver resonator or resonators, and can be used to improve the coupling between resonators with different orientations, or whose dipole moments are not favorably aligned. The power transfer between the resonators can occur through near-fields, in other words, non-radiative fields.

In some embodiments, wireless power transfer system 900 can include a monitor system 730 which measures a power transfer response of any components (e.g., power source, load device, source, receiver, repeater resonators.) The measurements can be carried out through wireless communication (e.g. using WiFi, Bluetooth, near field communication (NFC)) between the monitor system 730 and the components. Alternatively, communication between monitor system 730 and the components of power transfer system 900 can occur via wired connections. The system 900 can include a processor (not shown) which can analyze and compile measurement results obtained from the monitor system 730.

The wireless power transfer system 900 can also include an adjustment system 740 which can move the position of the resonators or adjust the resonant frequency of the resonators. In some embodiments, resonators may be moved by a person instead of using the adjustment system 740.

Multiple source resonators 702 can be included in the wireless transfer scheme 300. Similarly, multiple receiving resonators 704 can be included. When one or more receiver resonators 704 are moving, one or more repeater resonators 706 can be stationary to provide improved power transfer (e.g., higher transfer efficiency, greater range) to the one or more receiver resonators 704. Alternatively, one or more receiver resonators 704 can be stationary, while one or more repeater resonators 706 are moving to provide improved power transfer. A single repeater resonator 706 can provide power to one or more receiver resonators 704.

Source, Receiver, Repeater Resonators

For purposes of this disclosure, a resonator 102 may be considered as a source resonator 702 when it transmits power to another resonator or directly to a device. A resonator may be considered as a receiver (also referred to as a “receiving”) resonator 704, when it receives power that has been wirelessly transmitted from another device such as a source resonator or repeater resonator; typically, the received power is drained by a load device 720. In some embodiments, the load device 720 may drain power through a physical connection between the receiving resonator 704 and the load device 720. In some embodiments, the load device 720 can drain power from the receiver resonator 704 in a non-contact manner without a physical connection. A resonator may be considered as a repeater resonator 706 when it receives power transmitted wirelessly from a device (e.g., another resonator) and transfers the power to another device (e.g., another resonator). A resonator can function as a combination of a source resonator 702 and/or a repeater resonator 706 and/or and a receiver resonator 704.

In some embodiments, a source resonator 702 can transmit power to a receiver resonator 704 via a repeater resonator 706.

In some embodiments, a resonator may alternate between operating as a source resonator 702, a receiver resonator 704, or repeater resonator 706. For example, a receiver resonator 704 that is connected to load or electronic device may operate simultaneously, or alternately as a repeater resonator 706 for another device, repeater resonator, or receiver resonator. The alternation can be achieved by time multiplexing, frequency multiplexing, self-tuning, or through a centralized control algorithm. Multiple repeater resonators 706 can be positioned in an area and tuned in and out of resonance to achieve a spatially varying field (e.g., electric, magnetic field.) In some embodiments, a local area of a strong field may be created by an array of resonators (e.g., source, receiver, repeater resonators), and the position of the strong field area may be moved around by changing electrical components or operating characteristics of resonators in the array.

Structure of Repeater Resonator

A repeater resonator 706 can be any type of resonator (e.g., LC circuit) as described for resonator 102 earlier.

In some embodiments, a repeater resonator 706 may have dimensions, size, or configuration that is the same as a source resonator 702 or receiver resonator 704. The repeater resonator 706 may have dimensions, size, or configuration that is different than the source resonator 702 or receiver resonator 704. For example, the repeater resonator 706 may have a characteristic size that is larger than the receiver resonator 704 or larger than the source resonator 702, or larger than both. A larger repeater resonator may improve the coupling between the source and the repeater resonator at a larger separation distance between the source resonator 702 and the receiver resonator 704.

A repeater resonator 706 can include only inductive and capacitive components without any additional circuitry. Alternatively, the repeater resonator 706 can include additional control circuitry, tuning circuitry, measurement circuitry, or monitoring circuitry. For example, additional circuitry can be used to monitor the voltages, currents, phase, inductance, capacitance of the repeater resonator 706. Measured parameters of the repeater resonator 706 can be used to adjust or tune the repeater resonator 706. A controller or a microcontroller may be used by the repeater resonator 706 to actively adjust the capacitance, resonant frequency, inductance, resistance of the repeater resonator 706. The repeater resonator 706 may be adjusted prevent exceeding its voltage, current, temperature, or power limits. For example, the repeater resonator 706 may detune its resonant frequency to reduce the amount of power transferred to the repeater resonator 706, or to modulate or control how much power is transferred to other resonators that couple to the repeater resonator 706.

In some embodiments, control and/or monitoring circuitry of a repeater resonator 706 may be powered by the power received by the repeater resonator 706 from another resonator (e.g., source, receiver, repeater resonator.) In this case, although the control and/or monitoring may behave as a load, the repeater resonator 706 may be considered as a repeater resonator than a receiver resonator. The repeater resonator 706 can include AC to DC, AC to AC, or DC to DC converters and regulators to provide power to the control and/or monitoring circuitry. The repeater resonator 706 may include an additional energy storage component such as a battery or a super capacitor to supply power to the control and monitoring during momentary or extended periods of wireless power transfer interruptions. The battery, super capacitor, or other power storage component may be periodically or continuously recharged during normal operation when the repeater resonator 706 is within range of any source resonator 702.

The repeater resonator 706 can include communication or signaling capabilities such as WiFi, Bluetooth, NFC that may be used to coordinate power transfer from one or more source resonators to a specific location or one or more repeater resonators 704. For example, multiple repeater resonators 706 can be spread across and be signaled to selectively tune or detune from a specific resonant frequency to extend the field (e.g., electric, magnetic field) from a source to a specific location, area, or resonator. For example, the selective tuning or detuning within a given resonator can be accomplished using variable capacitance, variable inductance, and/or variable geometry.

In some embodiments, a repeater resonator 706 can include a device into which some, most, or all of the power transferred or captured from a source resonator 704 may be available for use. The repeater resonator 706 can provide power to one or more electric or electronic devices (e.g., low power consumption devices, lights, LEDs, displays, sensors) included in the repeater resonator, while relaying or extending the range of the source.

Q-factor

A repeater resonator 706 can have an intrinsic Q-factor of 50 or larger (e.g., 80 or larger, 100 or larger, 200 or larger, 300 or larger, 500 or larger, 1000 or larger.) In some embodiments, a repeater resonator 706 can have an intrinsic quality factor Qᵣ satisfying \sqrt{QᵣQᵢ}>50 (e.g., \sqrt{QᵣQᵢ}>80, \sqrt{QᵣQᵢ}>100, \sqrt{QᵣQᵢ}>200, \sqrt{QᵣQᵢ}>300, \sqrt{QᵣQᵢ}>500, \sqrt{QᵣQᵢ}>1000), where Qᵢ is an intrinsic quality factor of an adjacent resonator (e.g., source, receiving, or repeater resonator) which couples with the repeater resonator 706.

Example Arrangements

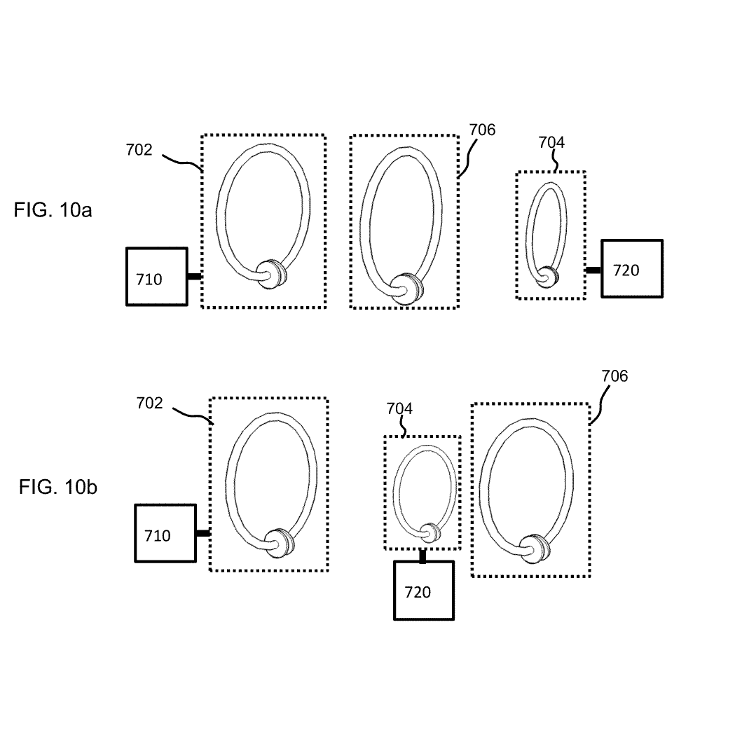

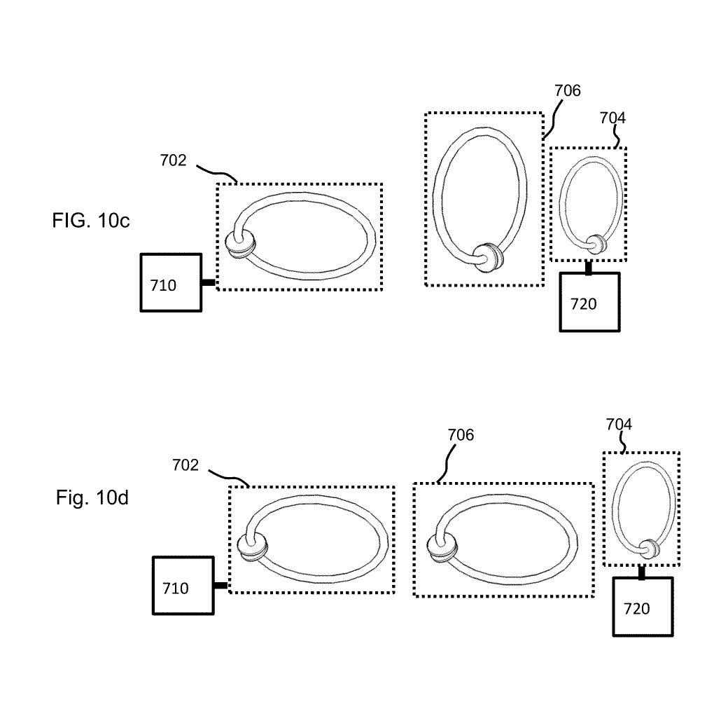

FIG. 10a is a schematic diagram showing an example arrangement where a repeater resonator 706 is positioned between a source resonator 702 and a receiver resonator 704 to extend the range of power transfer from the source resonator 702. FIG. 10b is a schematic diagram showing an example arrangement where a repeater resonator 706 can be positioned after, and further away from a source 702 than a receiver resonator 704. In this case, it still may be possible to have more efficient power transfer between the source resonator 702 and the receiver resonator 704 compared to if the repeater resonator 706 was not used. The repeater resonator 706 can be larger than the receiver resonator 704.

A repeater resonator 706 can be used to improve coupling between non-coaxial resonators or resonators whose dipole moments are not aligned for high coupling factors or energy transfer efficiencies. FIGS. 10c and 10d are schematic diagrams showing examples, where a repeater resonator 706 is used to enhance coupling between a source resonator 702 and a receiver resonator 704 that are not coaxially aligned. This is achieved by placing the repeater resonator 706 between the source resonator 702 and receiver resonator 704, and aligning the repeater resonator 706 with the receiver resonator 704 as shown in FIG. 10c, or aligning the repeater resonator 706 with the source resonator 702 as shown in FIG. 10d.

Frequency of Repeater Resonators

The resonant frequency of one or more source resonators 702, one or more receiver resonators 704, and one or more repeater resonators 706 can be chosen based on the arrangement or application of the wireless power transfer system. For example, all of the resonators can have substantially similar (e.g., within 10%, 5%, 3%, 1% of each other) resonant frequencies. Alternatively, only a subgroup of resonators (e.g., multiple repeater resonators, a source resonator and one or more repeater resonators, source resonator and receiver resonator) may have substantially similar resonant frequencies.

In some embodiments, a repeater resonator 706 can be tuned to have a resonant frequency that is substantially equal to that of the resonant frequency of a source or device or at least one other repeater resonator 706 with which the repeater resonator 706 is designed to interact or couple. In this disclosure, substantially equal resonant frequencies refer to that the difference between the resonant frequencies can be within a largest bandwidth among the resonators. For example, the difference can be within 100% (e.g., within 75%, within 50%, within 25%, within 10%) of the largest bandwidth. Alternatively, the repeater resonator 706 can be detuned to have a resonant frequency that is substantially different (e.g., greater than, or less than) the resonant frequency of a source or device or at least one other repeater resonator 706 with which the repeater resonator is designed to interact or couple. In this disclosure, substantially different resonant frequencies refer to that the different between the resonant frequencies are larger than a largest bandwidth among the resonators. For example, the difference can larger than 100% (e.g., larger than 150%, larger than 200%). In some embodiments, a repeater resonator 706 can be a source resonator and/or a receiver resonator simultaneously, or it may be switched between operating modes of a source, receiver, or repeater resonator.

Wireless Power Transfer in Battery-Operated Systems

The methods and systems disclosed herein can be used to wirelessly transfer power to a battery, a system of batteries, and/or a charging unit (hereinafter referred to collectively as a “power receiving apparatus”), either alone or while installed in a battery-operated device. For example, any of the source resonators 702, repeater resonators 706, or receiver resonators 704 described above in relation to FIGS. 1-10d can be connected to or integrated in one or more batteries. This can allow the one or more batteries to be charged remotely without being physically connected to a power outlet through an electrical wire. For example, a repeater resonator 706 can be connected to or integrated in a battery, which is used to power an electronic device. The repeater resonator 706 charges the battery by wirelessly receiving power from a source resonator. In some embodiments, the battery can provide power to the electronic device while the electronic device is being used.

In some embodiments, the device can be moved during use and while the power receiving apparatus is providing power to the device. As such, the device may be conveniently used and charged at the same time without requiring that the device be physically connected to a power source. Moreover, power can be delivered to the device (e.g., to the batteries of the device) when the device is in a variety of orientations with respect to the source resonator; that is, the device does not have to be precisely positioned with respect to the source resonator, or installed on a charging unit, to deliver power to its power receiving apparatus.

The operating frequencies of power transfer can be in the range, for example, of 10 kHz to 100 MHz. For example, the operating frequency can be 13.56 MHz or 6.78 MHz. In some embodiments, power can be transmitted at multiple operating frequencies. For example, the multiple operating frequencies can be 6.78 MHz and 13.56 MHz. In this example, one frequency is a harmonic frequency (e.g, a second harmonic) of the other frequency.

Any one of the source, repeater and receiver resonators can be a high Q resonator described in relation to FIGS. 1-11d. For example, Q>100, Q>200, Q>300, Q>500 or Q>1000.

In this disclosure, “wireless energy transfer” from one resonator to another resonator refers to transferring energy to do useful work (e.g., mechanical work) such as powering electronic devices, vehicles, lighting a light bulb or charging batteries. Similarly, “wireless power transfer” from one resonator to another resonator refers to transferring power to do useful work (e.g., mechanical work) such as powering electronic devices, vehicles, lighting a light bulb or charging batteries. Both wireless energy transfer and wireless power transfer refer to the transfer (or equivalently, the transmission) of energy to provide operating power that would otherwise be provided through a connection to a power source, such as a connection to a main voltage source. Accordingly, with the above understanding, the expressions “wireless energy transfer” and “wireless power transfer” are used interchangeably in this disclosure. It is also understood that, “wireless power transfer” and “wireless energy transfer” can be accompanied by the transfer of information; that is, information can be transferred via an electromagnetic signal along with the energy or power to do useful work.

Power Receiving Apparatus

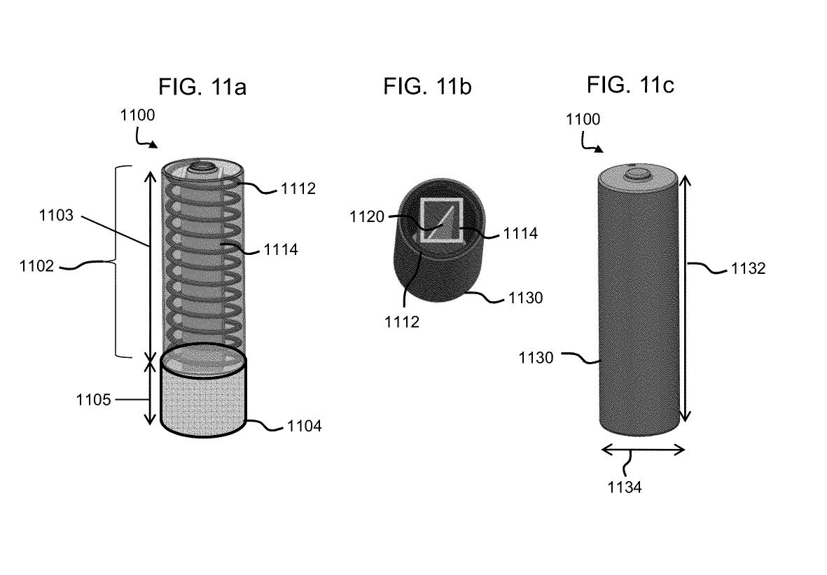

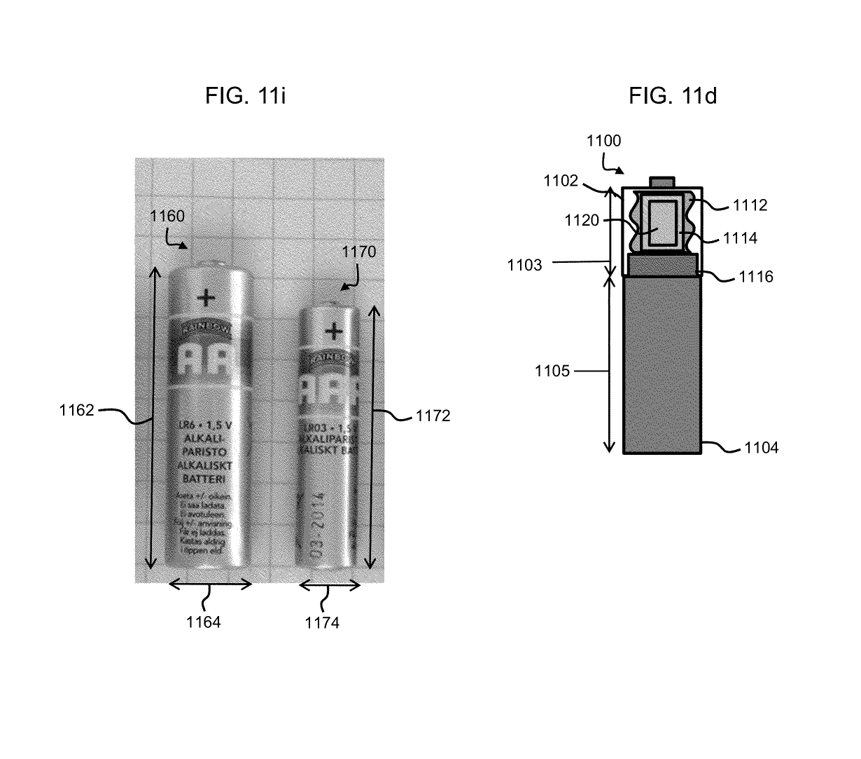

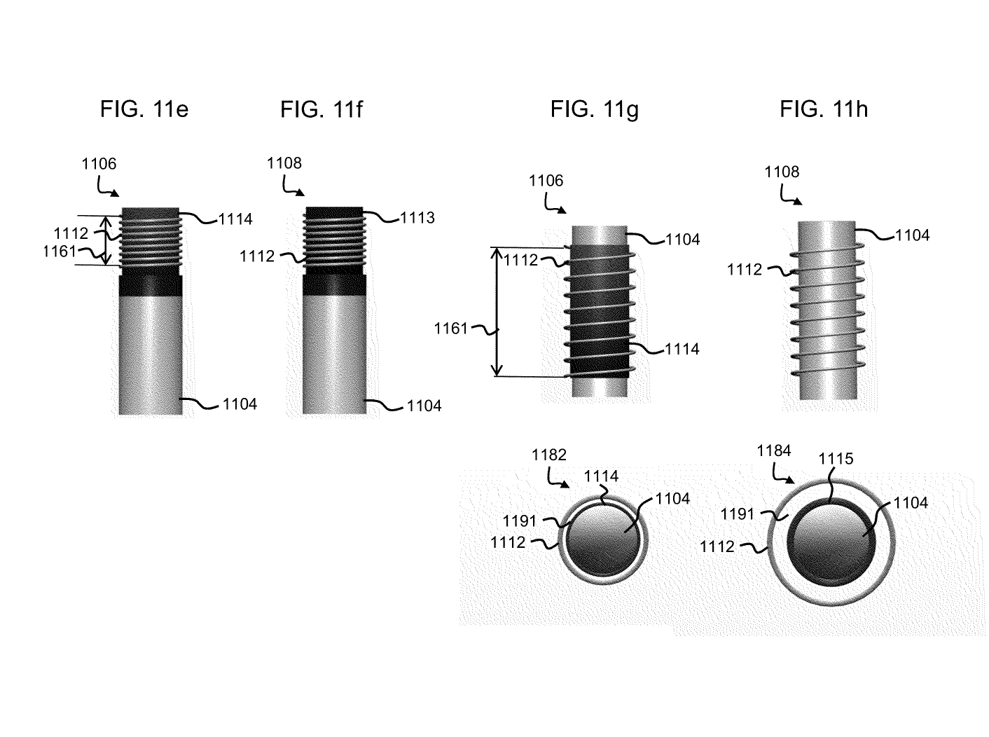

FIGS. 11a-c are schematic diagrams showing an example of a power receiving apparatus implemented in the form factor of a battery 1100. The following discussion refers to battery 1100 for purposes of clarity in discussing various aspects and features of wireless power transfer systems. It should be appreciated, however, that a power receiving apparatus can be implemented in a variety of forms (including forms other than batteries), and the features disclosed herein are applicable to a power receiving apparatus in any form, not only when implemented as a battery.

Battery 1100 includes a power receiving sub-structure 1102 connected to a battery cell 1104. The power receiving sub-structure 1102 includes a coil 1112 formed by a plurality of loops of conductive material and a magnetic material 1114 disposed in a core region within coil 1112. In this example, the magnetic material 1114 is a hollow rectangular shaped tubular member enclosing control electronics 1120, as shown in FIG. 11b. In some embodiments, coil 1112 and magnetic material 1114 forms a receiver resonator which can wirelessly receive power from a source resonator. The received power induces oscillating currents along the loops of the coil 1112, for example, at an operating frequency of the source resonator. Control electronics 1120 convert the induced current to a DC voltage which is applied to the battery cell 1104, which stores the received power. The DC voltage may be substantially constant, with variations within 1% (e.g., within 3%, within 5%, within 10%) relative to its average of the constant voltage.

In certain embodiments, a resonant frequency of the receiver resonator is determined by the inductance and capacitance of the coil 1112. Alternatively, the receiver resonator can include a capacitor which can be arranged in control electronics 1120. In this case, the resonant frequency of the receiver resonator can be controlled by a capacitance value of the capacitor.

FIG. 11c is a schematic diagram showing the battery 1100 including its battery housing 1130 (also referred as “battery shell”) which encloses the power receiving sub-structure 1102 and the battery cell 1104 (not shown). For example, the battery housing 1130 can be made from materials including plastic, rubber, kapton, ABS. In some embodiments, at least some portion of the battery housing 1130 can includes material that has low loss and do not significantly attenuate the oscillating fields (e.g., electric, magnetic field) in the battery 1100. For example, the attenuation may be less than 10% (e.g., less than 5%) of total energy of oscillating magnetic fields. In some embodiments, a battery 1100 may not include a battery housing 1130.

In some embodiments, housing 1130 is dimensioned to engage with a battery compartment of a battery-operated device. By engaging with a battery compartment, battery 1100 can be used to deliver power to the battery-operated device without modifying the device. That is, instead of installing conventional batteries to power the device, battery 1100 can be installed simply and quickly.

FIG. 11i is a photo of a standard AA battery 1160 and a standard AAA battery 1170. Standard AA battery has a length 1162 about 50.1-50.5 mm without its button terminal and a diameter 1164 about 13.5-14.5 mm. Standard AAA battery 1170 has a length 1172 about 44.5 mm and a diameter 1174 about 10.5 mm. In the example shown in FIGS. 11a-c, housing 1130 of battery 1100 has exterior dimensions that are substantially similar in size to the exterior dimensions of a standard AA battery. Thus, referring to FIG. 11a, battery cell 1104 has a length 1105 smaller than the length 1162 of the standard AA battery 1160 to have space for incorporating the power receiving sub-structure 1102. In this example, the battery cell 1104 has a length 1105 corresponding to about ¼ of the length 1162 of the standard AA battery cell shown in FIG. 11i. The battery housing 1130 has a length 1132 substantially similar to the length 1162 and a diameter 1134 equal to the diameter 1164 of the standard AA battery 1160. Accordingly, the battery 1100 can easily replace a standard AA battery for use in conventional applications.

In some embodiments, a length 1104 of a battery cell 1104 can be a fraction (e.g., ¾ or less, ⅔ or less, ½ or less, ⅓ or less, ¼ or less) than the length 1162 of the standard AA battery cell 1160. For a given diameter, the larger the length 1105 of battery cell 1104, the larger the capacity of battery cell 1104 to store energy. In some embodiments, the larger the length 1105, the greater the extent to which the length of coil 1112 is reduced due to space constraints. The reduced length of coil 1112 may reduce a coupling coefficient of energy transfer between the battery cell 1104 and a source resonator. As such, a user may select the length 1105 of the battery cell 1104 for a particular application depending on several factors such as down-time and use-time of the battery cell. As used herein, down-time is the period of time when a battery cell 1104 receives power from a source, and use-time is the period of time when the battery cell 1104 is unable to receive power from the source because battery 1100 is delivering power to the device.

FIG. 11d is a schematic diagram showing another example of a wirelessly chargeable battery 1100, which includes a coil 1112, magnetic material 1114 and control electronics 1120. Power receiving element 1102 is securely fixed to a battery cell 1104 by a locking element 1116 (e.g., locking ring, adhesive, ferrite material, etc.) In this example, the battery 1100 has a substantially similar size as the standard AA battery 1160. The battery cell 1104 has a length 1105 corresponding to about ⅔ of the length 1162 of the standard AA battery 1160 and the power receiving sub-structure 1102 has a length 1103 of about ⅓ of the length 1162 of the standard AA battery 1160.

While the foregoing examples have the form factor of a conventional AAA battery, the batteries disclosed herein can have form factors that correspond to any of a variety of different conventional batteries. For example, the batteries can have a form factor that is substantially similar to the form factor of a conventional AAA, AA, C, D, 9 V, LiPo cell, or C123 battery, e.g., within 3% (e.g., within 5%, within 10%) of the volume of such a conventional battery. Battery cell 1104 can have a length 1105 that is a fraction of a length of a conventional battery.

In some embodiments, a battery cell 1104 can be a rechargeable battery cell such as lead-acid, valve regulated lead-acid, gel, absorbed glass mat, nickel-cadmium (NiCd), nickel-zinc (NiZn), nickel metal hydride (NiMH), lithium-ion (Li-ion), lithium poly or molten sand based rechargeable battery cell. In certain embodiments, battery cell 1104 can include solid state materials such as Ag4RbI5, LiI/Al2O3 mixtures, clay and β-alumina group of compounds (NaAl₁₁O₁₇), or glassy and polymeric materials that can be readily made in thin film form. In certain embodiments, battery cell 1104 can include fuel cells, capacitors, super capacitors, piezoelectric elements, or springs.

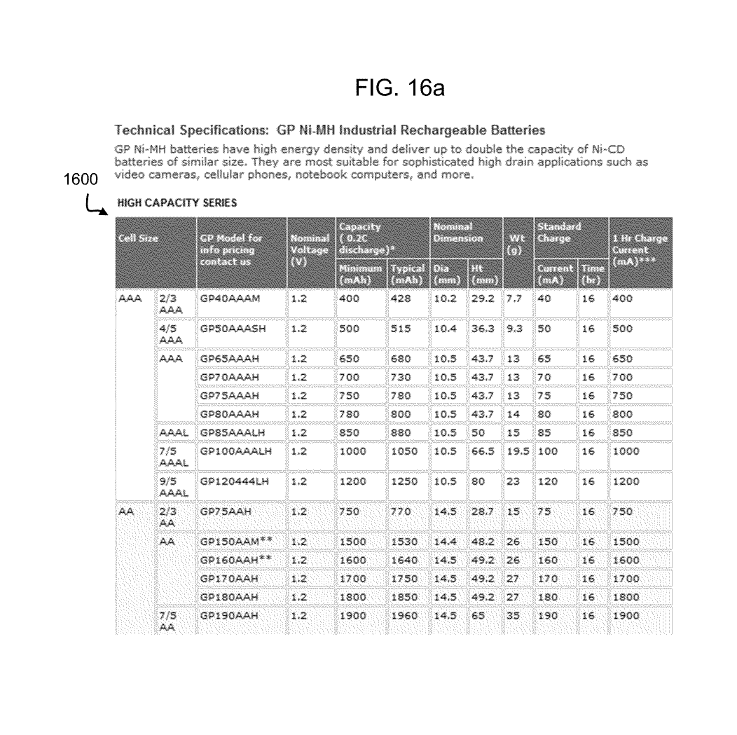

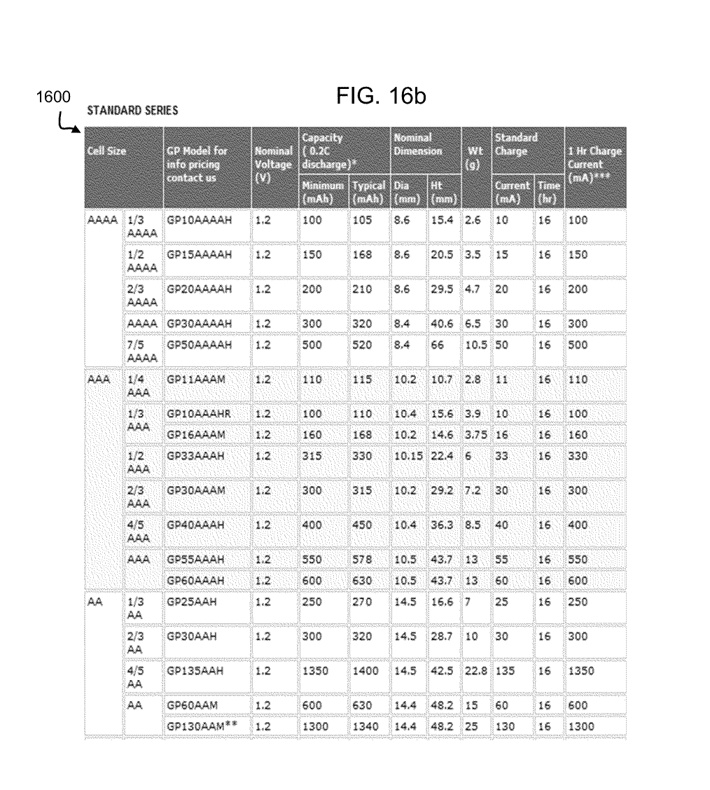

In some embodiments, battery cell 1104 can be made from a commercially available battery cell. For example, the battery cell 1104 can be made from one or more battery cells with a ⅘ AA battery type with 1100 mA-hr capacity. The battery cell 1104 can be made from one or more battery cells with a ⅔ AA battery type with 700 mA-hr capacity. The battery cell 1104 can be made from one or more battery cells with a AAA battery type with 700 mA-hr capacity. The battery cell 1104 can be made from one or more battery cells with a ⅔ AAA battery type with 400 mA-hr capacity. The battery cell 1104 can be made from one or more battery cells with a AAAA battery type with 300 mA-hr capacity. The battery cell 1104 can be made from one or more battery cells with a ½ AAA battery type with 250 mA-hr capacity. The battery cell 1104 can be made from one or more battery cells with a ⅓ AAA battery type with 180 mA-hr capacity. The battery cell 1104 can be made from one or more battery cells with a ¼ AAA battery type with 85 mA-hr capacity. The battery cell 1104 can be made from one or more battery cells with a ⅓ AA battery type or a ½ AAAA battery type. FIGS. 16a-b are tables 1600 listing exemplary sizes and specifications of commercially available Ni-MH battery cells, which can be used for the battery cell 1104. Alternatively, a battery cell 1104 can be a custom made battery cell.

In some embodiments, a battery 1100 can include multiple battery cells 1104 which may have one or more types of battery cells. This may be advantageous when one of the battery cells 1104 has a defect because the battery 1100 can still store power through the other battery cells 1104 which function properly.

In certain embodiments, a power receiving apparatus may not include a battery cell 1104 but directly provide power to an electronic device.

FIG. 11e is a schematic diagram showing an example of a wirelessly chargeable battery 1106 having a receiver resonator including a coil 1112, and a magnetic material 1114 positioned in a core of the coil 1112. The magnetic material 1114 is placed adjacent to a battery cell 1104, which has a substantially similar diameter to that of a standard AA battery. For example, the diameter of battery cell 1104 can differ from that of the standard AA battery by less than 2% (e.g., less than 5%, less than 10%, less than 15%). In some embodiments, the battery cell 1104 has a substantially similar diameter and length to that of a standard AA battery. For example, the diameter and length of the battery cell 1104 can differ from that of the standard AA battery by less than 2% (e.g., less than 5%, less than 10%). The magnetic material 1114 is shaped as a hollow cylindrical shell covering a cylindrical container (not shown), which encloses control electronics 1120 (not shown).

FIG. 11f is a schematic diagram showing another example of a wirelessly chargeable battery 1108 having a receiver resonator including a coil 1112, which is connected to a battery cell 1104. The coil 1112 wraps around a cylindrical container 1113, which encloses control electronics 1120 (not shown). Hence, there is no magnetic material between the coil 1120 and the container 1113. The absence of magnetic material reduces the weight and manufacturing cost of the battery 1108. In this example, the battery cell 1104 has a substantially similar diameter to a standard AA battery.

FIG. 11g is a schematic diagram of an example of a wirelessly chargeable battery 1106 which has a coil 1112 wrapped around a magnetic material 1114 shaped as a hollow cylinder. The magnetic material 1114 encloses a battery cell 1104. In this example, the battery cell 1104 has a substantially similar size to a standard AAA battery. The coil 1112 has a length 1161 that extends a substantial portion of the battery cell 1104 unlike the example shown in FIG. 11e. For example, in FIG. 11g, the length 1161 extends at least 75% (e.g., at least 80%, at least 90%) of the length of the battery cell 1104. In FIG. 11e, a length 1161 of coil 1112 is less than 40% (e.g., less than 30%, less than 25%) of the length of battery cell 1104. The longer length 1116 may provide a larger coupling coefficient of power transfer from a source resonator than the example shown in FIG. 11e. View 1182 illustrates the arrangement of the battery 1104 as seen along a coaxial axis (pointing out of the drawing plane) of the battery 1104. In some embodiments, the thickness of the magnetic material 1114 can be in a range of 0.5-1 mm. For example, the thickness can be 0.52±0.05 mm. In some examples, the thickness can be 0.5 mm or more, 0.55 mm or more, 0.6 mm or more, 0.65 mm or more, 1 mm or less, 0.95 mm or less, 0.9 mm or less. The combined thickness of the magnetic material 1114 and a gap 1191 can be in a range of 1-3 mm. In some examples, the combined thickness can be 0.8 mm or more, 0.9 mm or more, 1 mm or less, 2 mm or less, 3 mm or less, 4 mm or less. In some examples, the combined thickness can be 2±0.1 mm A user can select the thicknesses to increase energy coupling to a source resonator and/or reduce losses due to the magnetic material 1114, if any.

A battery 1100 (such as battery 1106) can include a battery cell 1104 which has a metallic outer surface or contains metal. This may induce a loss of the energy received by the battery 1100. Thus, in some cases, it may be desirable to shield the metal of the battery cell 1104 from an adjacent coil 1112. In some embodiments, a magnetic material 1114 can be used as shield between the coil 1112 and the battery cell 1104. For example, in FIG. 11g, magnetic material 1114 is positioned between the coil 1112 and the battery cell 1104. When power provided by a source resonator induces oscillating currents in the coil 1112, the magnetic material 1114 can reduce the amount of penetration of the fields (e.g., electric field, magnetic field) generated by the currents into the battery cell 1104. The reduction or absence of penetration of the fields into the battery cell 1104 can increase the energy stored in the battery cell 1104 for given amount of received energy. In some embodiments, the magnetic material 1114 can be used to shield the coil 1113 from other lossy objects (e.g., control electronics 1120, other perturbing objects such as metal in a connected electronic device).

In some embodiments, a magnetic material 1114 can be arranged to improve the coupling coefficient of energy transfer between a source resonator and a coil 1112. In certain embodiments, a magnetic material 1114 may be positioned to reduce the coupling between a coil 1112 and an electronic device connected to a battery cell 1104. This arrangement would depend on the geometry of the electronic device. For example, the magnetic material 1114 can be positioned between a metallic portion of the electronic device and the coil 1112 to shield the effect of loss in the metallic portion. In certain embodiments, the thickness of the magnetic material 1114 can be in a range of 0.5-1 mm. For example, the thickness can be 0.52±0.05 mm. In some examples, the thickness can be 0.5 mm or more, 0.55 mm or more, 0.6 mm or more, 0.65 mm or more, 1 mm or less, 0.95 mm or less, 0.9 mm or less. The thickness at least 1 times (e.g., at least 1.5 times, at least 2 times) of a skin depth of fields (e.g., electric field, magnetic field) that may penetrate the battery cell 1104. In some embodiments, the magnetic material 1114 can be separated from the coil 1112 with a gap thickness of at least 0.1 mm (e.g., at least 0.5 mm, at least 1 mm, at least 1.5 mm) or less than 3 mm (e.g., less than 2 mm, less than 1 mm, less than 0.5 mm). The gap thickness can be selected based the skin depth of fields that may penetrate the battery cell 1104 to improve the shielding effect.

FIG. 11h illustrates an example of a wirelessly chargeable battery 1108 which has a coil 1112 wrapped around a battery cell 1104. In this example, there is no magnetic material between the coil 1112 and the battery cell 1104. Embodiments with no magnetic material between coil 1112 and battery cell 1104 may be used, for example, when the loss due to the battery cell 1104 is negligible (e.g., loss is less than 5% of power received from a source resonator). In some embodiments, the battery cell 1104 has an outer surface 1115 facing the coil 1112 made from a metal with high conductivity and low loss. The outer surface 1115 may act as a shield for the coil 1112. In such embodiments, the volume of the battery cell 1104 and/or the diameter of the coil 1112 can be made larger due to the absence of a magnetic material, which also reduces the weight of the battery 1106. The top view of battery 1108 illustrates the arrangement of the battery as seen along its coaxial axis (pointing out of the drawing plane). A gap 1191 (e.g., air gap) is positioned between the coil 1112 and the outer surface 1115. In some embodiments, a dielectric medium such as adhesive can be placed between the coil 1112 and the outer surface 1115.

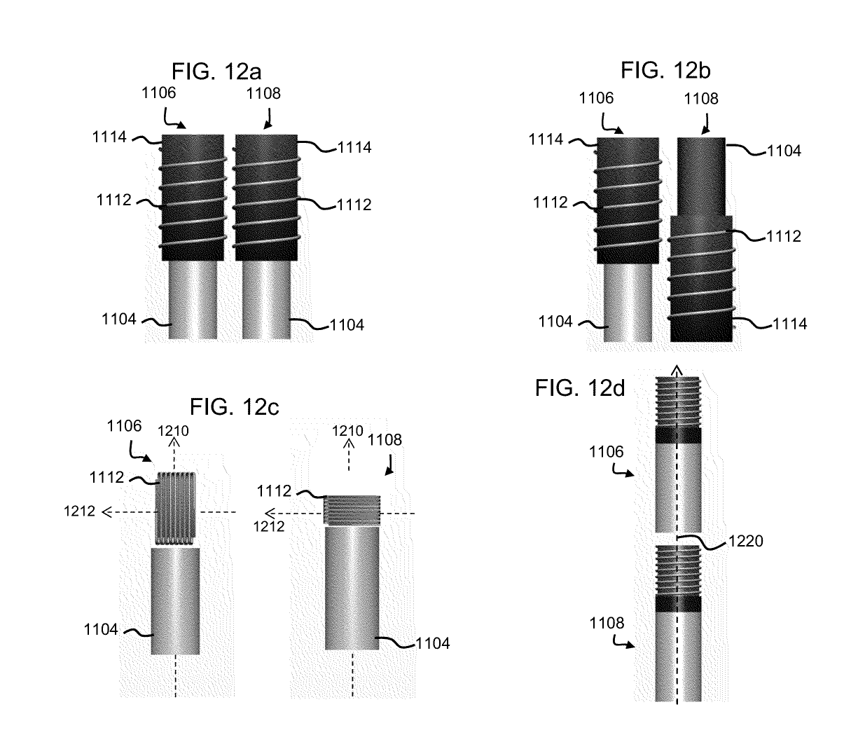

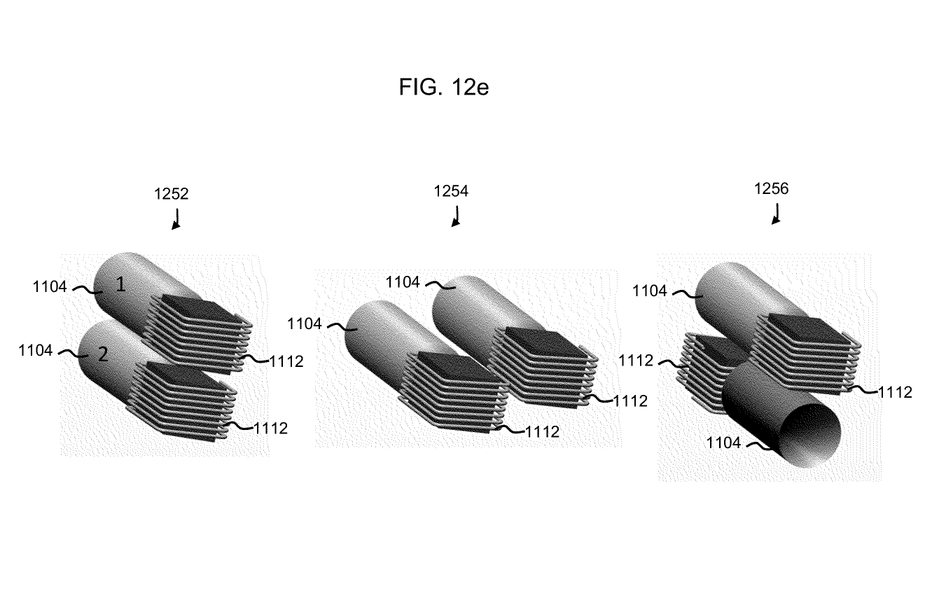

A variety of arrangements of multiple wirelessly chargeable batteries can be implemented. In particular, a user can select specific designs of the batteries and their arrangement depending on factors such as coupling between adjacent batteries and the field distribution generated by one or more source resonators. In some embodiments, a battery 1106 and a battery 1108 can be positioned in a side-by-side aligned arrangement, as shown in FIG. 12a. In other embodiments, a battery 1106 and a battery 1108 can be positioned in an anti-aligned arrangement, as shown in FIG. 12b. The anti-aligned arrangement may reduce the coupling between the coils 1112 of the batteries 1106 and 1108.

Resonators can generally be oriented along different directions with respect to an axis of a battery cell. FIG. 12c is a schematic diagram showing an example arrangement where a battery 1106 has its battery cell 1104 with its coaxial axis along a direction 1210 and a coil 1112 with its coaxial axis along a direction 1212. The directions 1210 and 1212 are orthogonal to each other. Conversely, battery 1108 has coaxial axes of battery cell 1104 and coil 1112 parallel to each other being oriented along direction 1210.

Positioning batteries 1106 and 1108 adjacent to one another and with resonators oriented in orthogonal directions can reduce coupling between coils 1112 of the batteries due to their orthogonal arrangement. Moreover, for a given magnetic field direction provided by a source resonator, either or both of the batteries 1106 and 1108 may be charged and provide power to an electronic device. For example, when the source resonator generates a magnetic field along direction 1210, the battery 1108 may be predominantly charged. When the magnetic field is generated along direction 1212, the battery 1106 may be predominantly charged. When the magnetic field points in a direction between directions 1210 and 1212, both batteries 1106 and 1108 may be charged. In this approach, the electronic device may receive power from the source resonator in a wide range of orientations of the electronic device with respective to the source resonator.

FIG. 12d is a schematic diagram showing another example arrangement of a battery 1106 and a battery 1108, where the axes of each battery are coincident along an axis 1220. Coupling between the coils of batteries 1106 and 1108 can be significantly reduced due to the presence of battery cell 1104 of battery 1106. FIG. 12e is a schematic diagram showing other example arrangements of two batteries with coils 1112 oriented perpendicular to the axis of their respective battery cells 1104. In some cases, two coils 1112 can be aligned to each other as shown in view 1252. Alternatively, when coupling between adjacent coils 1112 is large, their battery cells 1104 can be anti-aligned as shown in view 1254. The asymmetry of the anti-alignment may reduce the coupling between the adjacent coils. In certain embodiments, two coils 1112 can be displaced as shown in view 1254. The amount of displacement can be depend on the exact field (e.g., electric, magnetic) distribution of a region where the two coils 1112 are positioned. The displacement can be determined to reduce the coupling between the two coils 1112. For example, when the field distribution in the region has a strong gradient, the displaced arrangement in view 1254 may have reduced coupling between the two coils 1112.

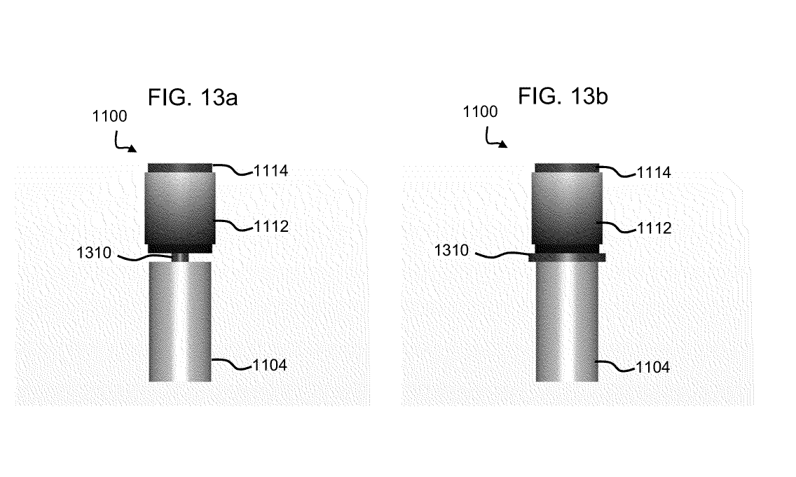

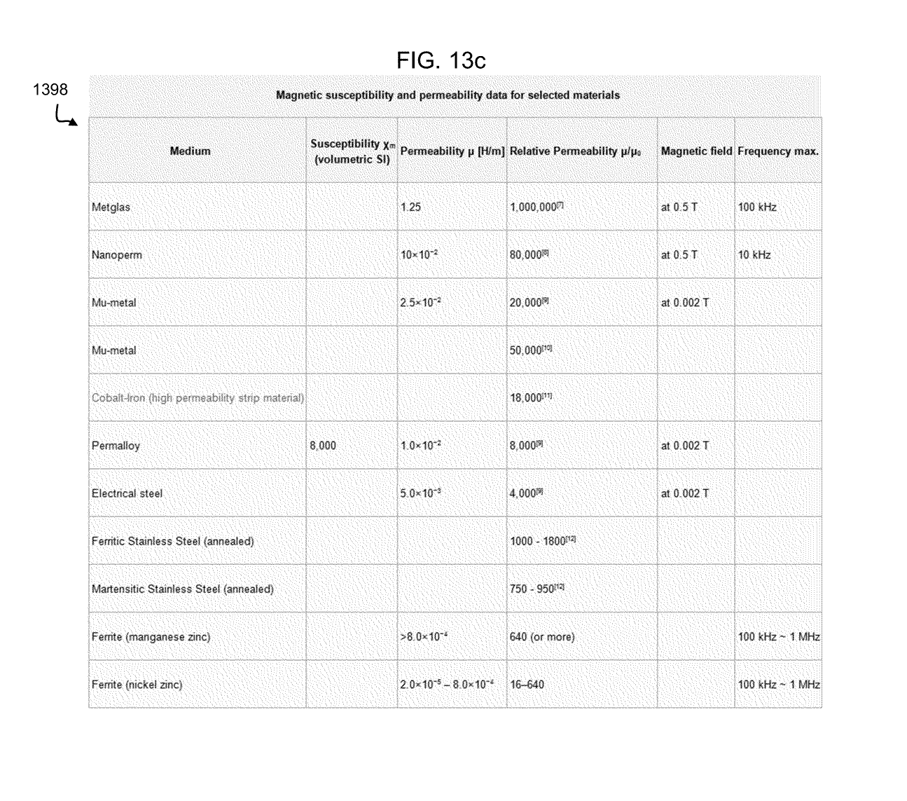

FIG. 13a is a schematic diagram showing an example of a battery 1100. In this example, the battery 1100 includes an intermediate element 1310 between a magnetic material 1114 and a battery cell 1104. The intermediate element 1310 can act as a shield to reduce penetration of fields (e.g., electric field, magnetic field) induced by the currents into the battery cell 1104. The intermediate element 1310 can be made from the same material of the magnetic material 1114. In some embodiments, the intermediate element 1310 can be made from material with a higher shielding effect than the magnetic material 1114. The intermediate element 1310 can be made from one or more materials (e.g., metglass, nanoperm, mu-metal, cobalt-iron, permalloy, electric steel, ferrite stainless steel, martensitic stainless steel) listed in table 1398 shown in FIG. 13c. In some embodiments, the intermediate element 1310 can function as a rigid locking element which fixes the connection of the magnetic material 1114 and the battery cell 1104. For example, the intermediate element 1310 can be made from a shock absorbing material that reinforces the battery 1100 to withstand force applied along the coaxial direction of the battery 1100. FIG. 13b is a schematic diagram showing another example of a battery 1100 including a intermediate element 1310. The diameter of the intermediate elements 1310 can be selected based factors such as cost, weight, shielding and reinforcement of the battery 1100. For example, the diameter can be less than 90% (e.g., less than 75%, less than 50%, less than 25%) of a diameter of the battery cell 1104.

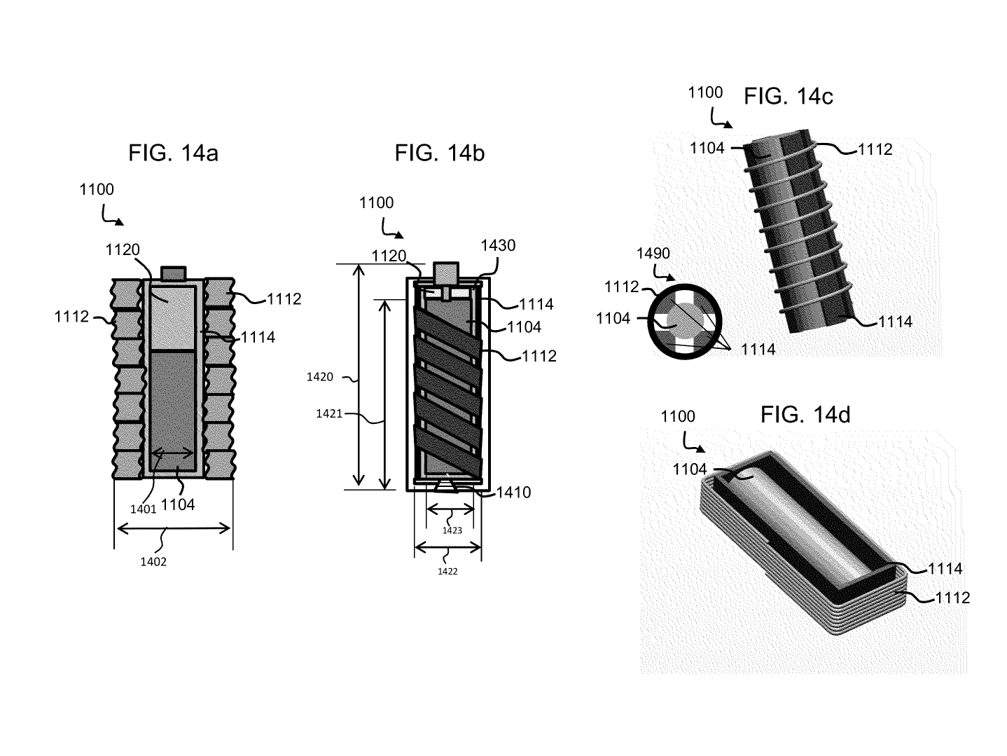

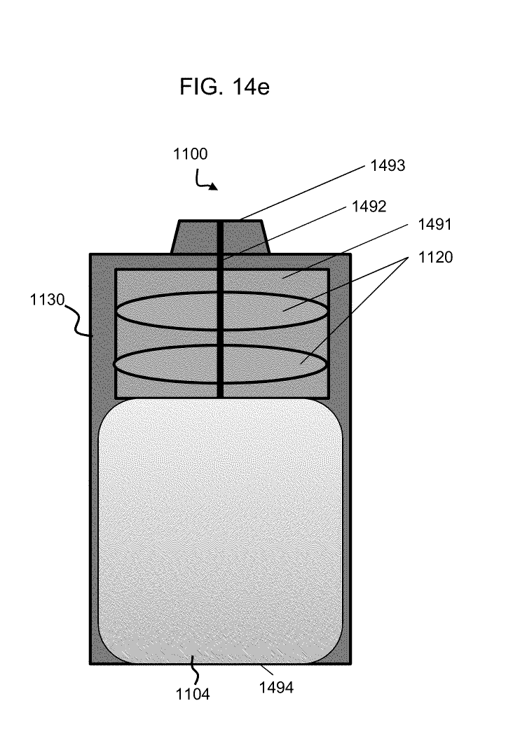

In some embodiments, a battery 1100 can have a diameter of a specific standard battery (e.g., AA battery) while including a battery cell with a size of another standard battery (e.g., AAA battery). As an example, FIG. 14a is a schematic diagram showing a battery 1100 including a battery cell 1104 with a diameter 1401 corresponding substantially to a diameter of a standard AAA battery or a standard AAA battery cell. A receiver resonator includes a coil 1112 wrapped around a magnetic material 1114. In this example, the magnetic material 1114 encloses the battery cell 1104. The combined thickness of the coil 1112 and the magnetic material 1114 is select such that the total diameter 1402 is substantially the same as a standard AA battery. For example, the total diameter 1402 can be within 2% (e.g., within 5%) of the diameter of the standard AA battery. In certain embodiments, the diameter 1402 of the battery 1100 and/or the diameter of 1401 of the battery cell 1104 may not be exactly the equivalent to that of a standard battery but within 2% (e.g., within 5%, within 10%). In this approach, a standard battery of a smaller size can be easily modified to be used as a standard battery of a larger size. For example, the coil, magnetic material and control electronics can be built alone as a stand-alone unit which is connected to a commercially available standard battery. The stand-alone unit can be implemented as a sleeve, with an interior opening dimensioned to receive a standard battery or a standard battery cell, which is inserted into the sleeve.

FIG. 14b is a schematic diagram showing an example of a battery 1100 having a specific standard battery size (e.g., AA battery size) while including a battery cell with a size of a smaller standard battery (e.g., AAA battery). The battery 1100 includes control electronics 1120 which is 20% or less (e.g., 10% or less, 5% or less) of the volume of a battery cell 1104. For example, in some embodiments, the control electronics has a height of about 5 mm and a diameter of about 12.6 mm By reducing size of the control electronics 1120, the energy storage capacity of the battery cell 1104 can be maximized for the given specific standard battery size.

In this example, the battery 1100 includes a buffer 1410 (e.g., spring, conical spring contact, cushion) for absorbing force applied to the battery 1100 along its coaxial direction by compression. The compression can help to absorb the force that is typically applied to the battery when it is introduced into a battery compartment of a device, making battery 1100 more damage-resistant. In FIG. 14b, the buffer 1410 is positioned at the negative end of the battery 1100. In some embodiments, the buffer 1410 can be positioned at the positive end of the battery 1100. The buffer 1410 can be positioned at both the positive and negative end of the battery 1100. Dimensions 1420-1423 can correspond to that, for example, of a standard AAA battery. For example, the values can be 1.985, 1.772, 0.470-0.487, 0.403 inches, respectively. Magnetic material 1114 is a flexible ferrite joined to a copper shield 1430 by an adhesive. The copper shield 1430 wraps around the battery cell 1104 and the control electronics 1120.

FIG. 14e is a schematic diagram of an example of a battery 1100 (where coil 1112 and magnetic material 1114 are not shown). In this example, bottom of a battery cell 1104 is in contact with a negative side 1494 of the battery 1100. The large contact area between the negative side 1494 and the battery 1100 can spread stress applied along the coaxial axis of the battery cell 1104 in a large area. In this example, the battery 1100 includes a support 1492 (e.g., wire) which extends from a positive side 1493 of the battery 1100 to the battery cell 1104. The support 1492 passes through adhesive 1491 (e.g., epoxy) which holds control electronics 1120. The adhesive 1491 can absorb force applied along the coaxial axis, thereby reduced stress applied to the control electronics 1120, which may include a PCB.

In some embodiments, battery 1100 may include a magnetic material 1114 with several magnetic elements spaced apart from each other, as shown in FIG. 14c. Inset 1490 is a top view of the battery 1100, which shows four magnetic elements of the magnetic material 1114. The magnetic elements can be placed at positions which can increase the coupling coefficient of energy transfer from a source resonator or at positions which effectively shield and reduce the loss effect of an enclosed battery cell 1104. Moreover, in this approach, the total weight of the battery 1100 may be reduced by eliminating unnecessary portions of the magnetic material 1114. The shape and position of each arrangement of each magnetic element can be determined based on the relative arrangement of the coil 1112 and battery cell 1104. For example, the magnetic elements can be positioned to guide and shape the fields (e.g., electric field, magnetic field) induced by the currents of the coil 1112 in a way to avoid penetrating the battery cell 1104. This may reduce losses induced by the battery cell 1104.

In some embodiments, a battery 1100 may include a coil 1113 and a magnetic material in a rectangular arrangement, as shown in FIG. 14d. A battery cell 1104 is arranged with the magnetic material 1114 in way such that the coaxial axis of the battery cell 1104 intersects the magnetic material 1104. This arrangement can be used us a wireless chargeable battery for a standard 9V battery which has a rectangular cuboid shape. For example, a standard AAA battery cell can be modified to be used as a standard 9V battery.

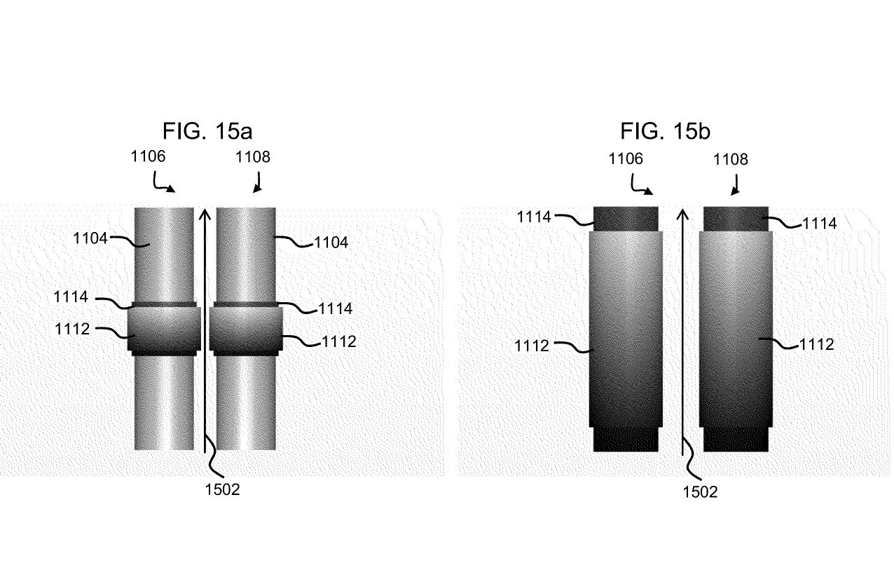

FIG. 15a is a schematic diagram showing two batteries 1106 and 1108, where each battery has a coil 1112 and magnetic material 1114 positioned at the center of battery cell 1104 along the axes of batteries 1106 and 1108. The two batteries 1106 and 1108 can be used together in a device. More generally, however, each of the coils 1112 and magnetic materials 1114 can be placed at a position other than at the center of battery cell 1104 along the axes of batteries 1106 and 1108. For example, in some embodiments, the coil 1113 and the magnetic material 1114 are movable in a direction parallel to axis 1502. The relative arrangements of the coils 1113 and magnetic material 1114 of the batteries 1106 and 1108 can therefore be selected manually. In some cases, adjusting the relative positions of the coils 1113 can reduce the coupling from each other. This may be desirable when the coupling between coils 1113 significantly affects, for example, detuning the resonant frequencies more than the bandwidth of each coil.

FIG. 15b is a schematic diagram showing another example arrangement with two batteries 1106 and 1108, where each battery has a magnetic material 1114 enclosing its battery cell 1104 (not shown) in its entirety. In some embodiments, the batteries 1106 and 1108 can have their coil 1112 to be wound around the entire portion of its magnetic material 1114. In some other embodiments, each battery can have its coil 1112 wound around a substantial portion (e.g., 80% or more, 90% or more) of its magnetic material 1114, but not necessarily 100%. Winding around less than 100% can be used, when a battery 1130 housing limits the available space for its coils.

It is understood that the techniques disclosed in relation to FIGS. 12a-e and 15a-b can be extended to more than two batteries 1100 (e.g., three or more batteries, four or more batteries, five or more batteries).

A power receiving apparatus can be configured to be engaged within a battery compartment of a battery-operated device. In some embodiments, the power receiving apparatus can include electrodes which connect to the device for providing power. In some other embodiments, the power receiving apparatus can inductively transfer power directly to the device.

Coil, Magnetic Material, Control Electronics of Power Receiving Apparatus

A receiver resonator can have a coil 1112, which is formed from materials with high conductivity at the operating frequency. For example, for receiving power at frequencies around 6 MHz, the coil 1112 can include copper ribbon and PCB traces. For receiving power at lower frequencies (e.g., 2 MHz or lower), the coil 1112 can include litz wire.

In some embodiments, a coil 1112 can be made from solid copper or be printed or etched on flexible printed-circuit-board (PCB). The solid copper or flexible PCB can be wrapped around a battery cell 1104. For example, the coil 1112 can be formed as multiple conducing windings which are soldered together. This approach may be advantageous for frequencies where the AC conducting loss of copper is low. For example, copper can be used at operating frequencies greater than 2 MHz. In certain embodiments, copper maybe used, for example, at operating frequencies about 6 MHz (e.g., 5.5-6.5 MHz, 5-7 MHz). In some embodiments, using copper may reduce the cost of manufacturing.

In some embodiments, a coil 1112 can be printed on a label such as flexible substrate (e.g., thin flexible paper or plastic). The coil 1112 can be printed using printed traces, conducing ink or conducting gel. The flexible substrates can be easy to manufacture, transport or store, thereby reducing the manufacturing costs. The flexible substrates can easily deform to a shape of a variety of form factors of a battery cell 1104. In some cases, a user can fine tune the exact geometry of the coil 1112 before printing depending on a specific design of the battery cell 1104.

A coil 1112 can be directly printed on a magnetic material 1114. The coil 1112 can be printed using printed traces, conducing ink or conducting gel. Overall the combined thickness of the coil 1112 and the magnetic material 1114 can be reduced because there may be no need to add an additional adhesive layer.

In certain embodiments, the coil 1112 can be formed as a solid piece of conductor that is wrapped around a magnetic material 1114 or a battery cell 1104. For example, the coil 1112 can be a single sheet of conducting film with only a one-turn winding. This can eliminate a need to solder different pieces of conductors together.

In certain embodiments, the coil 1112 can be printed or embedded on a battery housing 1130. This may eliminate any need of soldering different pieces of the coil 1112 together or using a separate adhesive layer to fix the coil 1113 to the battery housing or a magnetic material 1114. Because the battery housing 1130 can be made from a rigid material such as hard plastic or aluminum, the battery housing 1130 can reduce damage of the coil 1112 from external forces.

In some embodiments, a coil 1112 can be deformable (e.g., flexible) and conform to a shape of a battery compartment or an electronic device. For example, the coil 1112 can be a conducting gel, which may easily conform to external forces. This may be desirable for use in a battery 1100 used in conditions of high pressure (e.g., at least 2 atm, 3 atm) or high temperatures (e.g., at least 85 F, at least 100 F), where the structure of battery 1100 can be deformed.

A magnetic material 1114 can include a rigid or flexible ferrite material. For example, at wireless power transfer frequencies of about 6 MHz, the magnetic material 1114 can include ferrite material such as Nickel-Zinc ferrites, rigidly-formed NL-12S ferrites or flexible FJ3. At lower frequencies (e.g., 2 MHz or lower), the magnetic material 1114 can include Manganese-Zinc ferrites.

In some embodiments, a magnetic material 1114 can be made from one or more materials (e.g., metglas, nanoperm, mu-metal, cobalt-iron, permalloy, electric steel, ferrite stainless steel, martensitic stainless steel) listed in table 1398 shown in FIG. 13c.

Control electronics 1120 can include various elements such as a circuit board, conductor, magnet, communication component, antenna, switch, connector, display and. A magnetic material 1114 may be arranged to at least partially enclose some of the elements in the control electronics 1120. This arrangement may allow the magnetic material 1114 to shield losses due to elements of the control electronics 1120.

In some embodiments, control electronics 1120 can include circuitry for tuning a resonant frequency of a connected receiver resonator or impedance matching. For example, the control electronics 1120 can include control circuitry, tuning circuitry, measurement circuitry, or monitoring circuitry. These circuitry may be fixed tunes or variably tuned, and can be used to monitor the voltages, currents, phase, inductance, capacitance of the repeater resonator. Measured parameters of the repeater resonator can be used to adjust or tune the repeater resonator. A user may manually tune or the control electronics 1130 may actively adjust the capacitance, resonant frequency, inductance, resistance of the repeater resonator based on a received external signal to prevent exceeding its voltage, current, temperature, or power limits. In certain embodiments, the control electronics 1120 can include open or closed loop circuits for feedback control, where a feedback signal may be received as a wireless signal (e.g., RF signal, Bluetooth, NFC signal). The feedback signal can be fed to the circuitry within the control electronics 1120.

In certain embodiments, control electronics 1120 can include elements for protecting the operation of a battery 1100. For example, control electronics 1120 can include switches such as thermal switches, poly switches or DC circuits. Control electronics 1120 can include sensors and/or over-voltage protection, over-current protection, and/or over-temperature protection circuits. The elements can be used detect above threshold condition (e.g., in voltage, current, temperature), adjust the operation of a battery 1100 or send a signal to a monitoring device. In certain embodiments, elements such as field effect transistors (FET) or poly switches can be used to change a resonant frequency or received power of the battery 1100. The overall footprint of control electronics 1120 may be reduced using these elements.

In some embodiments, a battery housing 1130 of a battery 1100 can be opened so that the arrangement of its individual components is adjusted or tuned. For example, the battery housing 1130 can be a sleeve which can slide off its power receiving sub-structure 1102 and battery cell 1104. In other example, the battery housing 1130 can have a sliding cover or hinged cover. A user can slide open the cover or rotate the hinged cover to directly access the power receiving sub-structure 1102 and/or the battery cell 1104. This may allow easy replacement of any defect elements in the battery 1100. Control electronics 1120 can include electrodes which contact either the anode of cathode of the battery 1100. In some cases, a user may replace components (such as a battery cell 1104, resonator or faulty circuitry) to a new component. This may reduce cost of maintaining the battery 1100.

Power Transmitting Apparatus

As part of a wireless power transfer system, a power transmitting apparatus transmits power to a power receiving apparatus such as one of more of the batteries disclosed herein. As explained above, the transmitted power can be stored in storage cells of the power receiving apparatus and/or delivered directly to the device in which the power receiving apparatus is installed. Typically, the power transmitting apparatus includes one or more source resonators for power transmission.

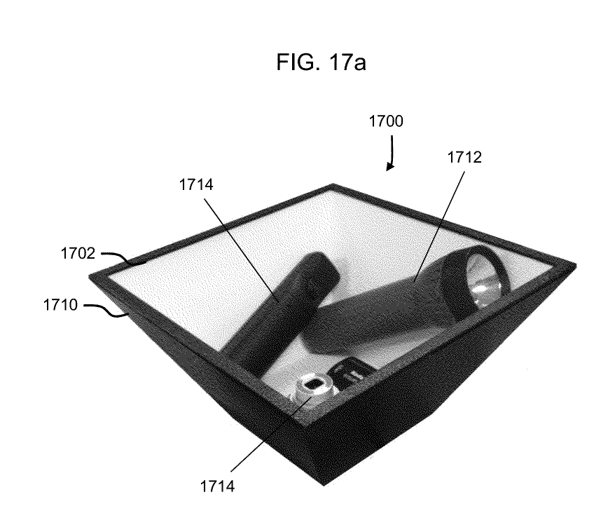

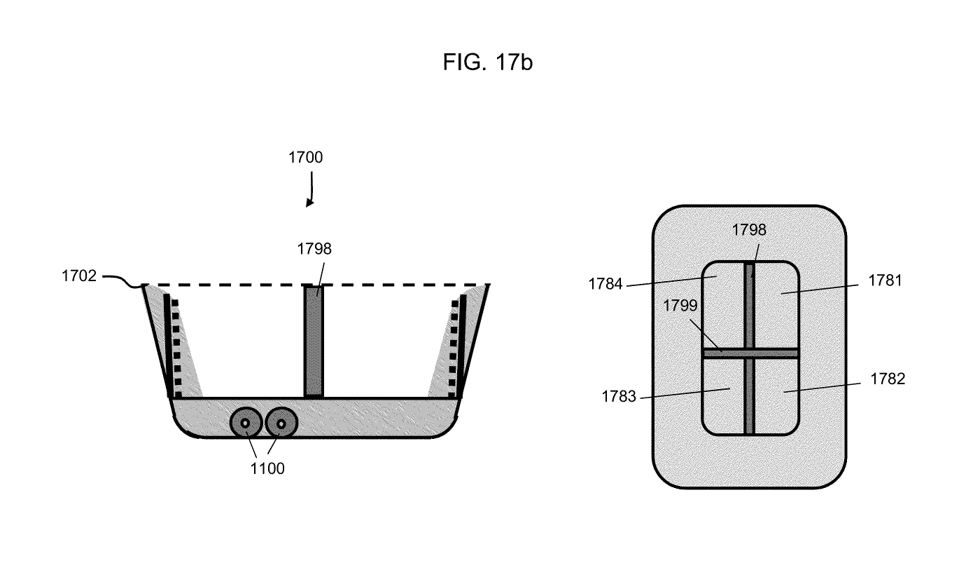

FIG. 17a is a schematic diagram showing an example of a power transmitting apparatus 1700. Power transmitting apparatus 1700 includes a housing 1702 that is shaped to hold several electronic devices. In the example shown in FIG. 17a, housing 1702 is a shaped as bowl 1710, which has embedded source resonators (not shown) in its sidewalls. More generally, housing 1702 can have a variety of form factors, including being shaped as a bowl, box, storage cabinet, storage compartments, toy containers, furniture, etc. For example, a storage cabinet can have drawers where source resonators are embedded within the sidewalls or floor of its drawers. The storage cabinet can have drawers, slots or openings to hold electronic devices and/or wirelessly rechargeable batteries 1100 which receive power from the source resonators. In some embodiments, housing 1702 can be made from materials including plastic or fabric.

In FIG. 17a, the devices (e.g., battery-operated devices) that include batteries 1100 to which power is transmitted by apparatus 1700 include a flashlight 1712, remote control 1714 and digital camera 1714. More generally, however, a wide variety of battery-operated devices can include batteries 1100 to which power is transmitted by apparatus 1700 when the devices (with the batteries installed) are positioned in, or near, apparatus 1700. Additional examples of such devices include, but are not limited to, toys, remote controls, game controllers, and communication devices.

In some embodiments, power transmitting apparatus 1700 can have multiple storage compartments. For example, the storage compartments may be sterile or waterproof compartments. FIG. 17b is a schematic diagram showing a top view and a side view of a power transmitting apparatus 1700 with multiple storage compartments. The top view shows two compartment walls 1798 and 1799, which divide the power transmitting apparatus 1700 into four compartments 1781-1784. The side view shows the compartment wall 1798 (while the compartment wall 1799 is not shown). It is understood any other number of compartment walls may be used. Different compartment walls may have repeater resonators or magnets in their sidewalls to guide or enhance the field provided by source resonators. For example, compartment walls 1798 and 1799 can have embedded repeater resonators or magnets. In some embodiments, the compartment walls may include highly conductive materials, objects, forms or sheets. One or more batteries 1100 may fit at least partially within a battery compartment. Power transmitting apparatus 1700 may have a lid, cap, cover, screen, seal, etc., to enclose the battery compartment. In some embodiments, one or more repeater resonators may be embedded in or attached to housing 1702 (e.g., bowl 1710) instead of source resonators physically connected to a power outlet. The one or more repeater resonators may receive power from one or more source resonators (external to apparatus 1700). It is understood that, in the following disclosure related to apparatus 1700, a repeater resonator may be used instead or in combination with a source resonator. The resonators may be of any size or shape. The resonators may have a two-dimensional (2D) structure or a three-dimensional (3D) structure.

In certain embodiments, multiple resonators may be overlapped to each other. This approach may increase the controllability of a field (e.g., electric, magnetic field) distribution generated by the multiple resonators. For example, by controlling magnitudes of applied voltages and currents through multiple resonators, the orientation of the magnetic field at a point in 3D space can be controlled. By controlling relative phases of voltages and currents through multiple resonators, a rotating magnetic field can be generated. As another example, by selectively activating the overlapped multiple resonators, power may be transferred to a device with arbitrary orientations of its receiver resonator.

In certain embodiments, a power transmitting apparatus 1700 may encase multiple compartments, sections, drawers, slots, openings, etc. For example, the bowl 1710 (shown in FIG. 17a) may further include inner-sidewalls to provide compartments separating the flashlight 1712, remote control 1714 and digital camera 1714. The inner-sidewalls may include one or more source resonators. The compartments may be shaped to hold specific types of batteries. The compartments may be shaped to hold specific batteries near each other or away from each other.

In some embodiments, different compartments can have source resonators operating at different frequencies. This may allow a user to selectively provide power to batteries 1100 or electronic devices. For example, the different frequencies (e.g., 6.78 MHz, 13.56 MHz) can have a harmonic relationship from each other. This approach may be implemented using a single frequency generator.

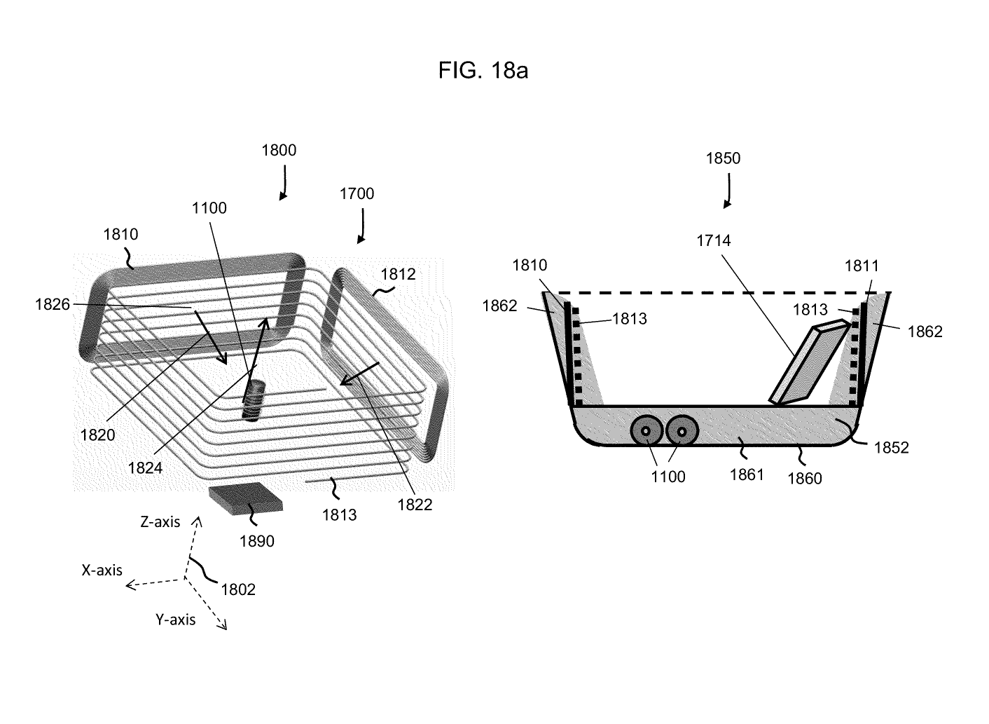

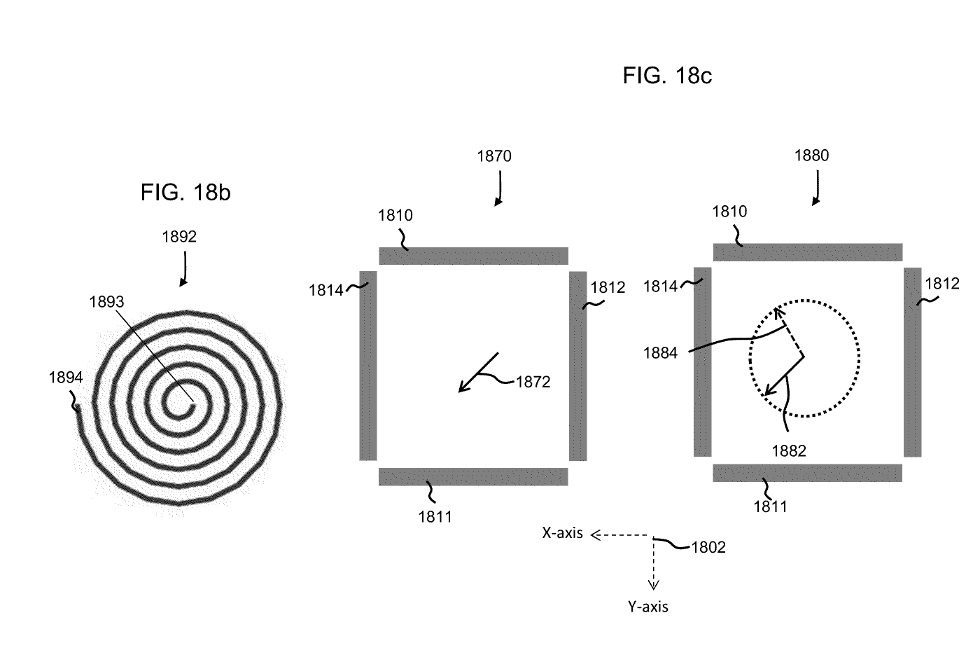

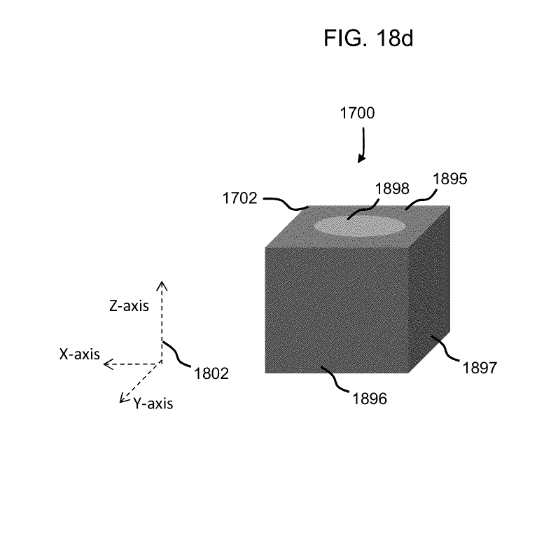

FIG. 18a is a schematic diagram of a power transmitting apparatus 1700. View 1800 shows the arrangement of source resonators of the apparatus without its housing. In this example, a source resonator 1810 includes a Type A coil, a source resonator 1812 includes a Type A coil and a source resonator 1813 includes a helical coil. A Type A coil can have its coil wound around in a single plane, as shown in view 1800. A helical coil can have a plurality of loops wound around an axis while the loops advance in a direction of the axis for each turn of the loops. The orientation of each coil is described in relation to coordinate axes 1802. Type A coil of the source resonator 1810 has a plurality of loops of conducting material forming a series of concentric loops in a plane parallel to the X-Z plane. The loops define a coil with an axis 1820 parallel to the Y coordinate direction. Type A coil of the source resonator 1812 has a plurality of loops of conducting material that lie in a plane parallel to the Y-Z plane and define a coil with an axis 1822 parallel to the X direction. Source resonator 1813 includes a plurality of loops that define a helical coil with an axis 1824 parallel to the Z direction. This arrangement creates a box-like arrangement of source resonators.

The source resonator 1810 has a center region 1826, which may be referred as a core region in this disclosure. In some embodiments, a magnetic material may be positioned in the core region such that the core of the source resonator 1810 is formed from the magnetic material. Other source resonators 1811, 1812 and 1813 may have their respective cores formed from a magnetic material. In this case, the cores of each pair are formed from magnetic materials. In certain embodiments, the source resonators have their coils formed concentric to their respective cores. It is understood that the magnetic material in the apparatus 1700 can have properties described in relation to magnetic material 1114 of a power receiving apparatus. For example, the magnetic material can include ferrite material such as Nickel-Zinc ferrites, rigidly-formed NL-12S ferrites or flexible FJ3, or Manganese-Zinc ferrite. The magnetic material in the apparatus 1700 can be made from one or more materials (e.g., metglass, nanoperm, mu-metal, cobalt-iron, permalloy, electric steel, ferrite stainless steel, martensitic stainless steel) listed in table 1398 shown in FIG. 13c.

View 1850 illustrates a side cross-section of apparatus 1700 with its housing 1852 (partially shown) in the Y-Z plane. The housing 1852 has a floor 1860 and a drawer compartment 1861, which can hold multiple batteries 1100. The housing 1852 includes sidewalls 1862 which enclose the source resonators 1810, 1811, 1812 (not shown) and 1813. In this example, a source resonator 1811 (e.g., Type A coil) is enclosed to a sidewall 1862 opposite to the sidewall 1862, which encloses the source resonator 1810, so that resonators 1811 and 1810 are spaced from one another. Moreover, resonators 1810 and 1811 are aligned along a common axis. That is, a common axis extends between and connects the centers of the coils of resonators 1810 and 1811.

It is also understood that the power transmitting apparatus 1700 can include another source resonator 1814 (not shown) embedded in a sidewall different from (e.g., opposite to) the sidewall enclosing the source resonator 1812, so that resonators 1814 and 1812 are spaced from one another and aligned along a common axis (which is different from, and perpendicular to, the common axis along which resonators 1810 and 1811 are aligned). Note that the two source resonators 1811 and 1814 are not shown in the left hand side of FIG. 18a. The first pair of source resonators 1810 and 1811, being spaced apart from each other, may include the same type of coils. The second pair of source resonators 1812 and 1814, being spaced apart from each other, may include the same type of coils. In some embodiments, a pair of coils may include different types of coils, for example, positioned at opposing sidewalls of the housing of apparatus 1700. Various types of source resonators can be paired together.

In some embodiments, a power transmitting apparatus 1700 may include source resonators covering all six sides of the power transmitting apparatus 1700. Referring to FIG. 18d, a power transferring apparatus 1700 has a housing 1702 shaped as a cube. Each side of the housing 1702 has one or more source resonators embedded in their walls. Top wall 1895 includes one or more source resonators. Sidewalls 1896 and 1987 each include one or more source resonators. Although not shown in FIG. 18d, it is understood that the power transmitting apparatus 1700 has three other sides each including one or more source resonators. In this example, the top wall 1895 has an aperture 1898 were a user can place a power receiving apparatus through the aperture 1898. The one or more source resonators (not shown) in the top wall 1895 can be wound around the aperture 1898. In other example, the top wall 1895 can be detached from the other walls of the power transmitting apparatus 1700. In this case, the top wall 18995 may or may not have the aperture 1898. In some embodiments, other sides of the power transmitting apparatus may have openings (e.g., apertures) used for inserting a power receiving apparatus into the power transmitting apparatus.

In certain embodiments, source resonators 1811 and 1814 may not be included in a power transmitting apparatus 1700. In this case, opposing sidewalls can have one source resonator within one side of the sidewalls. In some embodiments, multiple source resonators can be enclosed or within one sidewall or attached to one sidewall.

It is understood that the coils can have properties described in relation to coil 1112 of a power receiving apparatus. For example, the coils can include litz wire, copper ribbons, printed on PCB, etc.

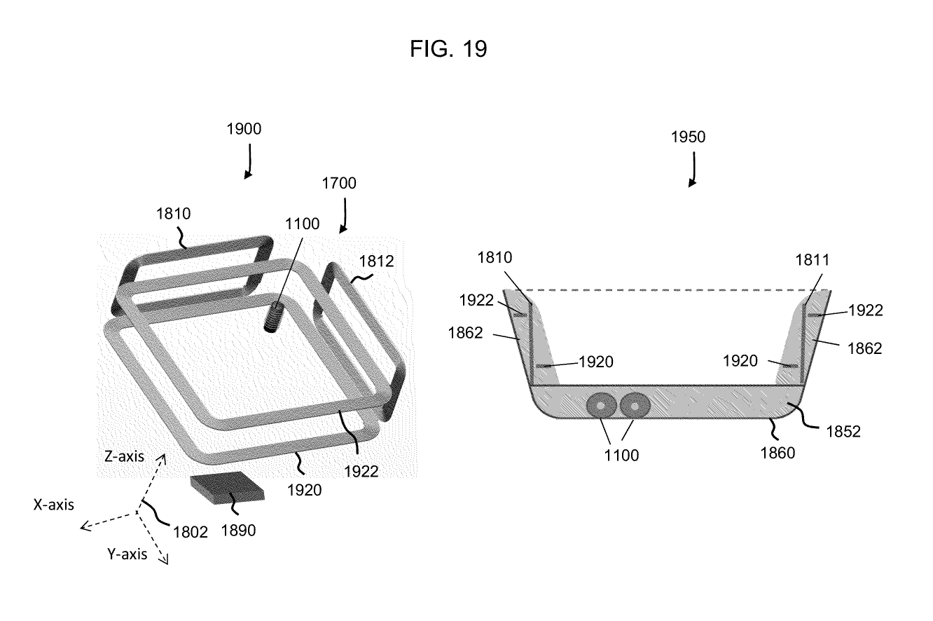

FIG. 19 illustrates a power transmitting apparatus 1700 having two source resonators 1920 and 1922 each including a Type A coil, which are oriented in planes parallel to the X-Y plane. View 1950 illustrates a side cross-section of the power transmitting apparatus 1700 in the Y-Z plane. View 1950 shows source resonators 1810, 1811, 1920 and 1922 enclosed in the sidewalls 1862.

It is understood that the power transmitting apparatus shown in FIG. 19 can have pairs of source resonators with spaced apart coils as disclosed above in connection with FIG. 18a. It is also understood that in the following examples, source resonators can be paired with one another in a similar manner so that the resonators of the pair are spaced from one another and aligned along a common axis.

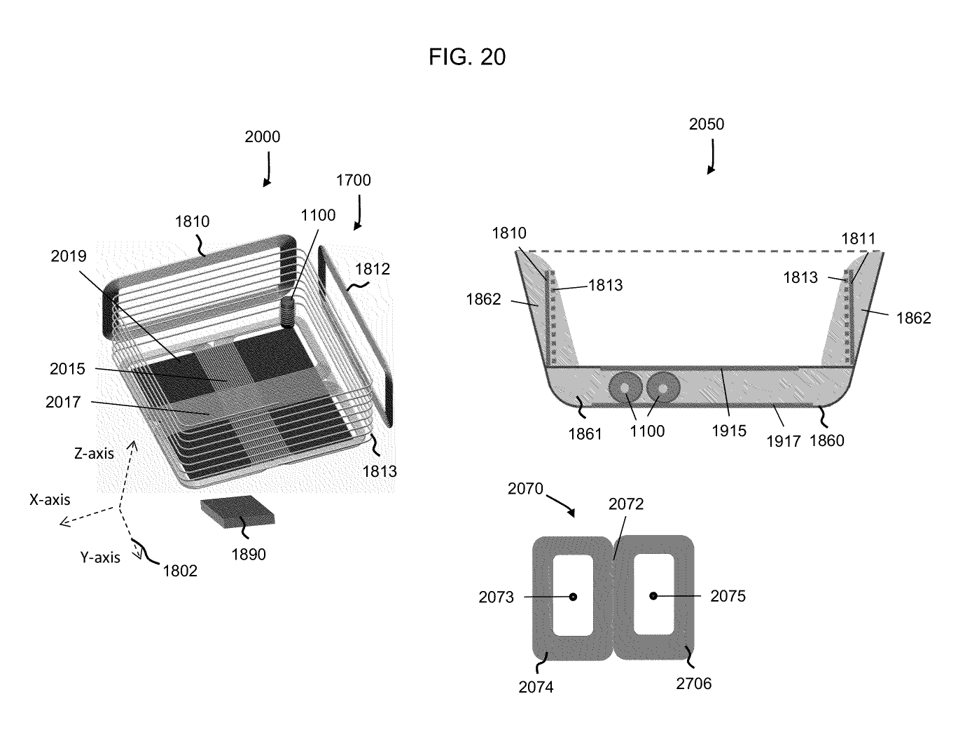

FIG. 20 is a schematic diagram showing another schematic of a power transmitting apparatus 1700. In this example, the power transmitting apparatus 1700 includes source resonators 1810 and 1812 including Type A coils and a source resonator 1813 including a helical coil. The power transmitting apparatus 1700 also has a source resonator 2015 including a bottom Type E-hybrid coil and a source resonator 2017 including a top Type E-hybrid coil. A Type E-hybrid coil is described in the following paragraph. View 2050 illustrates a side cross-section of the power transmitting apparatus 1700 in the Y-Z plane. Sidewalls 1862 enclose the source resonators 1810, 1811 and 1813. The source resonator 2015 is positioned in a bottom portion of a drawer compartment 1861. The source resonator 2017 is positioned in a top portion of the drawer compartment 1861.

View 2070 shows a schematic of a single Type E-hybrid coil 2072 lying in the drawing plane. The Type E-hybrid coil 2070 includes two winding components 2074 and 2706. In certain embodiments, the two windings 2074 and 2706 are each a Type A coil. For example, windings 2074 and 2706 can have the same winding direction. In other examples, windings 2074 and 2706 can have opposite winding directions. Currents flowing in the two windings 2074 and 2706 can generate magnetic dipole moments 2073 and 2075, respectively. In some embodiments, currents can flow in each winding 2074 and 2706, for example, around the same direction in the windings 2074 and 2706 to have the dipole moments 2073 and 2075 be aligned together (or “in-phase”). In certain embodiments, currents can flow in each winding 2074 and 2706, for example, around opposite directions in the windings 2074 and 2706 to have the dipole moments 2073 and 2075 be anti-aligned from each other (or “out-of-phase”). In some embodiments, generated dipole moments 2073 and 2075 can give rise to a relatively strong magnetic field component in the drawing plane of view 2070. For example, a strong magnetic field component in the drawing plane may be generated when magnetic fields bend over the drawing plane due to the magnetic fields generated by the dipole moments 2073 and 2075.

In some other embodiments, two adjacent coils can have each coil electrically connect to each other so that current can flow from one coil to another. Such an arrangement may have similar properties described in relation to a Type E-hybrid coil.

In some embodiments, multiple coils (e.g., multiple Type A coils, Type E-hybrid coils) can be arranged to overlap each other. In the example shown in FIG. 20, the source resonators 2015 and 2017 are overlapped but with a separation in the Z direction. The presence of the two Type E-hybrid coils of the source resonators 2015 and 2107 may increase a coupling coefficient of energy transfer between the power transmitting apparatus 1700 and a battery 1100. In certain embodiments, a magnetic material 2019 may be positioned between the two Type E-hybrid coils to improve the coupling coefficient of energy transfer. A Type E-hybrid coil may be embedded in a sidewall of the power transmitting apparatus 1700.

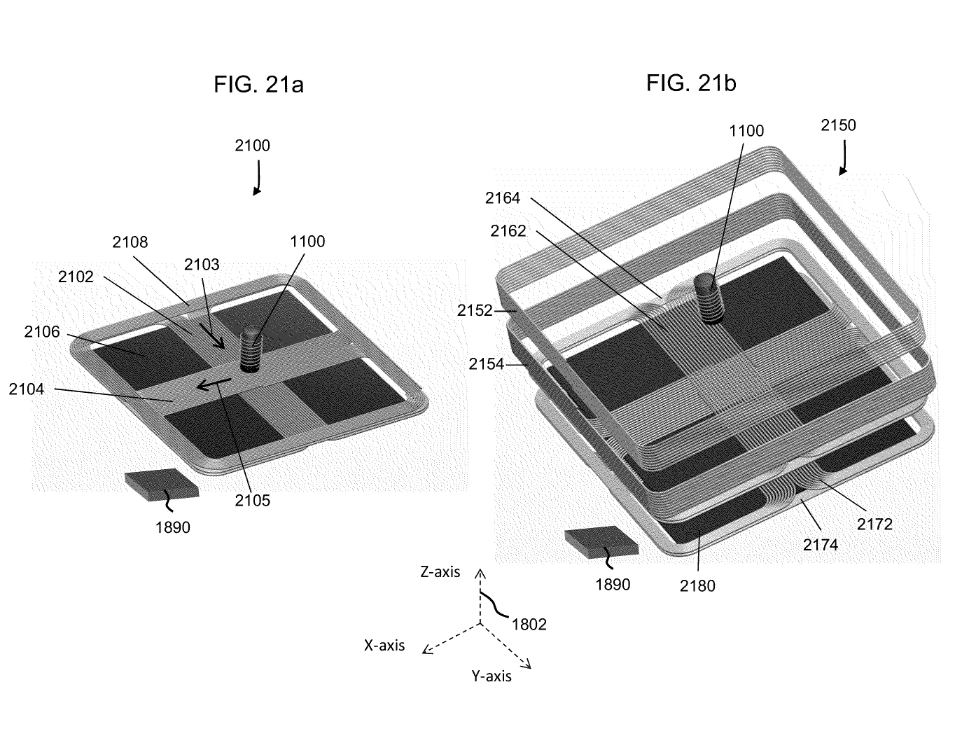

FIG. 21a is a schematic diagram showing a portion of a power transmission apparatus 2100 that includes three source resonators. Apparatus 2100 includes a source resonator 2102 including a bottom Type E-hybrid coil, a source resonator 2104 including a middle Type E-hybrid coil 2104 and a source resonator 2108 including a topmost Type A coil along the Z direction of coordinate 1802. The three source resonators 2102, 2014 and 2108 are overlapped with each other without substantial gaps in between. Source resonator 2104 has its coils in its middle portion pointing along a direction 2103 (parallel to the Y direction). Source resonator 2104 has its coil in its middle portion pointing along a direction 2105 (parallel to the X direction). A magnetic material 2106 can be positioned below the source resonators or between any of two of the source resonators. The arrangement may be used to improve the controllability of a field (e.g., electric, magnetic field) distribution generated by the source resonators.

FIG. 21b is a schematic diagram showing another power transmission apparatus 2150 that includes multiple source resonators. The source resonators include four Type E-hybrid coils 2174, 2172, 2164 and 2162 in order along the Z direction of the coordinate 1802. The Type E-hybrid coils 2174 and 2172 are positioned together without a gap. The Type E-hybrid coils 2164 and 2162 are positioned together without a gap. The Type E-hybrid coils 2172 and 2164 are separated by a gap (e.g., 20 mm) along the Z direction. In addition, apparatus 2150 includes helical coils 2154 and 2152 separated with a gap (e.g., 20 mm) along the Z direction. In this arrangement edges of the helical coils 2154 and 2152 can enhance energy coupling in the X-Y plane with a source battery 1100 at the edges of apparatus 2150, particularly at high positions in the Z direction where contributions from the Type E-hybrid coils are smaller. The gap between the helical coils 2154 and 2152 can be optimized to enhance this energy coupling.

In certain embodiments, multiple resonators can be overlapped with each other. For example, in FIGS. 21a-b, multiple source resonators are overlapped to each other. Such overlapping arrangements can produce magnetic dipole moment sin perpendicular directions. For example, one source resonator can produce a magnetic dipole moment along the X direction and another source resonator can produce a magnetic dipole moment along the Y direction. Accordingly, magnetic field components pointing in the X and Y direction can be generated. This approach can be used to efficiently transfer power to a receiver resonator with its coaxial axis pointing in any direction in the X-Y plane.

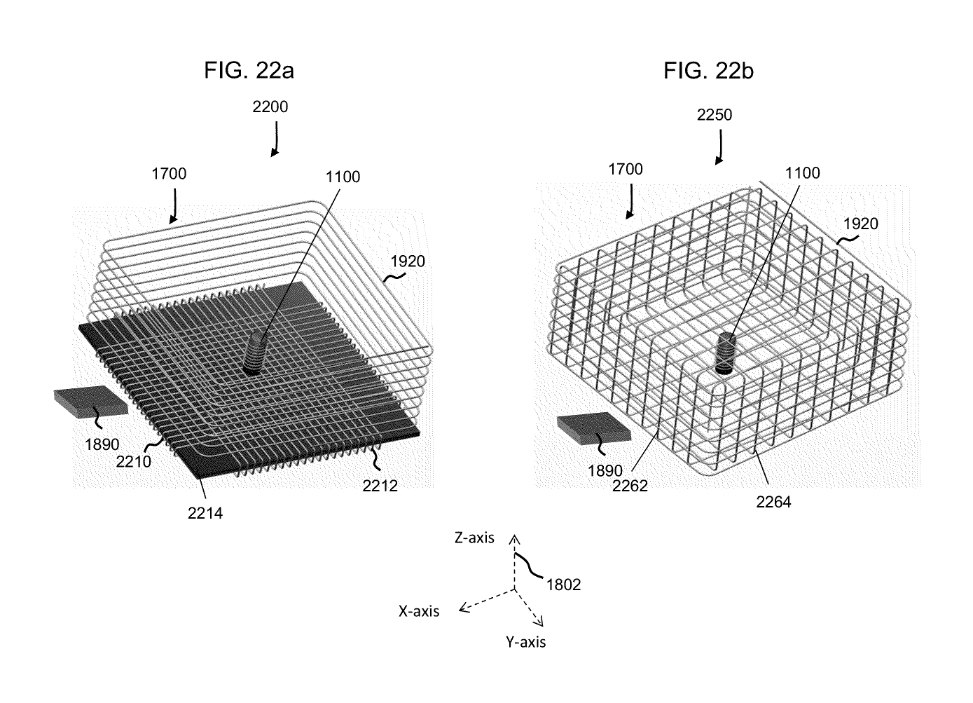

In some embodiments, a power transmission apparatus 1700 can have source resonators including multiple helical coils. For example, as shown in FIG. 22a, view 2200 shows a power transmission apparatus 1700 having a source resonator including a helical coil 1920. The axis of coil 1920 is oriented parallel to the Z axis of the coordinate 1802. The helical coil 1920 can provide a relatively uniform magnetic field along the Z direction. The apparatus 1700 includes two helical coils 2210 and 2212 wrapped around a magnetic material 2214. The helical coil 2210 is oriented so that it can produce a magnetic dipole moment in the Y direction through oscillating currents in its coil. The helical coil 2212 is oriented so that it can produce a magnetic dipole moment in the X direction through oscillating currents in its coil. The two helical coils 2210 and 2212 can be used to control the direction of a generated magnetic field in the X-Y plane.

FIG. 22b is a schematic diagram showing another example of power transmission apparatus 1700 including multiple helical coils. In this example, the power transmitting apparatus 1700 includes three helical coils 1920, 2262 and 2264 which are each oriented such that their respective axes are parallel to the Z, Y and X directions, respectively. Because the coil loops of the helical coils 1920, 2262 and 2264 span a significant volume (e.g., 80% or more, 90% or more) of apparatus 1700, this arrangement can provide a substantially uniform field distribution throughout the volume of the apparatus. For example, a difference between a maximum and minimum absolute value of a magnetic field distribution may be within 5% (e.g., within 10%, within 20%, within 30%) of the maximum value in the volume enclosed by the helical coils 1920, 2262 and 2264. Helical coils can be embedded on sidewalls or all size faces of the apparatus 1700.

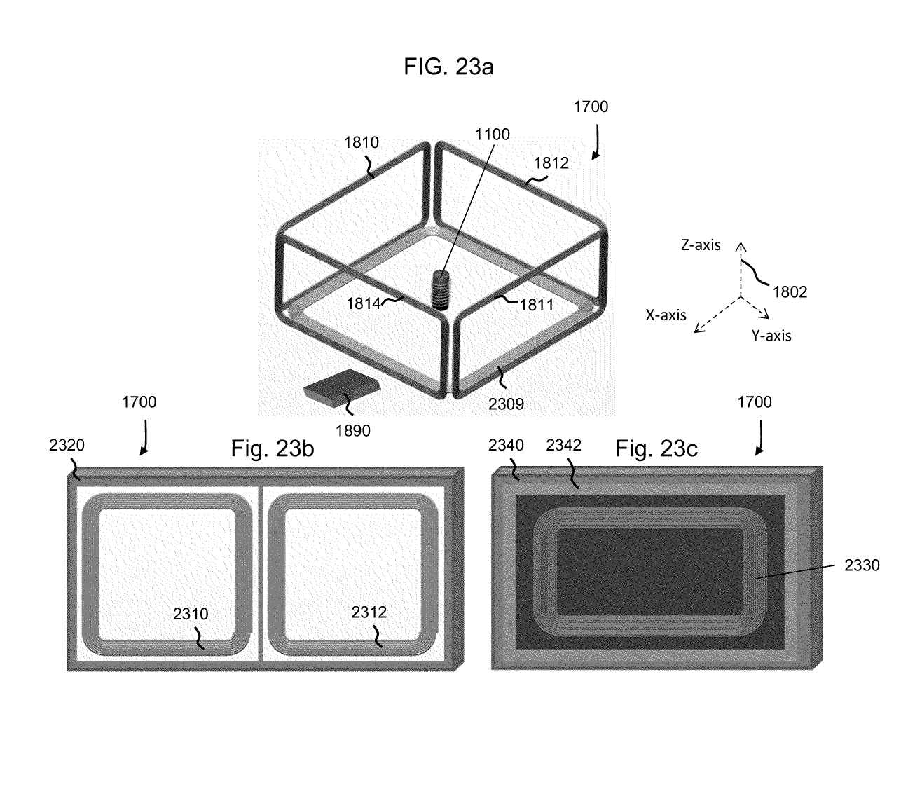

FIG. 23a is a schematic diagram showing an example of a power transmission apparatus 1700 with at least five source resonators, each including a Type A coil. FIG. 23b is a schematic diagram showing an example of a power transmission apparatus 1700 which has two source resonators 2310 and 2312 (which have multiple planar windings) side-by-side and enclosed in a housing 2320. The two source resonators 2130 and 2312 may be driven synchronously using a same power source. FIG. 23c illustrates another example of a power transmitting apparatus 1700 which includes one source resonator 2330 enclosed in a housing 2340 (e.g., plastic casing). The housing 2340 may also include a shield 2342 for reducing any losses by nearby perturbing objects (e.g., metallic objects). The housing 2320 and 2340 may be portable, light-weight and configured to be placed directly under toys or toy containers. In certain embodiments, the source resonator 2330 may conform to a shape of a toy or a toy container.

In some embodiments, a power transmitting apparatus 1700 has a housing which can be configured in a variety of form factors. For example, the power transmitting apparatus 1700 may be configured as a box shape, which can hold several electronic devices and/or batteries 1100. In the box shape configuration, the power transmitting apparatus 1700 can be used to move the contained objects around.

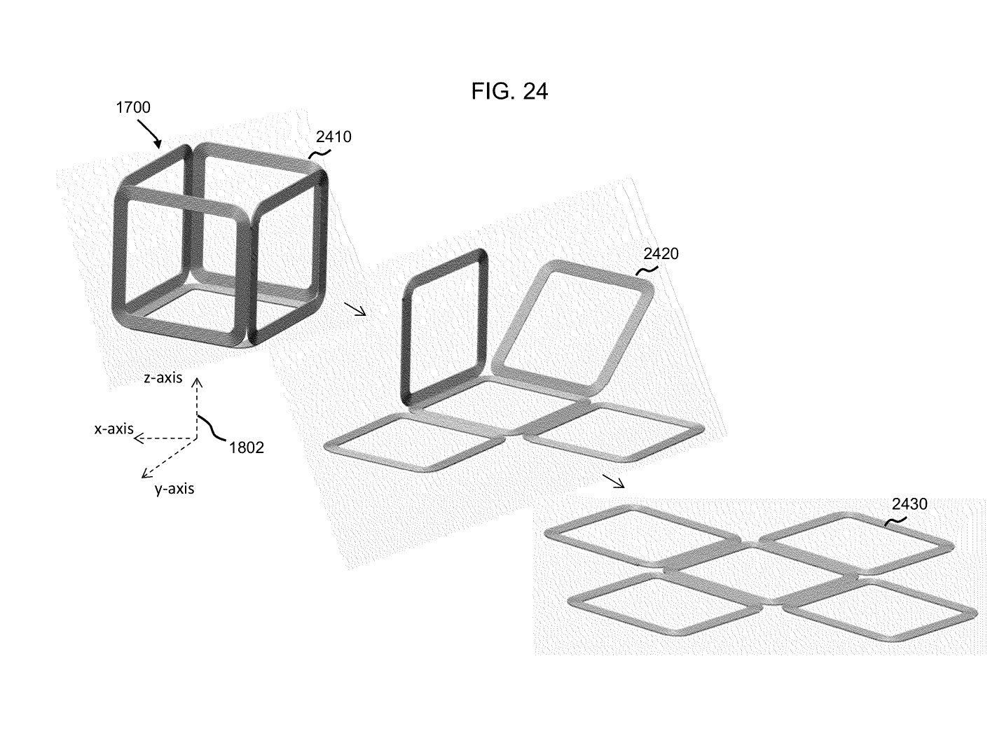

In some embodiments, the form factor of the housing of apparatus 1700 can be reconfigured from a first form factor to another form factor. For example, the sidewalls can be detached at the edges and pressed flat in a planar form factor. FIG. 24 illustrates such an example reconfiguration. In this example, a power transmitting apparatus 1700 has source resonators including five Type A coils. It is understood that other types of source resonators can be used. In configuration 2410, the five Type A coils are attached to each to form a box shape. In configuration 2420, edges of the Type A coils, which formed the sidewalls in configuration 2410, are detached to be flexibly rotated. In configuration 2430, the five Type A coils are configured to lie in the X-Y plane of the coordinate 1802 as a flat pad-shaped structure. This configuration may be used to expand the area when electronic device and/or batteries 1100 cannot fit inside the power transmitting apparatus.

In certain embodiments, a power transmitting apparatus 1700 may be deformable. For example, source resonators included in the power transmitting apparatus 1700 may be flexible to be reconfigured to accommodate different types or numbers of devices. The source resonators may be integrated into toy containers, toy shelves, cribs, or other furniture.

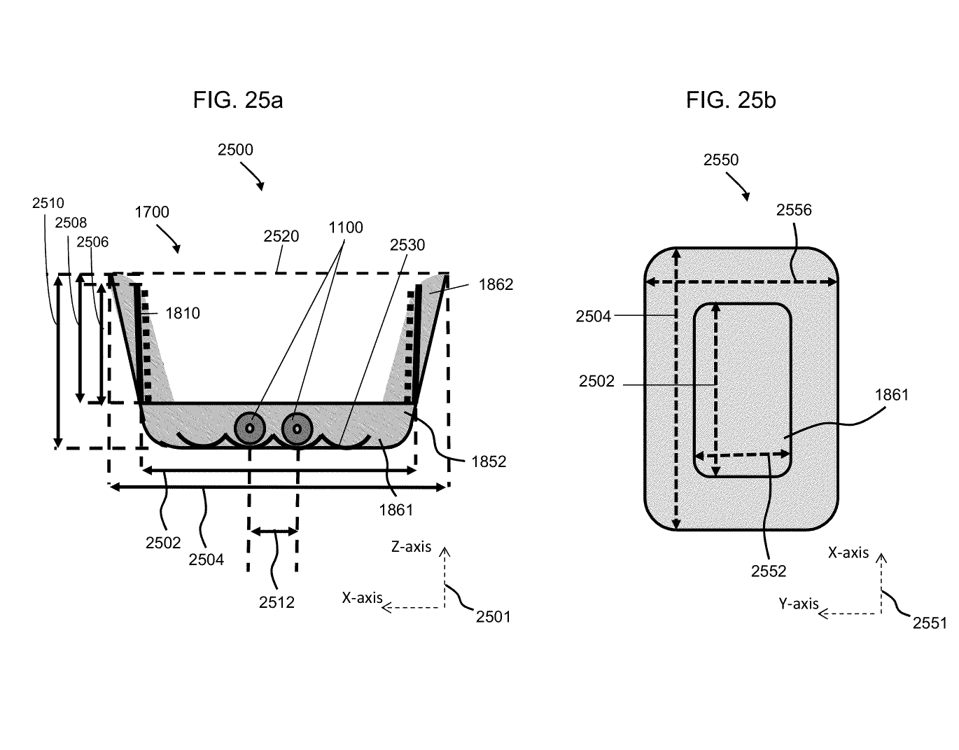

FIG. 25a is a schematic diagram showing an example of a power transmitting apparatus 1700 with its housing 1852. View 2500 shows a side-cross section of the power transmitting apparatus 1700 as seen in a X-Z plane of the coordinate 2501. The power transmitting apparatus 1700 has a drawer component 1861 with a width 2504 of about 200 mm in the X direction. The power transmitting apparatus 1700 also includes a sidewall 1862 which is connected to the drawer component 1861 at an oblique angle to provide an opening 2520 (also referred as “aperture” 2520) at the top of the power transmitting apparatus 1700. The opening 2520 has a width of about 300 mm in the X direction. The opening 2520 can allow a power receiving apparatus (e.g., a battery 1100) to be introduce in the housing 1852. A source resonator 1810 has a height 2506 of about 105 mm. The sidewall 1862 has a height 2508 of about 130 mm. The total height 2510 of the power transmitting apparatus 1700 is about 160 mm FIG. 25b is a schematic diagram showing a view 2550 of the power transmitting apparatus 1700 as seen in the X-Y plane of the coordinate 2551. The drawer compartment 1861 has a width 2552 of about 150 mm in the Y direction. The opening 2520 has a width 2556 of about 200 mm in the Y direction. Such dimensions can allow the power transmitting apparatus to be used in common shelves. It is understood that the power transmitting apparatus 1700 can be designed to have other dimensions (e.g., widths, heights) to be suitable for the intended application.

In some embodiments, a power transmitting apparatus 1700 can include a support structure 2530, where a device or a battery 1100 can be fitted in. For example, the support structure 2530 can include grooves, slots or openings in a drawer compartment 1861. Referring back to FIG. 25a, the power transmitting apparatus 1700 has a support structure 2530 in its drawer compartment 1861. Two batteries 1100 are each placed in groove of the support structure 2530, which can separate the two batteries 1100 at a minimum distance 2512. For example, the minimum distance 2512 can be 0.5 times or more (e.g., 1 time or more, 1.5 times or more, 2 times or more) of the diameter of one of the battery cell 1100 in the X-Z plane. The minimum distance 2512 is typically chosen to reduce the amount of coupling between the adjacent batteries 1100, and thereby reduce any change of resonant frequencies or coupling between receiver resonators inside the two batteries 1100.

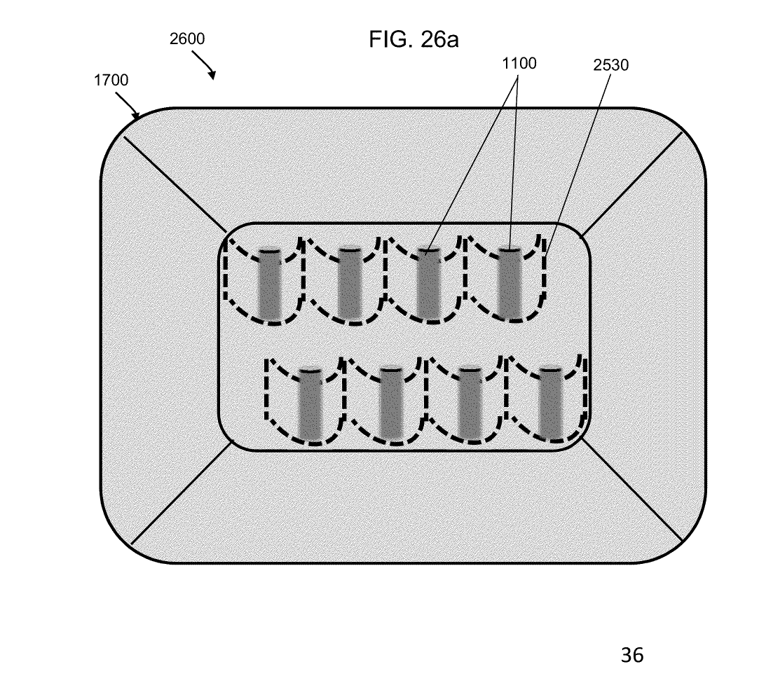

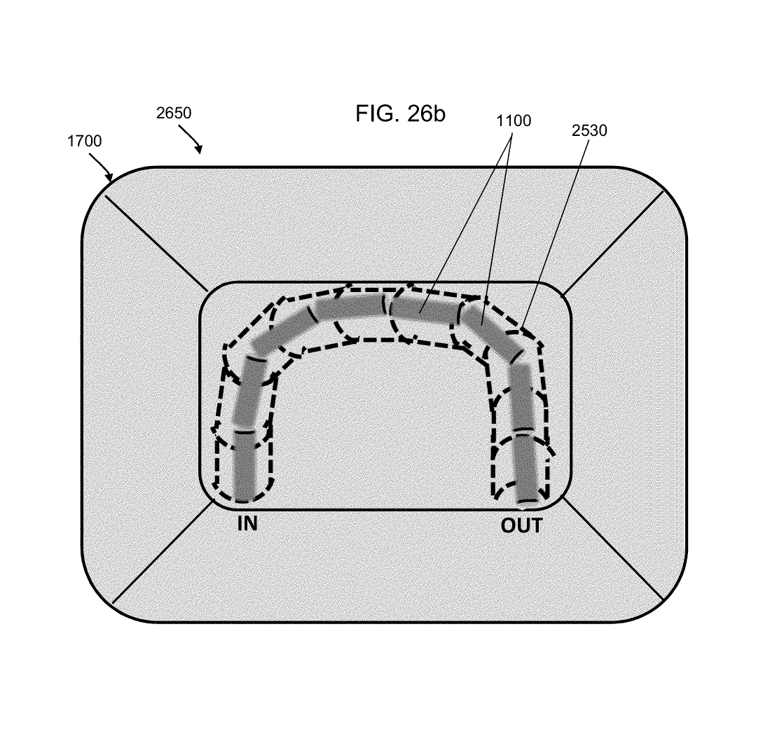

In certain embodiments, a support structure 2530 can be used to position multiple batteries 1100 at positions with relatively high magnetic fields in a power transmitting apparatus 1700. Referring to FIG. 26a, view 2600 shows a power transmitting apparatus 1700 from a top view with a support structure 2530. In this example, the support structure 2530 has two racks, where each rack can have four batteries 1100 to fit in. The position of the racks can be determined based on the types, arrangement and operation of source resonators embedded in the power transmitting apparatus 1700. The coupling may be enhanced along the coaxial axes of the batteries 1100. Referring to FIG. 26b, view 2650 shows a power transmitting apparatus 1700 from a top view with a support structure 2530. In this example, the support structure 2530 includes a flexible band, which can hold up to eight batteries 1100. The batteries can be inserted one by one into an entrance hole and taken out from an exit hole by pulling the flexible band. The support structure 2530 is designed to have a semi-circular shape to avoid low magnetic field distributions of the power transmitting apparatus 1700. The semi-circular shape can be designed to place the batteries 1100 in positions with reduced coupling between the batteries 1100. In some embodiments, a patter 2530 can be formed in one or more sidewalls of a power transmitting apparatus 1700.

Operation of Power Transmitting Apparatus

When devices that include a wireless power receiving apparatus are placed in proximity to a wireless power transmitting apparatus, the relative placement between the apparatus' is often relatively uncontrolled. That is, one or more receiving resonators in the power receiving apparatus can be positioned in a variety of orientations with respect to source resonators in the power transmitting apparatus. Power transfer between the power transmitting apparatus and power receiving apparatus is nonetheless dependent on the relative orientations of the respective resonators. However, requiring users of the systems disclosed herein to perform reproducible positioning of the apparatuses with respect to one another is frequently inconvenient; in some embodiments, it may be rather difficult, particularly where the power transmitting and/or receiving apparatuses are concealed within housings that do not indicate their respective orientations.

The methods and systems disclosed herein enable efficient wireless power transfer between a power transmitting apparatus and a power receiving apparatus without knowledge of the relative orientations of the apparatuses, and without taking steps to specifically align the apparatuses. The methods and systems disclosed herein activate multiple source resonators to wirelessly transfer power along multiple spatial directions so that power transfer between apparatuses in a variety of relative orientations can be achieved. In this manner, power transfer for operation of devices and charging of batteries in devices occurs in a straightforward, cost-effective way that does not burden users of the system with inconvenient and/or difficult alignment tasks.

Source resonators can be activated in various ways to realize directionally-varying power transfer. Specifically, currents and voltages in source resonators in a power transmitting apparatus 1700 can be operated in various configurations. In this section, several configurations are described in relation to FIG. 18a. It is understood that the disclosed techniques can be generally applied to other examples described in this disclosure.

Referring back to FIG. 18a, the power transmitting apparatus 1700 includes a first pair of source resonators 1810 and 1811, which are spaced from one another along a common axis 1820. The power transmitting apparatus 1700 includes a second pair of source resonators 1812 and 1814 (not shown but described earlier), which are spaced from one another along a common axis 1822. The axis 1820 is different from axis 1822. In some embodiments, axes 1820 and 1822 are orthogonal. More generally, however, axes 1820 and 1822 are oriented at an angle with respect to one another, the angle being between 30 degrees and 90 degrees (e.g., between 40 degrees and 90 degrees, between 60 degrees and 90 degrees, between 70 degrees and 90 degrees, between 80 degrees and 90 degrees).

In this example, the power transmitting apparatus 1700 includes a controller 1890 which is connected to the source resonators. In some other embodiments, the controller 1890 may be external to the power transmitting apparatus 1700.

In some embodiments, a controller 1890 can include a processor used carry out the functions of the controller 1890 described in this disclosure.

In some embodiments, controller 1890 can be configured to activate the first pair and the second pair of source resonators to provide non-radiative wireless power transfer from the power transmission apparatus 1700 to a power receiving apparatus. This may be achieved by alternately activating the first pair of source resonators to transfer power from the first pair to at least one receiving resonator in the battery 1100 and activating the second pair of source resonators to transfer power from the second pair to at least one receiving resonator in the battery 1100. As used herein, “alternately activating” first and second pairs of source resonators refers to activating the first and second pairs of source resonators such that both pairs of resonators are not receiving a maximum driving voltage or power from a controller (e.g., controller 1890) at the same time during an activation cycle. Pairs of source resonators can be alternately activated in several ways. For example, in some embodiments, first and second pairs of source resonators are alternately activated by applying oscillating driving voltages to the first and second pairs of resonators which are not in phase. Since the oscillating driving voltages are not in phase, when a maximum driving voltage is applied to the first pair of source resonators, the driving voltage applied to the second pair of source resonators will be different from that pair's maximum driving voltage. Similarly, when a maximum driving voltage is applied to the second pair of source resonators, the driving voltage applied to the first pair of source resonators will be different from that pair's maximum driving voltage. The maximum driving voltages applied to the first and second pairs of source resonators can be the same or different. As used herein, an “oscillating” voltage or driving signal is a voltage or signal that varies in a repeatable cycle between maximum and minimum values. The oscillating voltage or signal can oscillate continuously (e.g., as a sinusoidal or other periodically continuous waveform), in discrete steps, or in a piecewise-continuous manner. Voltages that oscillate in discrete steps can oscillate in steps that are of the same or different magnitudes.

A controller (e.g., controller 1890) is coupled to pairs of source resonators to activate the resonators. In some embodiments, the controller is coupled to the source resonators through a direct electrical connection. When connected directly, the controller can activate a pair of source resonators by applying currents and voltages to each source resonator in the pair, which generates fields (e.g., electric field, magnetic field) in a power transmitting apparatus. The controller 1890 can be configured to control a magnitude and phase of currents and voltages applied to each source resonator in the pair. This can allow the controller 1890 to control a generated field (e.g., electric field, magnetic field) distribution by the source resonators.

In certain embodiments, the controller can be coupled to the source resonators indirectly, e.g., through one or more repeating resonators. When coupled in this manner, the controller can activate the source resonators by delivering power to the source resonators through the repeating resonators (e.g., wirelessly). With either type of coupling, the controller can be integrated within the housing of a power transmission apparatus, or separate from the housing (e.g., external to the housing).

In some embodiments, the resonators can provide circulating magnetic fields which may allow devices (e.g., game controller) or batteries to be charged in any position within a power receiving apparatus 1700.

In the example illustrated in FIG. 18a, the source resonator 1810 has its Type A coil wound clock-wise starting from its inner loop to outer loop. The source resonator 1811 has its Type A coil wound counter clock-wise starting from its inner loop to outer loop. To elaborate this, FIG. 18b is a schematic diagram showing an example coil 1892. The coil 1892 has its loops wound clock-wise starting from its inner loop 1893 to outer loop 1894. In one configuration, the controller 1890 can activate the first pair of source resonators 1810 and 1811 by applying the same magnitude and phase of voltage to these source resonators. Because the Type A coils of the two source resonators 1810 and 1811 are wound in opposite directions, magnetic fields generated by the Type A coils will reinforce each other in the power transmitting apparatus 1700. This approach may reduce a field gradient within the power transmitting apparatus 1700. Alternatively, the controller 1890 can activate the source resonator 1810 and 1811 out-of-phase, and magnetic field generated by the Type A coils will oppose each other in the power transmitting apparatus 1700. This approach may reduce a field gradient within the power transmitting apparatus 1700. In some embodiments, the Type A coils of the two source resonators 1810 and 1811 may be wound in the same direction, and the controller can adjust its application of voltages to the source resonators.

In some embodiments, the first pair of source resonators 1810 and 1811 can have their Type A coils wound in opposite directions and the controller 1890 can apply the same magnitude and phase of voltages to the source resonators 1810 and 1811. The second pair of source resonators 1812 and 1814 can have their Type A coils wound in opposite directions and the controller 1890 can apply the same magnitude and phase of voltages to the source resonators 1812 and 1814. The controller 1890 can be configured to apply oscillating voltages to the first and second pairs with the same magnitude and phase of voltages (without activating the source resonator 1813). FIG. 18c is a schematic diagram showing a view 1870 of a magnetic field 1872 generated by the combined fields provided by the first and second pairs in such an example. The magnetic field 1872 is pointing in the X-Y plane with an angle of 45 degrees between the X and Y axes due to the same magnitude and phase of voltages applied to the first and second pairs. In another example, the controller 1890 can be configured to apply voltages to the first and second pairs with the same magnitude and a phase difference of 90 degrees (without activating the source resonator 1813). View 1880 shows a schematic view of a magnetic field 1888 generated by the combined fields provided by the first and second pairs in such an example. The magnetic field 1882 lies and rotates in the X-Y plane due to the phase difference of currents and voltages in the first and second pairs. The magnetic field 1882 rotates, and at a different time it is positioned as, for example, magnetic field 1884. In some applications, this rotating magnetic field 1882 may be used to charge batteries that are oriented principally in the X-Y plane.

The controller 1890 can be configured to apply oscillating voltages to the source resonator 1813 to generate a magnetic field in the Z direction (without currents in the Type A coils 1810 and 1812). Such a magnetic field may effectively transfer power to a power receiving apparatus (e.g., a battery 1100) for certain orientations of the apparatus. The helical coil of the source resonator 1813 extends a substantial distance in the Z direction. This configuration may provide a relatively uniform magnetic field in the Z direction. In certain embodiments, the controller 1890 may apply a static voltage to the source resonator 1813 to generate a static field. In some embodiments, the power transmitting apparatus 1700 can include a third pair of source resonators which are spaced apart along a common axis in the Z direction. An example is shown in FIG. 21b.

Referring back to FIG. 18a, the controller 1890 can be configured to apply voltages to the first pair of source resonators 1810, 1811, to the second pair of resonators 1812, 1814 and to source resonator 1813. In some embodiments, the controller 1890 can include another source resonator lying in a plane parallel to the X-Y plane but spaced apart from the source resonator 1813. This another source resonator and the source resonator 1813 can form a third pair of source resonators. The third pair of source resonators including the source resonator 1813 can have a common axis that is different from the common axes 1826 and 1822 of the first and second pairs. Generally, the controller 1890 can be configured to apply oscillating voltages to the first and second pair of resonators which differs in phase. For example, the difference in phase can be 20° or more (e.g., 30° or more, 60° or more, 90° or more). The difference in phase can be 90° (or between 85° to 95°) or 180° (or between 175° to 185°). In some embodiments, the controller 1890 can be configured to apply oscillating voltages to the first and second pair of resonators which different magnitudes. For example, the difference in magnitude can be within 10% (e.g., within 20%, within 30%, within 50%, within 80%, within 90%) of the larger magnitude.

Generally, the controller 1890 can be configured to apply oscillating voltages to each of the first, second and third pairs of resonators to differ in phase, for example, the difference can be 20° or more (e.g., 30° or more, 60° or more, 90° or more). The difference in phase can be 90° (or between 85° to 95°). In some embodiments, the controller 1890 can be configured to apply oscillating voltages to each of the first, second and third pair of resonators to differ in magnitudes. For example, the differences in magnitude can be within 10% (e.g., within 20%, within 30%, within 50%, within 80%, within 90%) of the largest magnitude. In certain embodiments, the controller 1890 can be configured to apply a static (e.g., constant) voltage to at least one of the pair of resonators. The static voltage can vary by 10% or less (e.g., 5% r less, 2% or less, 1% or less, 0.5% or less, 0.1% or less) of its mean value during power transmission to a power receiving apparatus.

In some embodiments, the controller 1890 can be configured to apply oscillating voltages with different frequencies to different pairs of resonators or individual resonators. This approach may be used to charge devices with different resonant frequencies of receiver resonators.

It is understood that a controller 1890 can be configured to apply voltages to two pairs of resonators and an additional resonator in a similar manner described above.

Referring back to FIG. 18a, the controller 1890 can be configured to apply oscillating voltages to the first and second pair of resonators and the source resonator 1813 to generate a magnetic field with a component rotating in the X-Y plane and a component in the Z direction. Such an approach may be used to generate magnetic fields pointing in all directions of the 3D space of the power transmitting apparatus 1700 to effectively charge devices or batteries 1100.

The controller 1890 can be configured to activate the first pair of source resonators 1810, 1811 and the second pair of source resonators 1812, 1814 for a time period t₁, the first pair of source resonators 1810, 1811 and the source resonator 1813 (or additional source resonators if available) for a time period t₂, and the second pair of source resonators 1812, 1814 and the source resonator 1813 (or additional source resonators if available) for a time period t₃. For example, t₁, t₂ and t₃ can be the same. Alternatively, at least one of t₁, t₂ and t₃ can be different. In certain embodiments, the controller 1890 can adjust t₁, t₂ and t₃ based on a feedback signal. For example, the feedback signal can be received from a power receiving apparatus. The feedback signal can be received as an optical or auditory signal, for example, from a status indicator in the power receiving apparatus. The feedback signal can be wirelessly communicated, for example using optical, RF, Bluetooth or NFC signals. In some embodiments, the feedback signal includes information of charge status (e.g., charge capacity), and/or impedance, and/or inductance values of the power receiving apparatus. In some cases, the feedback signal includes information of thresholds values or time periods to adjust for the operation of the source resonators in the power transmitting apparatus 1700. Details of a feedback signal are described in other portions of this disclosure.

In the example illustrated in FIG. 23a, the power transmitting apparatus 1700 includes source resonators, 1810, 1811, 1812, 1814 and 2309. The source resonator 1810 and the source resonator 1811 can be a first pair of source resonators, and the source resonator 1812 and the source resonator 1814 can be a second pair of source resonators. The source resonator 2309 can be an additional source resonator. The apparatus 1700 may further include an additional source resonator lying in a plane parallel to the X-Y plane but spaced apart from the source resonator 2309. For example, the additional source resonator can be positioned at the top side among the six sides of the apparatus 1700. The additional source resonator and the source resonator 2309 can be a third pair of source resonators. The first, second and third pairs of source resonators can each have a common axis.

Generally, a controller 1890 can be configured to apply oscillating voltages to multiple source resonators individually or in unison. The respective voltages may the same or different magnitudes or phases. In some embodiments, the controller 1890 can apply voltages based on power received from a power source. In some embodiments, the controller 1890 can apply voltages bases on power received from other resonators external to a power transmitting apparatus 1700.

The disclosed techniques can be used to configure a controller 1890 and source resonators to generate a field (e.g., electric field, magnetic field) distribution in 3D space. The field distribution can be controlled spatially and in a time-varying manner. In this approach, a user may conveniently place a power receiving apparatus without worrying about the orientation of its receiver resonator because the field distribution can have magnetic field components along the orientation.

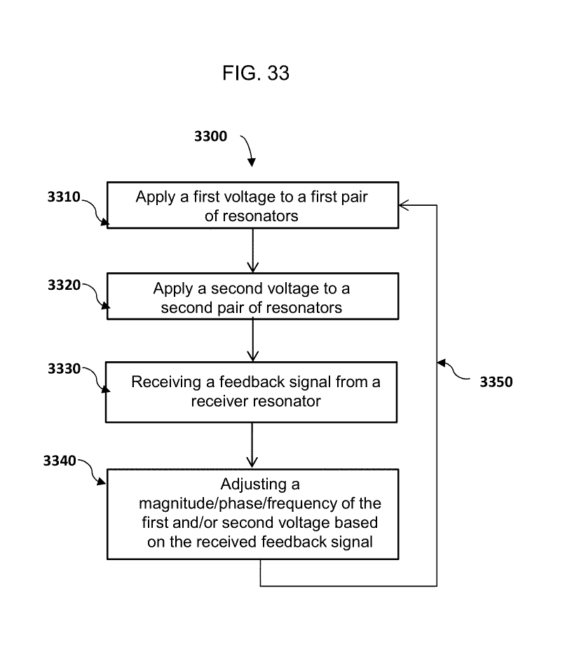

FIG. 33 is a flow chart depicting an example of a process 3300 used to wirelessly transfer power. In some embodiments, the process 3300 can be used in conjunction with the power transfer system 2700 to wirelessly transfer power to a power receiving apparatus.

At 3310, a controller 1890 applies an oscillating voltage to a first pair of source resonators spaced from one another, where each resonator includes a loop of conducting material surrounding a common first axis. The first pair of source resonators generate oscillating field which is used to transfer power from the first pair of source resonators to a receiving resonator in the power receiving apparatus.

At 3320, the controller 1890 applies an oscillating voltage to a second pair of source resonators spaced from one another, where each source resonator in the second pair includes a loop of conducting material surrounding a common second axis different from the first axis. The second pair of source resonators generate oscillating field which is used to transfer power from the second pair of source resonators to the receiving resonator. The magnitude and phase of the oscillating voltage applied in step 3320 differs from that of step 3310.

At 3330, the controller 1890 receives a feedback signal from the receiving resonator. For example, the feedback signal can be received as a wireless communication (e.g., optical, RF, Bluetooth, NFC signal). The feedback signal can include information of the location of the receiving resonator or charging status (e.g., charge capacity) of a battery cell connected to the receiving resonator. In some embodiments, the feedback signal includes information an impedance, inductance, or load condition of the receiving resonator.

At 3340, the controller 1890 adjusts a magnitude and/or a phase and/or a frequency of the first and/or second voltages applied to the first and second pair of source resonators. In some embodiments, the controller 1890 can adjust the magnitude and/or phase and/or frequency of the first and/or second voltages based on the received feedback signal at step 3330. For example, if the receiving resonator sends a feedback signal indicating the charge of the battery cell is near complete, the controller 1890 can reduce the magnitude. In some embodiments, the phases and/or frequencies of applied voltages can be adjusted to change the generated field (e.g., electric and/or magnetic field) distribution. By adjusting the magnitude and/or phase and/or frequency of the voltages based on the feedback signal, the efficiency of power transfer to the power receiving apparatus can be increased and/or optimized. For example, in response to the feedback signal controller 1890 can adjust the magnitude and/or phase and/or frequency of the first and/or second voltages, and monitor the rate at which power is transmitted to the power receiving apparatus (e.g., by determining the rate at which the battery cells are charged). The magnitude and/or phase and/or frequency of the voltages can be systematically varied to increase or decrease the power transmission rate.

In some embodiments, the controller 1890 can further apply a voltage to at least one additional source resonator including conducting material surrounding a third axis different from the first and second axes to transfer power from the at least one additional source resonator to the receiving resonator. For example, referring back to FIG. 18a, the controller 1890 can further apply a voltage to the source resonator 1813 to generate a magnetic field component in the Z direction.

At 3350, steps 3310-3340 can be repeated.

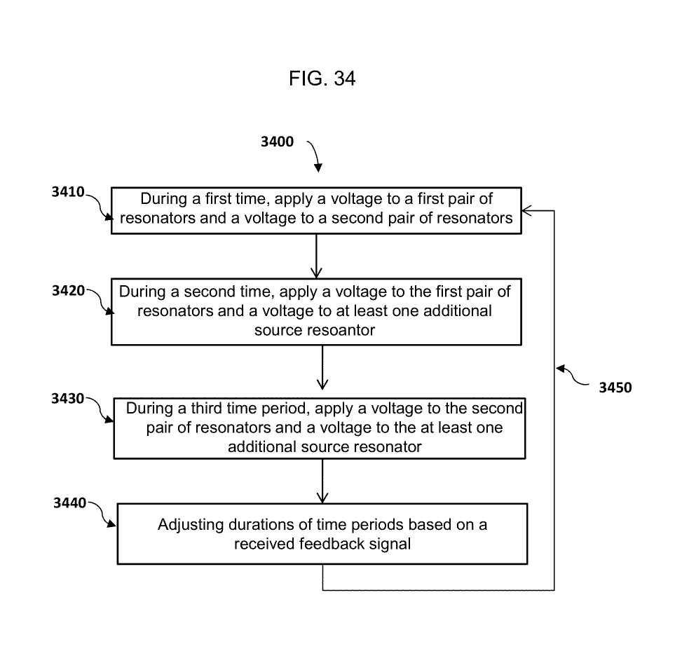

FIG. 34 is a flow chart depicting an example of a process 3400 used to wirelessly transfer power. In some embodiments, the process 3400 can be used in conjunction with the power transfer system 2700 to wirelessly transfer power to a power receiving apparatus.

At 3410, during a first time period, a controller 1890 applies a voltage to a first pair of source resonators spaced from one another, where each source resonator in the first pair includes a loop of conducting material surrounding a common first axis. The controller 1890 also applies a voltage to a second pair of source resonators spaced from one another, where each source resonator in the second pair includes a loop of conducting material surrounding a common second axis perpendicular to the first axis. As an example, referring back to FIG. 18a, the controller 1890 can apply a voltage to the first pair of source resonators 1810 and 1811, and a voltage to the second pair of source resonators 1812 and 1814, during a first time period.

At 3420, during a second time period, the controller 1890 applies a voltage to the first pair of source resonators and applying a voltage to at least one additional source resonator including a loop of conducting material surrounding a common third axis perpendicular to the first and second axes. Referring back to FIG. 18a, the controller 1890 can apply a voltage to the first pair of source resonators 1810 and 1811, and a voltage to the source resonator 1813, during a second time period. The generated time varying magnetic field distribution can differ from that at step 3410.

At 3430, during a third time period, the controller 1890 applies a voltage to the second pair of source resonators and applying a voltage to the at least one additional source resonator. Referring back to FIG. 18a, the controller 1890 can apply a voltage to the second of source resonators 1812 and 1814, and a voltage to the source resonator 1813, during a third time period. The generated time varying magnetic field distribution can differ from that at steps 3410 and 3420.

At 3440, the controller 1890 adjusts the durations of the time periods in steps 3140-3430 based a received feedback signal. For example, the feedback signal can be received as a wireless communication (e.g., RF, Bluetooth, NFC signal). The feedback signal can include information of the location of the receiving resonator or charging status of a battery cell connected to the receiving resonator. In some embodiments, the feedback signal includes information an impedance, inductance, or load condition of the receiving resonator. For example, if the receiving resonator sends a feedback signal indicating the charge of the battery cell is near complete, the controller 1890 can change some or all of the durations of the time periods to reduce power transfer. Alternatively, if the receiving resonator sends a feedback signal indicating that the battery cell is not charging more slowly than a desired rate, controller 1890 can change some or all of the durations of the time periods to increase the power transmission rate. In certain embodiments, the adjustment can lead to optimizing the power transfer efficiency to the receiving resonator.

At 3450, steps 3410-3440 can be repeated.

Communication of Wireless Power Transfer

Referring back to FIG. 18a, the power transmitting apparatus 1700 can wirelessly provide power to a wirelessly chargeable battery 1100. In some embodiments, the battery 1100 may include a status indication (e.g., visual, auditory indicator) for providing a signal about the charge state of the battery 1100 or its ability to receive wireless power. For example, the battery 1100 may include a light source such as an LED or an electroluminescent label, which provides a light signal depending on the condition of the battery 1100. Different colors of light or blinking of light may signal how much capacity of the battery 1100 is charged. In certain embodiments, the battery 1100 is inserted in an electronic device having clear windows, cutouts, or holes to allow a user to determine the condition (e.g., charge state) of the battery 1100. In certain embodiments, an indicator can be placed at a support structure 2530 or individual slots of the power transmitting apparatus 1700. The indicator can be placed on the power transmitting apparatus 1700.

In some embodiments, a wireless chargeable battery 1100 can have an outbound communication capability for wirelessly communicating its status (e.g. using WiFi, Bluetooth, near field communication (NFC), radiofrequency transmission). The communication can be received as a feedback signal to a monitoring/control unit which can be connected to or integrated within power transmission apparatus 1700 (e.g., in some embodiments, controller 1890 performs monitoring and/or control functions). The monitoring/control unit can receive information from the battery 1100 and determine a condition (e.g., charged capacity, temperature, orientation, location with the power transmitting apparatus 1700) of the battery 1100. For example, the determined condition can be used by the monitoring/control unit to reduce the amount of power transferred to the battery 1100 if it is over 99% (e.g., over 95%, over 90%) charged. The amount of power transfer can be reduced if the temperature of the battery is above a threshold (e.g., above 100 F, above 90 F, above 80 F) degree. The feedback signal from the battery 1100 can include a radiofrequency signal, an optical signal and a change in inductance of at least on receiving resonator of the battery 1100.

In some embodiments, the monitor/control unit can tune the resonant frequency or impedance of source resonators within the power transmitting apparatus 1700. In some cases, the monitor/control unit can send a signal back to the battery 1100 to adjust its resonant frequency or impedance. In certain embodiments, the monitor/control unit can change the relative magnitude and phase of currents in different source resonators of the power transmitting apparatus to reconfigure a generated magnetic field distribution based on the determined condition. For example, the magnetic field distribution can be focused in a region of the battery 1100 with a major component along a coaxial axis of the battery 1100's receiver resonator.

In certain embodiments, a source resonator or a monitor/control unit may detect a condition of a wirelessly chargeable battery 1100 through inbound communication. For example, the monitor/control unit can detect the impedance change of the battery 1100 over time. As another example, the monitor/control unit can detect the actual amount of power received by the battery 1100 compared to power transferred out by the source resonator. Any sudden change of change above a threshold can indicate that the battery 1110 is nearly fully charged or is operating abnormally. In certain embodiments, the battery 1100 can change its internal load to send a signal to the monitor/control unit. The monitor/control unit can detect the change, for example, by analyzing the energy transfer efficiency or impedance change.

It is understood that a monitor/control unit can be the controller 1890 described in relation to FIG. 18a. The monitor/control unit can include a processor analyzing received information. It is also understood that the disclosed operations of the power transmitting apparatus 1700 described in relation to FIGS. 18a-b can be generally applied to other embodiments, for example, described in FIGS. 19-26b.

### Example

### Wireless Power Transfer System

FIG. 27 is a schematic diagram showing an example of a wireless power transfer system 2700 for a wirelessly chargeable battery 1100. A power outlet 2702 provides power at 60 Hz which is converted to a DC voltage by an AC/DC conversion unit 2704. DC/RF amplifier unit 2706 receives the DC voltage and converts to a RF voltage, for example, at 10 kHz to 100 MHz. The RF voltage is supplied to a source resonator 2710 through an impedance matching network 2708. The source resonator 2710 wirelessly transfers power to a receiver resonator 2720, and the power is passed through an impedance matching network 2722 to a RF/DC rectifier unit 2724. The RF/DC rectifier unit 2724 outputs a DC voltage which is applied to a battery cell of the wirelessly chargeable battery 1100.

It is understood that a power transmitting apparatus 1700 may include the AC/DC conversion unit 2704, DC/RF amplifier unit 2706, impedance matching network 2708 and the source resonator 2710. Alternatively, the power transmitting apparatus 1700 may only include the source resonator 2710. In some embodiments, the power transmitting apparatus includes a repeater resonator which receives power from the source resonator 2710 and passes the power to the receiver resonator 2720.

The battery 1100 may include the receiver resonator 2720, impedance matching network 2722 and the RF/DC rectifier unit 2724. For example, the impedance matching network 2722 and the RF/DC rectifier unit 2724 can be included in control electronics 1120 of the battery 1100. In some embodiments, the RF/DC rectifier unit 2724 and the impedance matching network 2722 can be external to the battery 1100. In this case, the RF/DC rectifier unit 2724 can connect to the battery 1100 by way of electrodes.

### Example

### Applications

Examples described herein are intended to further illustrate systems and methods disclosed herein, but are not intended to limit the scope of the claims.

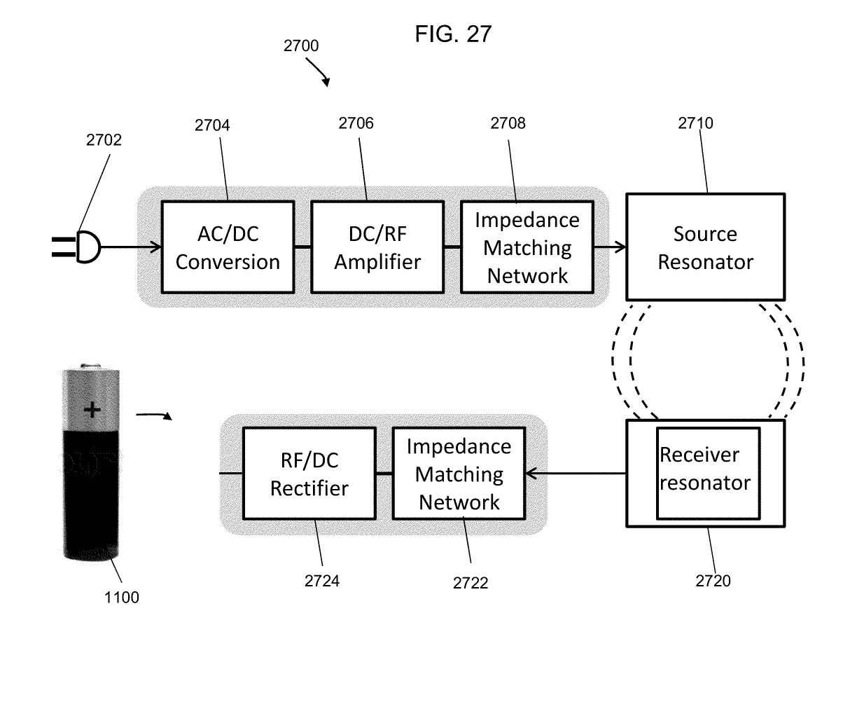

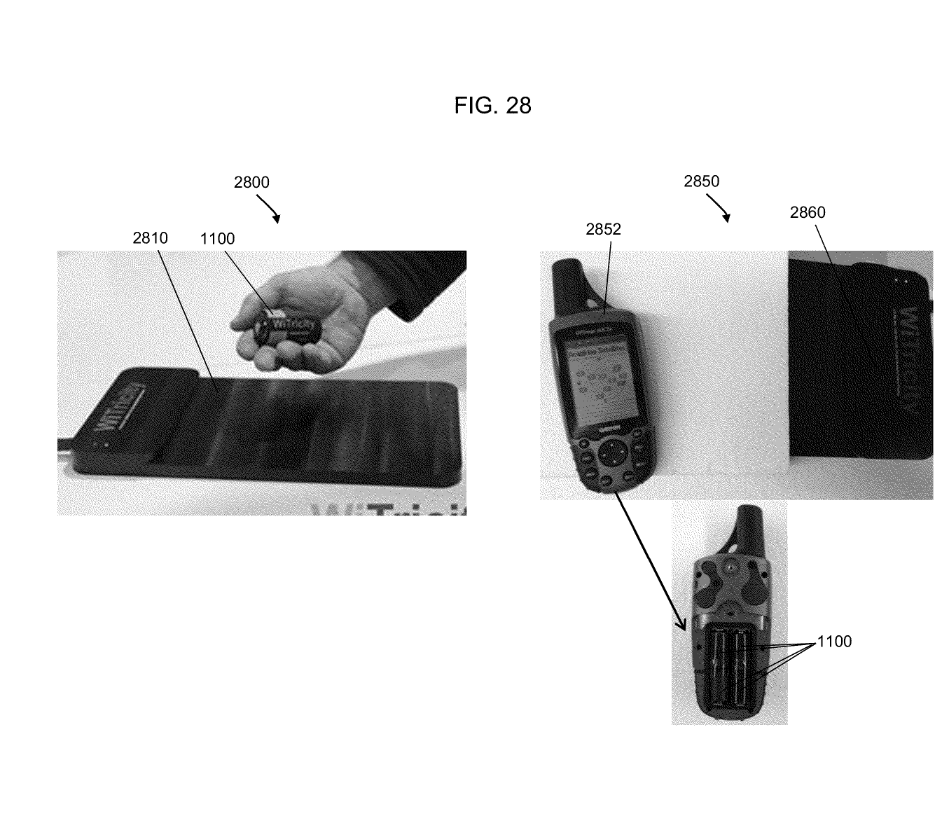

FIG. 28 is a series of photos showing examples of wireless power transmission systems. View 2800 shows a wirelessly chargeable battery 1100 including a receiver resonator, control electronics and battery cell (not shown in detail). The battery 1100 received power from the source 2810. View 2850 shows an electronic device 2852 (e.g., GPS unit) which is powered by wirelessly chargeable batteries 1100. The size of each battery 1100 conforms to a standard battery size. As such, the batteries 1100 can be inserted and used without modifying the electronic device 2852. The batteries 1100 are charged by the source 2860. Example electronic devices (e.g., battery-operated devices) include consumer electronics, mobile phones, appliances, etc.

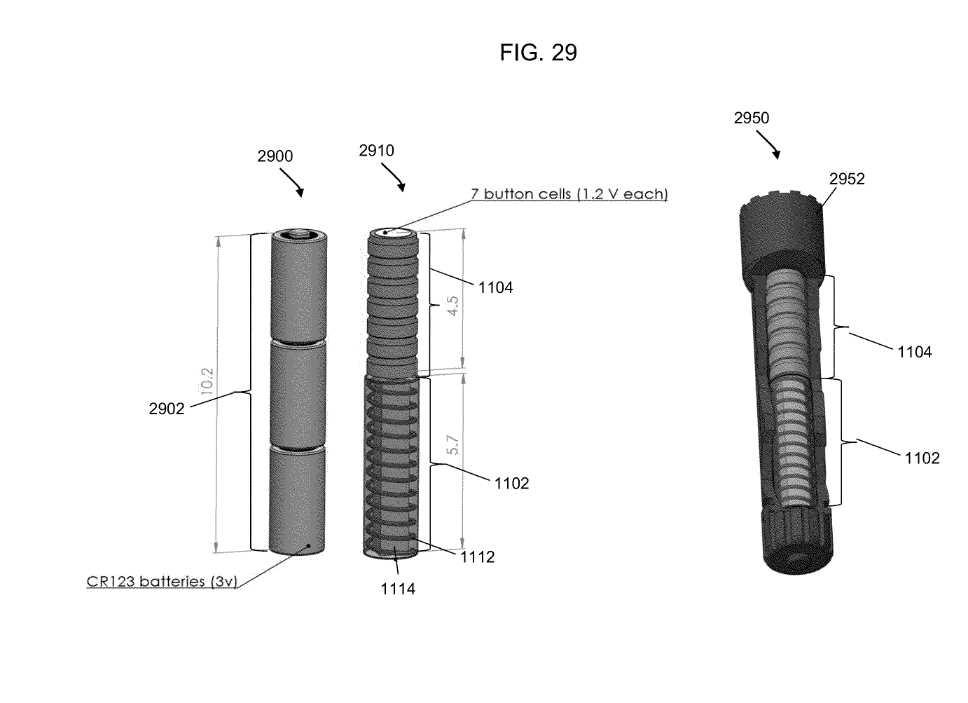

Referring to FIG. 29, view 2900 shows a battery pack 2902 with a series of standard size batteries. On the other hand, view 2910 shows a wirelessly chargeable battery including a power receiving sub-structure 1102 and a battery cell 1104. The power receiving sub-structure includes a coil 1112, magnetic material 1114 and control electronics (not shown). The battery pack 2902 can be replaced by the wirelessly chargeable battery (in view 2910), which provides the same voltage. View 2950 shows a flashlight 2952 in which the battery shown in view 2910 is inserted in the flashlight 2952 without modifications.

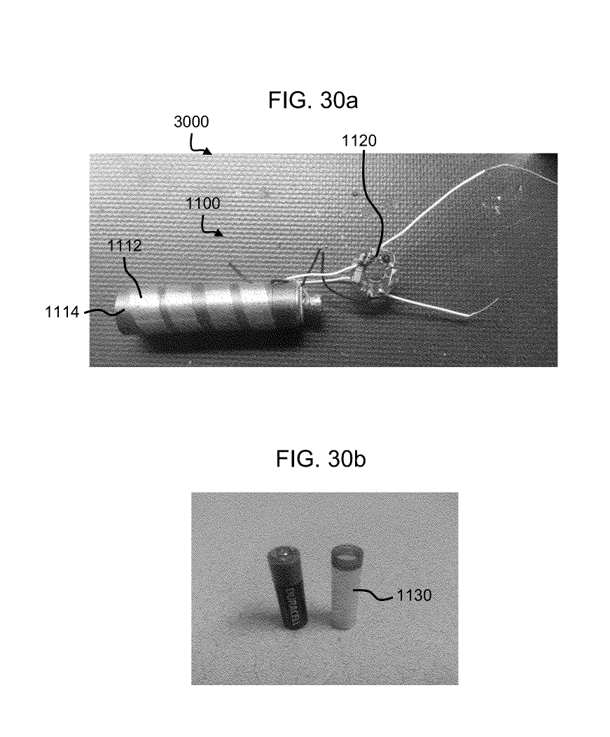

FIG. 30a is a photo showing an image 3000 of a wirelessly chargeable battery 1100 including a coil 1112 wrapped around a magnetic material 1114. The coil 1112 is connected to control electronics 1120. FIG. 30b shows an image of a battery housing 1130, which can be used as a cover for the battery 1100 shown in FIG. 30a.

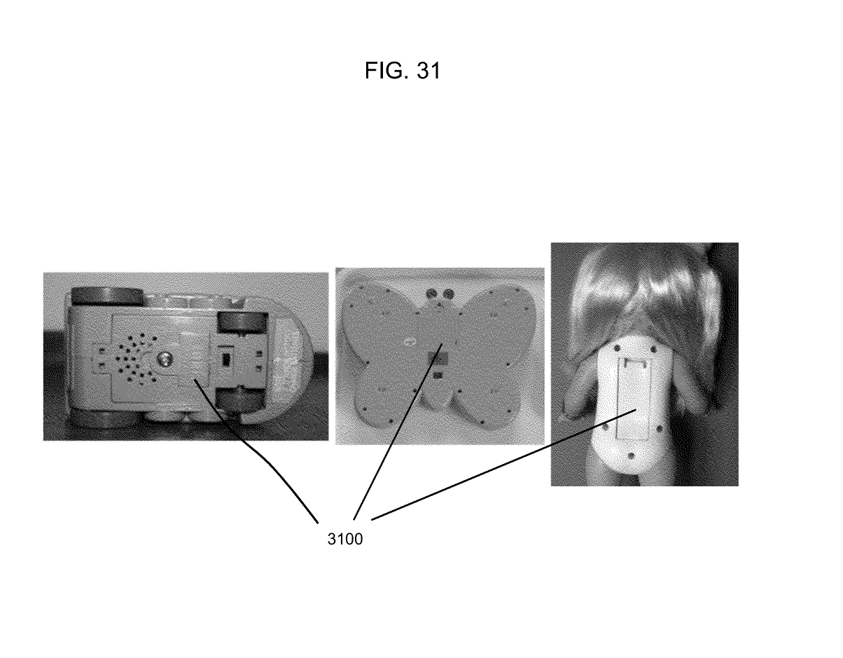

In some embodiments, one or more wirelessly chargeable batteries 1100 can be used to power toys. As an example, FIG. 31 is a series of photos showing toys with battery compartments for inserting the one or more batteries 1100. For example, the battery compartments may have inserted batteries 1100 such as wirelessly rechargeable lithium ion batteries and/or nickel metal hydride batteries that are substantially similar in size and form factor with that of a standard lithium ion battery and/or nickel metal hydride battery. Because the batteries of the toy may be recharged wirelessly, it may unnecessary for the battery compartments to be accessible. The batteries may not need to be taken out to be replaced or recharged and be kept in as long as the toy is used or never to be opened. In some embodiments, the battery compartment may be completely sealed making the toy safer, easier to be cleaned, water-proof. As such, in some cases, the battery compartments can be sealed such the toy becomes waterproof. This may reduce damage of the toys during use from exposure to liquid.

In certain embodiments, a toy may have an embedded receiver resonator and control electronics for powering the toy. For example, the toy may have a receiver resonator and control electronics integrated into its volume such as within its battery compartment. In some embodiments, the receiver resonator may include conducting materials and/or magnetic materials for shielding losses due to the toy's material and design.

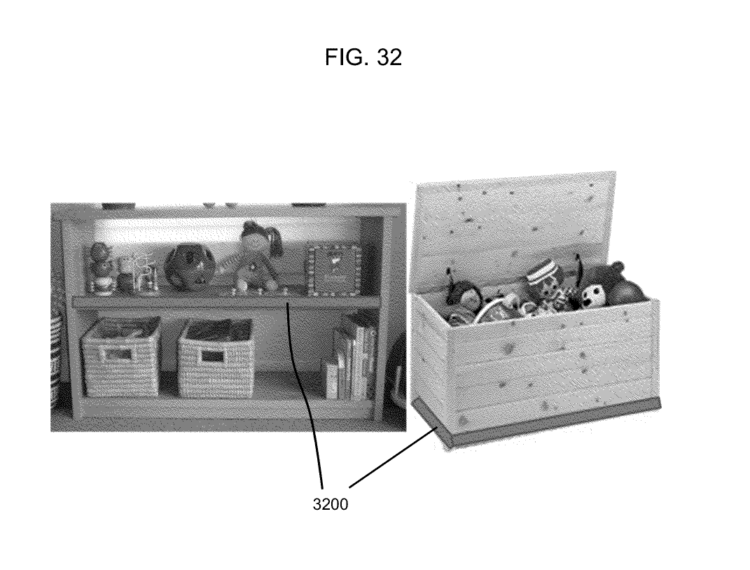

FIG. 32 is a series of photos showing examples of using source resonators 3200 in power transmitting apparatus. In these examples, multiple source resonators are embedded within a shelf or bottom of a cabinet, which are used for storing toys. The resonators may be embedded, attached or positioned in a base, top or sidewalls of a toy box. In some embodiments, source and receiver resonators can be arranged in a single plane or in multiple planes.

Hardware and Software

Some embodiments include using a controller 1890 and/or a monitor/control unit. It is understood that a controller 1890 can incorporate the operations of a monitor/control unit. The controller 1890 and/or monitor/control unit can include a processor which implements the operations of the controller 1890 and or monitor/control unit. The features of the processor can be implemented in digital electronic circuitry, or in computer hardware, firmware, or in combinations of these. The features can be implemented in a computer program product tangibly embodied in an information carrier, e.g., in a machine-readable storage device, for execution by a programmable processor; and features can be performed by a programmable processor executing a program of instructions to perform functions of the described embodiments by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program includes a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors which can be used in the controller 1890 and/or a monitor/control unit for the executing a program of instructions include, by way of example, both general and special purpose microprocessors, and the sole processor or one of multiple processors of any kind of computer. Generally, a processor will receive instructions and data from a read-only memory or a random access memory or both. Computers can be used to control the processor of the controller 1890 and/or a monitor/control unit for executing instructions and one or more memories for storing instructions and data. Generally, the computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features of the controller 1890 and/or a monitor/control unit can be implemented on a computer having a display device such as a CRT (cathode ray tube), LCD (liquid crystal display) monitor, e-Ink display or another type of display for displaying information to the user and a keyboard and a pointing device such as a mouse or a trackball by which the user can provide input to the computer.

While this disclosure contains many specific implementation details, these should not be construed as limitations on the scope of what may be claimed, but rather as descriptions of features specific to particular embodiments. Certain features that are described in this disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

What is claimed is:

1. A system for wireless transmission of power to a battery-operated device, the system comprising:
a power receiving apparatus comprising at least one receiving resonator and a housing dimensioned to engage with a battery compartment of a battery-operated device; and
a power transmitting apparatus comprising:
a first pair of source resonators spaced from one another, wherein each source resonator in the first pair comprises a loop of conducting material surrounding a common first axis;
a second pair of source resonators spaced from one another, wherein each source resonator in the second pair comprises a loop of conducting material surrounding a common second axis perpendicular to the first axis;
at least one additional source resonator comprising a loop of conducting material surrounding a common third axis perpendicular to the first and second axes; and
a controller coupled to the first and second pairs of source resonators and to the at least one additional resonator and configured to provide non-radiative wireless power transfer from the power transmitting apparatus to the power receiving apparatus by alternately activating in sequence:
the first pair of source resonators and the second pair of source resonators;
the first pair of source resonators and the at least one additional source resonator; and
the second pair of source resonators and the at least one additional source resonator.

2. The system of claim 1, wherein each one of the first pair of source resonators, each one of the second pair of source resonators, and each one of the at least one additional source resonator comprises multiple loops of the conducting material defining a coil.

3. The system of claim 1, wherein the power transmitting apparatus comprises a housing, wherein the first pair of source resonators are positioned on different sides of the housing, and wherein the second pair of source resonators are positioned on different sides of the housing.

4. The system of claim 3, wherein the first and second pairs of source resonators and the at least one additional source resonator are positioned within walls of the housing.

5. The system of claim 3, wherein the housing encloses the power transmitting apparatus and comprises an aperture dimensioned to allow the power receiving apparatus to be introduced into the housing.

6. The system of claim 3, wherein the housing has a form factor that corresponds to one of a bowl and a box.

7. The system of claim 3, wherein the housing comprises one or more movable elements so that a form factor of the housing is configurable.

8. The system of claim 7, wherein the housing is transformable between a first form factor and a second form factor.

9. The system of claim 8, wherein the first form factor comprises a planar shape.

10. The system of claim 1, wherein each one of the first pair of source resonators, the second pair of source resonators, and the at least one additional source resonator is an electromagnetic resonator having a resonant frequency f=ω/2π, an intrinsic loss rate Γ, and a Q-factor Q=ω/(2Γ), and wherein the Q-factor for at least one of the first pair of source resonators and for at least one of the second pair of source resonators is greater than 100.

11. The system of claim 10, wherein each one of the first pair of source resonators, the second pair of source resonators, and the at least one additional source resonator has a capacitance and an inductance that define the resonant frequency f.

12. The system of claim 1, wherein the controller is configured to activate the first pair of source resonators and the second pair of source resonators for a time period t₁, the first pair of source resonators and the at least one additional source resonator for a time period t₂, and the second pair of source resonators and the at least one additional source resonator for a time period t₃.

13. The system of claim 12, wherein the controller is configured to activate the first and second pairs of source resonators and the at least one additional source resonator such that t₁, t₂, and t₃ are the same.

14. The system of claim 12, wherein the controller is configured to receive a feedback signal from the power receiving apparatus, and wherein the feedback signal comprises information about a charge capacity of the power receiving apparatus.

15. The system of claim 14, wherein the feedback signal comprises at least one of a radiofrequency signal, an optical signal, and a change in inductance of the at least one receiving resonator of the power receiving apparatus.

16. The system of claim 14, wherein the controller is configured to adjust at least one of t₁, t₂, and t₃ based on the feedback signal.

17. The system of claim 1, wherein the at least one additional source resonator comprises one source resonator.

18. The system of claim 1, wherein the at least one additional source resonator comprises a pair of source resonators spaced from one another.

19. A device for wireless transmission of power to a power receiving apparatus comprising at least one receiving resonator, the device comprising:
a first pair of source resonators spaced from one another, wherein each source resonator in the first pair comprises a loop of conducting material surrounding a common first axis;
a second pair of source resonators spaced from one another, wherein each source resonator in the second pair comprises a loop of conducting material surrounding a common second axis different from the first axis; and
a controller coupled to the first and second pairs of source resonators and configured to provide non-radiative wireless power transfer from the device to the power receiving apparatus by alternately:
activating the first pair of source resonators to transfer power from the first pair of source resonators to the power receiving apparatus; and
activating the second pair of source resonators to transfer power from the second pair of source resonators to the power receiving apparatus.

20. The device of claim 19, wherein each one of the first pair of source resonators and each one of the second pair of source resonators comprises multiple loops of the conducting material defining a coil.

21. The device of claim 19, further comprising at least one additional source resonator comprising a loop of conducting material surrounding a common third axis different from the first and second axes, wherein the controller is configured to activate the first pair of source resonators and the second pair of source resonators for a time period t₁, the first pair of source resonators and the at least one additional source resonator for a time period t₂, and the second pair of source resonators and the at least one additional source resonator for a time period t₃.

22. The device of claim 21, wherein the first, second, and third axes are substantially mutually perpendicular.

23. The device of claim 21, wherein the controller is configured to activate the first and second pairs of source resonators and the at least one additional source resonator such that t₁, t₂, and t₃ are the same.

24. The device of claim 19, wherein each one of the first and second pairs of source resonators is an electromagnetic resonator having a resonant frequency f=ω/2π, an intrinsic loss rate Γ, and a Q-factor Q=ω/(2Γ), and wherein the Q-factor for at least one of the first pair of resonators and for at least one of the second pair of resonators is greater than 100.

25. A method for wireless transmission of power to a power receiving apparatus, the method comprising:
(a) during a first time period, applying a voltage to a first pair of source resonators spaced from one another, wherein each source resonator in the first pair comprises a loop of conducting material surrounding a common first axis, and applying a voltage to a second pair of source resonators spaced from one another, wherein each source resonator in the second pair comprises a loop of conducting material surrounding a common second axis perpendicular to the first axis;
(b) during a second time period, applying a voltage to the first pair of source resonators and applying a voltage to at least one additional source resonator comprising a loop of conducting material surrounding a common third axis perpendicular to the first and second axes;
(c) during a third time period, applying a voltage to the second pair of source resonators and applying a voltage to the at least one additional source resonator; and
(d) repeating (a)-(c) to transmit power wirelessly from the first and second pairs of source resonators and the at least one additional source resonator to a receiving resonator in the power receiving apparatus.

26. The method of claim 25, wherein the first, second, and third time periods are equal in duration.

27. The method of claim 25, wherein at least one of the first, second, and third time periods is different in duration from other time periods.

28. The method of claim 25, wherein the first, second, and third axes are mutually perpendicular.

29. The method of claim 25, further comprising:
receiving a signal from the power receiving apparatus, wherein the signal comprises information about a charge capacity of the power receiving apparatus; and
adjusting at least one of the first, second, and third time periods based on the signal.
